(19) United States
(12) Patent Application Publication
(10) Pub. No.: US 2025/0176535 A1
(43) Pub. Date: Jun. 5, 2025

(54) COMPOSITIONS AND METHODS FOR TARGETED DELIVERY OF CHEMICALS AND BIOMOLECULES TO PLANTS AND FUNGI

(71) Applicants: Juan Pablo GIRALDO GOMEZ, Riverside, CA (US); Suji JUN, Riverside, CA (US); Philippe ROLSHAUSEN, Riverside, CA (US); Leticia MARSHALL, Riverside, CA (US); The Regents of the University of California, Oakland, CA (US)

(72) Inventors: Juan Pablo Giraldo Gomez, Redlands, CA (US); Suji Jun, Riverside, CA (US); Philippe Rolshausen, Riverside, CA (US); Leticia Marshall, Moreno Valley, CA (US)

(73) Assignee: The Regents of the University of California, Oakland, CA (US)

(21) Appl. No.: 18/842,953

(22) PCT Filed: Mar. 6, 2023
(86) PCT No.: PCT/US2023/014648

§ 371 Date: Aug. 30, 2024

Related U.S. Application Data
(60) Provisional application No. 63/316,902, filed on Mar. 4, 2022.

(51) Int. Cl. A01N 25/10; A01N 25/12; A01N 43/30; A01N 43/40; A01N 43/653; A01N 43/78; A01N 43/80; A01N 43/90; A01P 13/00

(52) U.S. Cl. CPC A01N 25/10; A01N 25/12; A01N 43/30; A01N 43/40; A01N 43/653; A01N 43/78; A01N 43/80; A01N 43/90; A01P 13/00

(57) ABSTRACT

The invention provides methods and compositions for targeted delivery of a chemical or biomolecule cargo and/or a nanoparticle to phloem of a plant or to a fungus.

### RELATED APPLICATION

This application claims the benefit of priority of U.S. Provisional Application Ser. No. 63/316,902 filed on Mar. 4, 2022, which application is incorporated by reference herein.

### GOVERNMENT FUNDING

This invention was made with government support under Grant No. 1911763 awarded by the National Science Foundation. The government has certain rights in the invention.

### BACKGROUND OF THE INVENTION

The increasing global demand for agricultural productivity by a rapidly growing population requires a significant increase in food production. Agricultural practices wield some of the earth's most significant pressures on natural resources, leading to deforestation, groundwater pollution, and increased greenhouse gas emissions. The loss of agrochemicals such as pesticides and fertilizers in agricultural land are among the most negative impacts on environmental and human health. Pesticides, a major class of agrochemicals., accumulate in the environment; progressive biomagnification can move them into the food chain. While the use of pesticides increases crop yield and quality, excessive use of pesticides and herbicides leads to resistance to agricultural pests (e.g., pathogens), impacts air quality, and contaminates water and soil. This is particularly concerning, since it is estimated that less than 0.1% of the 5.6 billion pounds of pesticides applied worldwide reach the intended biological target.

Thus, the delivery efficiency of agrochemicals to the desired site of action is relatively low, leading to suboptimal efficacy and undesirable environmental side effects. There is a need for new methods and compositions for improved delivery of agrochemicals to plants and fungi.

### SUMMARY OF THE INVENTION

Certain embodiments of the invention provide a conjugate comprising a Sucrose Transporter protein (SUT) targeting agent linked to a cargo that is selected from a pesticide, herbicide, or fertilizer.

Certain embodiments provide a conjugate comprising a Sucrose Transporter protein (SUT) targeting agent linked to a cargo (e.g., linked either directly or indirectly), wherein the conjugate is capable of being delivered to a plant or fungus, and wherein the cargo is an agent that is capable of producing a desired effect in the plant or fungus following delivery of the conjugate to the plant or fungus.

In certain embodiments, the conjugate further comprises a nanoparticle and/or a molecular basket, wherein the nanoparticle is selected from the group consisting of a quantum dot, carbon dot, carbon nanotube, silica nanoparticle (e.g., porous silica nanoparticle), lipid nanoparticle, liposome, metal or metal oxide nanoparticle, and a micro or macro nutrient-based nanoparticle. In certain embodiments, the nanoparticle is linked to one or more SUT targeting agent(s). In certain embodiments, the cargo is associated with the nanoparticle or with the molecular basket. In certain embodiments, the cargo is associated with the nanoparticle. In certain embodiments, the cargo is associated with the molecular basket. In certain embodiments, the molecular basket comprises a beta cyclodextrin or gamma cyclodextrin.

Certain embodiments provide a conjugate comprising a Sucrose Transporter protein (SUT) targeting agent linked to a nanoparticle (e.g., comprising one or more SUT targeting agents linked to a nanoparticle), wherein the conjugate is capable of being delivered to a plant or fungus, and the nanoparticle is selected from the group consisting of a quantum dot, carbon dot, carbon nanotube, silica nanoparticle (e.g., porous silica nanoparticle), lipid nanoparticle, liposome, metal or metal oxide nanoparticle, and micro or macro nutrient-based nanoparticle.

Certain embodiments of the invention provide a conjugate comprising a Glucose Transporter protein (GUT) targeting agent linked to a cargo that is selected from a pesticide, herbicide, or fertilizer.

Certain embodiments provide a conjugate comprising a Glucose Transporter protein (GUT) targeting agent linked to a cargo (e.g., linked either directly or indirectly), wherein the conjugate is capable of being delivered to a fungus, and wherein the cargo is an agent that is capable of producing a desired effect in the fungus following delivery of the conjugate to the fungus.

In certain embodiments, the conjugate further comprises a nanoparticle and/or a molecular basket, wherein the nanoparticle is selected from the group consisting of a quantum dot, carbon dot, carbon nanotube, silica nanoparticle (e.g., porous silica nanoparticle), lipid nanoparticle, liposome, and a metal or metal oxide nanoparticle. In certain embodiments, the nanoparticle is linked to one or more GUT targeting agent(s). In certain embodiments, the cargo is associated with the nanoparticle or with the molecular basket. In certain embodiments, the cargo is associated with the nanoparticle. In certain embodiments, the cargo is associated with the molecular basket. In certain embodiments, the molecular basket comprises a beta cyclodextrin or gamma cyclodextrin.

Certain embodiments provide a conjugate comprising a Glucose Transporter protein (GUT) targeting agent linked to a nanoparticle (e.g., comprising one or more GUT targeting agents linked to a nanoparticle), wherein the conjugate is capable of being delivered to a fungus, and the nanoparticle is selected from the group consisting of a quantum dot, carbon dot, carbon nanotube, silica nanoparticle (e.g., porous silica nanoparticle), lipid nanoparticle, liposome, and metal or metal oxide nanoparticle.

Certain embodiments of the invention provide a conjugate comprising a cargo and a conjugate of Formula I as described herein, and optionally one or more molecular baskets, wherein the cargo is associated with the nanoparticle and/or molecular basket, and wherein the cargo is selected from a pesticide, herbicide, or fertilizer. Certain embodiments of the invention provide a conjugate comprising a conjugate of Formula II as described herein, wherein the cargo is selected from a pesticide, herbicide, or fertilizer. Certain embodiments of the invention provide a conjugate comprising a cargo and a conjugate of Formula III as described herein, and optionally, a nanoparticle, wherein the cargo is associated with the molecular basket and/or nanoparticle, and wherein the cargo is selected from a pesticide, herbicide, or fertilizer. In certain embodiments, the targeting agent is a SUT targeting agent (e.g., a disaccharide, such as sucrose). In certain embodiments, the targeting agent is a GUT targeting agent (e.g., a monosaccharide, such as glucose).

Certain embodiments provide a conjugate as described herein.

Certain embodiments provide a method of introducing a conjugate to a plant or fungus (e.g., that expresses a Sucrose Transporter (SUT) protein), the method comprising: contacting the plant or fungus with a conjugate as described herein.

Certain embodiments provide a method of treating a fungus infection in a plant or introducing a conjugate to a fungus, the method comprising: contacting the plant and/or fungus (e.g., that expresses a Glucose Transporter (GUT) protein) with a conjugate as described herein.

Certain embodiments provide a method for delivering a conjugate to a plant or fungus, comprising contacting the plant or fungus with a conjugate comprising a nanoparticle and/or a molecular basket that is linked to a Sucrose Transporter protein (SUT) targeting agent (e.g., linked to one or more SUT targeting agents), wherein the nanoparticle is selected from the group consisting of a quantum dot, carbon dot, carbon nanotube, silica nanoparticle (e.g., porous silica nanoparticle), lipid nanoparticle, liposome, metal or metal oxide nanoparticle, and a micro or macro nutrient-based nanoparticle.

Certain embodiments provide a method for introducing a conjugate to a fungus, comprising contacting the fungus with a conjugate comprising a nanoparticle and/or a molecular basket that is linked to a Glucose Transporter protein (GUT) targeting agent (e.g., linked to one or more GUT targeting agents), wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle.

Certain embodiments provide a method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle, and wherein the conjugate is contacted with the fungus during germination.

Certain embodiments provide a method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle, and wherein the conjugate is contacted with the fungus after germination.

Certain embodiments provide a method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle, and wherein the conjugate is contacted with the fungus during proliferation.

Certain embodiments provide a method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle, and wherein the conjugate is contacted with the fungus when fungus forms hyphae.

Certain embodiments provide a method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle, and wherein the conjugate is contacted with the fungus at sporulation.

Certain embodiments provide a method comprising detecting a conjugate as described herein in a plant or fungus.

Certain embodiments provide a method as described herein.

The invention also provides processes and intermediates disclosed herein that are useful for preparing conjugates described herein.

### BRIEF DESCRIPTION OF THE FIGURES

FIGS. 1A-1B. FIG. 1a) Targeted delivery of nanomaterials to the phloem by plant biorecognition. Sucrose coated quantum dots (sucQDs) and sucrose-B-cyclodextrin coated-carbon dots applied topically to the leaf surface are guided through leaf tissues into the phloem via biorecognition with sucrose transporters (SUT) located in phloem vessels. FIG. 1b) the upper schematic graph shows sucQDs; the lower schematic graph shows sucrose coated carbon dot (CD) which is also coated with beta cyclodextrin.

FIGS. 2A-2G. Characterization of sucrose coated QD (sucQD) and sucrose coated β-cyclodextrin CD (suc-β-CD). FIG. 2a), TEM image of sucQDs with an average size of 4.1 nm and suc-β-CDs with an average size of 9.1 nm. FIG. 2b), Hydrodynamic size of QDs, sucQDs, core CDs, and suc-β-CDs. FIG. 2c), The QDs, sucQDs, CDs and suc-β-CDs all have negative zeta potentials (TES buffer, pH 7.0). n=6-8. FIG. 2d), Absorption spectra of QD, sucQDs, CDs, and suc-β-CDs. The sucQDs show slight increase in absorbance in the UV region compared to QDs due to sucrose coating. The absorption shape of suc-β-CDs was broadened after functionalization with β-cyclodextrin and sucrose. FIG. 2e), Fluorescence emission spectra of QD, sucQD, CD and Suc-β-CDs do not overlap with leaf background fluorescence. FIG. 2f-FIG. 2g) FT-IR spectra of sucQDs and Suc-β-CDs indicating functionalization with sucrose or β-cyclodextrins on their surface.

FIGS. 3A-3C. Confocal microscopy imaging of nanomaterials into phloem cells. FIG. 3a) In vivo confocal fluorescence microscopy images near the sucQD foliar application area. The sucQDs (in light gray) were localized in the wheat leaf vasculature in between leaf mesophyll cells containing chloroplasts (in dark gray) Scale bar=100 μm. FIG. 3b) Representative images showing the high colocalization of sucQDs with the CF fluorescent dye that labels phloem cells (in dark gray). Scale bar=30 μm. FIG. 3c) In vivo confocal fluorescence microscopy images of sucrose coated CDs from the foliar application area. CDs were efficiently localized in the wheat leaf vasculature after coating with sucrose, whereas the uncoated CD formed globular structures across the leaf mesophyll. Scale bar=100 μm.

FIGS. 4A-4E. Rapid uptake and translocation of sucQDs in the phloem is mediated by plant biorecognition. FIG. 4a) Real-time imaging of QDs in the phloem of wheat leaves in planta was performed in a customized inverted epifluorescence microscope. A wheat leaf from an intact live plant was mounted on the microscope stage and FIG. 4b) a trace region 10 mm away from the loading area was excited to image QD translocation in the phloem. FIG. 4c) Fluorescence intensity changes in the tracing area indicate rapid loading and translocation of the sucQDs in the phloem. The sucQD fluorescence intensity changes were significantly higher than for unmodified QDs and glucose coated QDs (gluQDs). FIG. 4d) Epifluorescence image of wheat leaf vasculature after exposure to sucQDs (40 min) indicate sucQD phloem loading and potential pathway of leaf uptake through stomata. FIG. 4e) Differences in sucQD translocation in the phloem at 4° C. and 25° C. point to energy dependent mechanisms of nanoparticle loading and translocation into the phloem. n=4. Scale bar=50 μm

FIG. 5. Delivery of QDs from leaves to other plant organs through the phloem. Schematic represents topical application of QD and sucQDs onto leaf areas including exposed and trace leaf areas. Phloem vessel could facilitate sap transport towards stem and roots.

FIGS. 6A-6B. FIG. 6a) Synthesis of sucrose coated QD from carboxylated QDs.

FIG. 6b) sucrose, beta cyclodextrin coated CD.

FIG. 7. FT-IR spectra of sucQDs compared to QDs indicate the presence of sucrose and APBA.

FIG. 8. sucQDs and QDs do not impact photosynthesis in wheat leaves at different levels of photosynthetic active radiation (PAR). Carbon dioxide assimilation rates were similar in plant leaves exposed for 30 min to sucQD and QD (200 nM) or TES buffer without nanoparticles (control)

FIG. 9. CF, sucQD and leaf fluorescence emission spectrum under a 405 nm excitation and comparison of emission range with other components.

FIGS. 10A-10B. FIG. 10a) Confocal fluorescence microscopy images of phloem labeled with CF in wheat leaf, and sucQD exposed leaf. FIG. 10b) 3D renderings of CF and sucQD treated leaves created in FIJI. Scale bar=100 μm.

FIG. 11. Epifluorescence microscopy images of wheat leaves after exposure to sucQDs, QDs, and gluQDs for 40 min. Scale bar=100 μm.

FIG. 12. Composition of synthetic phloem sap.

FIG. 13. Hydrodynamic size and zeta potential of QDs, sucQDs, gluQDs dispersed in TES buffer (pH 7.4).

FIGS. 14A-14I. Design and characterization of nanocarriers for targeted delivery of fungicide active ingredients. FIG. 14a) Nanocarriers target the delivery of active ingredients to fungi in plants by recognizing glucose transporters (GUT) on the fungi cell membrane. FIG. 14b) The nanocarriers, β- or γ-cyclodextrin/glucose-coated Gd-doped carbon dots (glu-β-GdCD), in this Example, are made of three components: a biorecognition moiety (glucose), a fluorescent nanoparticle (carbon dot), and a molecular basket for loading fungicide(s). The glucose coated nanocarriers have a higher binding affinity to fungi cells mediated by biorecognition between glucose on the nanoparticle surface and GUT membrane proteins. FIG. 14c) UV-Vis absorbance of targeted β-GdCD and γ-GdCD. FIG. 14d) Fluorescence emission of glu-β-GdCD and glu-γ-GdCD (355 nm ex.) does not overlap with leaf autofluorescence. FIG. 14e) FTIR spectra of glu-β-GdCD compared with core GdCD. FIG. 14f) AFM image of core GdCD and height profiles for FIG. 14g) core GdCD, FIG. 14h) β-GdCD, and FIG. 14i) γ-GdCD. We observed an increase in nanoparticle thickness after functionalization with molecular baskets.

FIGS. 15A-15D. Enhanced delivery of nanocarriers functionalized with glucose to fungi in vitro. FIG. 15a) In vitro assay for GFP-Botrytis hyphae incubation with nanocarriers followed by washing with DI water before confocal microscopy imaging. FIG. 15b) Representative confocal images of GFP-Botrytis exposed to nanocarriers indicate enhanced uptake into fungi of glucose coated glu-β-GdCD. FIG. 15c) Colocalization analysis of GdCD with GFP-Botrytis fluorescence signals indicated a significantly higher percentage of GFP co-localized with targeted glu-β-GdCD compared to the control counterparts without glucose coating (one-way ANOVA and post hoc test, n=3-4, **, p<0.01). FIG. 15d) Orthogonal view of z-stacked confocal images GFP-botrytis was performed using line transect and it showed an overlap of the fluorescence peaks corresponding to GFP and GdCD. Scale bar 100 μm.

FIGS. 16A-16C. Targeted delivery of nanocarriers coated with glucose to fungi in infected leaves. FIG. 16a) In vivo confocal images of GFP-Botrytis infected leaves indicating a higher degree of colocalization of nanocarriers coated with glucose (glu-β-GdCD and glu-γ-GdCD) with GFP fluorescence compared to non-targeted nanocarriers (β-GdCD). FIG. 16b) Enhanced colocalization rates of glu-β-GdCD with GFP compared to β-GdCD. (t-test, n=3). Lower case letters represent significance at P<0.05. FIG. 16c) Orthogonal views from Z-stack confocal images showing colocalization of glu-β-GdCD within GFP-botrytis. Scale bar, 100 μm.

FIGS. 17A-17F. In vitro delivery of fluorescent chemical cargo to fungi mediated by nanocarriers. FIG. 17a) Chemical structure of molecular baskets (cyclodextrins) and fluorescent chemical cargo (Rhodamine 6G, R6G) FIG. 17b) Fluorescence spectra of R6G in the presence of different concentrations of β-cyclodextrins (0-10 mM, TES buffer, pH 7.4) FIG. 17c) Dose dependent fluorescence response of R6G interacted with β-, γ-cyclodextrins. FIG. 17d) Confocal images of GFP-botrytis infected leaf indicating a higher degree of colocalization of nanocarriers coated with glucose (glu-β-GdCD and glu-γ-GdCD) with GFP fluorescence compared to non-targeted nanocarriers (β-GdCD and γ-GdCD). FIG. 17e) Enhanced colocalization rates of glu-γ-GdCD with GFP compared to γ-GdCD. (t-test, n=3). FIG. 17f) Orthogonal views from z-stack confocal images colocalizing R6G with glu-γ-GdCD in GFP-botrytis. Scale bar, 100 μm.

FIGS. 18A-18C. Targeted delivery of fluorescent chemical cargo to fungi in infected leaves mediated by nanocarriers FIG. 18a) Confocal images of GFP-Botrytis infected leaves indicating a higher degree of colocalization of R6G delivered by glu-γ-GdCD with GFP fluorescence compared to non-targeted γ-GdCD. FIG. 18b) Colocalization rates of R6G delivered by glu-γ-GdCD with GFP compared to γ-GdCD. (one-way ANOVA host doc, n=3, *, p<0.05. FIG. 18c) Orthogonal views from z-stacks of confocal images showing colocalization of glu-γ-GdCD within GFP-Botrytis. Scale bar, 100 μm.

FIG. 19. Synthesis of sucrose or glucose coated nanocarrier (suc-β-GdCD, glu-β-GdCD) for targeted delivery of cargo. Detailed method is provided in Example 3.

FIG. 20. Confocal images of nanocarriers in wildtype fungi (Botrytis spp.) in vitro. Confocal images showed the highest fluorescence intensity from Glu-b-GdCDs treated Botrytis.

FIG. 21. Confocal images of GFP-Botrytis incubated with nanocarriers in vitro.

FIG. 22. Targeted delivery of nanocarriers to fungal structures.

FIG. 23. In-vivo Botrytis cinerea Inoculation of detached leaf Assay.

FIG. 24. GFP-Botrytis infected leaves treated with 0.1% Silwet and sucrose coated carbon dot NPs for 3 hours (40×).

FIG. 25. GFP-Botrytis infected leaves treated with 0.1% Silwet and sucrose coated carbon dot NPs for 3 hours (40×).

### DETAILED DESCRIPTION

Described herein are methods and compositions for improved delivery of exogenous material to a plant or fungus. For example, enhanced delivery into the phloem, stem, and/or root of a plant has been shown herein by, e.g., targeting a Sucrose Transporter (SUT) protein of the plant.

Sucrose Transporter (SUT) proteins are expressed in both plants and fungi. For example, plant Sucrose Transporter (SUT) proteins, which are expressed in cells lining phloem vessels, load sucrose synthesized from leaves into phloem veins for transportation towards stems and roots. As described herein, through targeted biorecognition of a Sucrose Transporter (SUT) protein, delivery efficiency and mass transport of exogenously introduced materials after foliar application could be increased (see, e.g., Example 1). Thus, facilitated by this SUT mediated targeted delivery approach, a higher proportion of exogenously introduced materials could enter phloem vasculature and reach the desired destination compartment of the plant, effectively increasing the bioavailability of the exogenously introduced material. Fungi also express SUTs and exogenously introduced materials, such as conjugates described herein, may be delivered throughout a fungus using targeted biorecognition of these SUT proteins.

In addition, Glucose Transporter (GUT) proteins are expressed in fungi. For example, Glucose Transporter (GUT) proteins expressed by fungal cells can facilitate the transport of monosaccharides such as glucose, which can serve as a carbon source for supplying energy or sustaining growth of fungal cells. As described herein, through targeted biorecognition of a Glucose Transporter (GUT) protein expressed by fungal cells, delivery efficiency of exogenous materials to the fungal cells can be enhanced (see, e.g., Example 2).

### Compositions

Certain embodiments of the invention provide 1) a conjugate comprising a Sucrose Transporter protein (SUT) targeting agent linked to a cargo, wherein the conjugate is capable of being delivered to a plant or fungus; or 2) a conjugate comprising a Glucose Transporter protein (GUT) targeting agent, wherein the conjugate is capable of being delivered to a fungus; and wherein the cargo is an agent that is capable of producing a desired effect in the plant or fungus following delivery of the conjugate to the plant or fungus.

Certain embodiments of the invention provide a conjugate comprising a Sucrose Transporter protein (SUT) targeting agent linked to a cargo, wherein the conjugate is capable of being delivered to a plant or fungus (e.g., to a desired site within the plant, such as the phloem via a SUT protein), and wherein the cargo is an agent that is capable of producing a desired effect in the plant or fungus following delivery of the conjugate to the plant or fungus.

Certain embodiments of the invention provide a conjugate comprising a Glucose Transporter protein (GUT) targeting agent linked to a cargo, wherein the conjugate is capable of being delivered to a fungus, and wherein the cargo is an agent that is capable of producing a desired effect (e.g., inhibitory effect) in the fungus following delivery of the conjugate to the fungus.

Certain embodiments of the invention provide a conjugate comprising a Sucrose Transporter protein (SUT) targeting agent or a Glucose Transporter protein (GUT) targeting agent linked to a cargo that is a pesticide, herbicide, or fertilizer.

In certain embodiments, a conjugate as described herein comprises a mixture of SUT and GUT targeting agents.

As used herein, the term “conjugate” includes two or more elements that are combined, linked or joined either reversibly or irreversibly.

In certain embodiments, the conjugate further comprises a nanoparticle and/or a cyclodextrin molecular basket. For example, in certain embodiments, a nanoparticle (NP) and/or molecular basket may serve as delivery vehicle or carrier for a cargo. For example, cargo carried or trapped within such a delivery system may be released in a plant or fungus. In particular, when linked with a SUT targeting agent, a higher proportion of such a delivery vehicle (e.g., NP and/or molecular basket) may be introduced to a plant (e.g., leaf surface) or fungus and reach a target site of action (e.g., phloem vessel and/or root) and thus improve cargo exposure at the site of action. In certain embodiments, when linked with a GUT targeting agent, a higher proportion of such a delivery vehicle (e.g., NP and/or molecular basket) may be introduced to a fungus as compared to a control delivery vehicle without the GUT targeting agent.

Thus, in certain embodiments, the cargo is associated with the nanoparticle and/or with the cyclodextrin molecular basket (i.e., the cargo is linked to the SUT or GUT targeting agent via its association with the nanoparticle and/or the cyclodextrin molecular basket).

In certain embodiments, the cargo is associated with the nanoparticle. For example, in certain embodiments, the cargo is conjugated to the surface of a nanoparticle or loaded within a nanoparticle (e.g., cargo loaded in a porous silica nanoparticle). Therefore, the cargo may be indirectly linked to the SUT or GUT targeting agent via the nanoparticle that is functionalized with the SUT or GUT targeting agent.

As used herein, the terms “functionalized” or “functionalization” refer to a compound or material (e.g., a nanoparticle) that has been modified to confer additional function to the compound or material (e.g., a function of targeting or a function of having enhanced cargo loading capacity). For example, a nanoparticle may be functionalized by linking a SUT or GUT targeting agent and/or molecular basket to its surface.

In certain embodiments, the conjugate comprises a nanoparticle (NP) linked to one or more Sucrose Transporter protein (SUT) targeting agent(s).

In certain embodiments, the conjugate comprises a nanoparticle (NP) linked to one or more Glucose Transporter protein (GUT) targeting agent(s).

In certain embodiments, the cargo is associated with a cyclodextrin molecular basket. For example, in certain embodiments, the cargo is loaded within a cyclodextrin molecular basket. In certain embodiments, the cargo forms an inclusion complex with the cyclodextrin. Therefore, the cargo may be indirectly linked to the SUT or GUT targeting agent via the cyclodextrin molecular basket (e.g., that is functionalized with the SUT or GUT targeting agent; or that is linked to a nanoparticle functionalized with the SUT or GUT targeting agent).

As used herein, the term “Glucose Transporter protein” or “GUT” refers to a fungal cell membrane-anchored protein capable of transporting glucose across the cell membrane of the fungal cell. GUTs in fungi are known in the art and described herein; methods for determining GUT mediated transport of substrates are also known in the art and described herein. For example, GUTs and their roles in transporting glucose in fungi are discussed in: D Schuler, et al., New Phytol. 2015 May, 206(3):1086-1100.; Ozcan, et al., Microbiol Mol Biol Rev. 1999 September, 63(3): 554-569.; TF dos Reis, et al, PLoS One. 2013, 8(11): e81412.; W Zhang, et al., Scientific Reports, volume 5, Article number: 13829 (2015).; and B Wang, et al., Biotechnology for Biofuels, 2017 Jan. 19; 10:17. doi: 10.1186/s13068-017-0705-4.; which are incorporated by reference herein.

In certain embodiments, the GUT protein is expressed by a fungus that is Magnaporthe oryzae, Botrytis spp. (e.g., Botrytis cinerea), Puccinia spp., Fusarium graminearum, Fusarium oxysporum, Blumeria graminis, Mycosphaerella graminicola, Colletotrichum spp., Ustilago maydis, Melampsora lini, or Zymoseptoria tritici.

In certain embodiments, the GUT protein is a Hxt protein (e.g., Hxt1 to Hxt17). In certain embodiments, the GUT protein is Hxt1 expressed in Ustilago maydis. In certain embodiments, the GUT protein is expressed by a Botrytis sp. (e.g., Botrytis cinerea).

As used herein, the term “a moiety or agent having affinity for a GUT” or “a GUT targeting moiety” or “a GUT targeting agent” are used interchangeably and refer to a molecule that specifically binds the GUT and/or is capable of being transported by the GUT (e.g., cross membrane transport). However, the term “GUT targeting agent” does not include the ion (proton H⁺) that may be co-transported by a GUT during the transportation of a molecule that specifically binds to the GUT (e.g., glucose). In certain embodiments, the GUT targeting agent is a small molecule compound having a molecular weight of less than 1000 g/mol (e.g., <500 or <400 g/mol).

It is understood that in addition to GUT's cognate ligand glucose, there are other substrates or ligands with binding affinity for glucose transporter proteins (GUTs) and/or that may be transported by a GUT of a fungus. In certain embodiments, the GUT targeting agent is a monosaccharide. In certain embodiments, the GUT targeting agent is a hexose (e.g., glucose, or galactose). In certain embodiments, the GUT targeting agent is a glucose. In certain embodiments, the GUT targeting agent is α-D-glucose. In certain embodiments, the GUT targeting agent is β-D-glucose.

In certain embodiments, the GUT targeting agent has a higher affinity for a GUT as compared to a SUT. In certain embodiments, the GUT targeting agent has at least about 1, 2, 3, 4, 5, 6, 7, 8, 9, 10, 15, 20 or more-fold higher affinity for a GUT than for a SUT. In certain embodiments, the GUT targeting agent has at least about 5-fold higher affinity for a GUT than for a SUT. In certain embodiments, the GUT targeting agent has at least about 10-fold higher affinity for a GUT than for a SUT.

In certain embodiments, the GUT targeting agent has a higher GUT transport efficiency as compared to a SUT's transport efficiency of the targeting agent (e.g., at least about 1, 2, 3, 4, 5, 6, 7, 8, 9, 10, 15, 20 or more-fold higher efficiency).

In certain embodiments, the GUT targeting agent is not a disaccharide. In certain embodiments, the GUT targeting agent is not a SUT targeting agent. In certain embodiments, the GUT targeting agent is not a sucrose.

As used herein, the term “Sucrose Transporter protein” or “SUT” refers to a membrane-anchored protein capable of transporting sucrose across a cell membrane (e.g., cell membrane of a plant cell or fungal cell). In certain embodiments, SUT refers to an endogenously expressed, cell membrane-anchored plant or fungal protein capable of transporting sucrose across a cell membrane of a plant (e.g., a monocot, or dicot plant) or fungus. Accordingly, in certain embodiments, the SUT is a plant SUT. In certain other embodiments, the SUT is a fungal SUT. SUTs are known in the art and described herein; SUTs and their roles in transporting sucrose in a plant and/or fungi, are discussed in J Doidy, et al., Trends Plant Sci. 2012 July; 17(7):413-22; C Kühn, et al., Curr Opin Plant Biol. 2010 June; 13(3):288-98; B Julius, et al., Plant Cell Physiol. 2017 Sep. 1; 58(9):1442-1460; Witteck, et al., J Integr Plant Biol. 2017 June; 59(6):422-435; Wahl, et al., PLoS Biol. 2010 February; 8(2): e1000303; and Wang et al., Front Microbiol. 2020; 11: 591697, which are incorporated by reference herein.

In certain embodiments, the SUT protein is expressed by the phloem companion cell of a plant. In certain embodiments, the SUT protein can transport an ion (e.g., proton H⁺) during the transportation of sucrose.

In certain embodiments, the SUT protein is a SUT protein expressed by wheat, oat, corn, rice, barley, a vegetable (e.g., lettuce, broccoli, carrot, spinach, or pepper), a fruit plant (e.g., apple, orange, pear, grape, or peach), or a nut tree (e.g., almond, walnut, or pecan). In certain embodiments, the SUT protein is a SUT protein expressed by a weed plant. In certain embodiments, the SUT protein may phylogenetically belong to the SUT1, SUT2, SUT3, SUT4, or SUT5 clade. In certain embodiments, the SUT protein may phylogenetically belong to the SUT1 clade (e.g., in a dicot plant). In certain embodiments, the SUT protein may phylogenetically belong to the SUT2, SUT3, SUT4, or SUT5 clade (e.g., in a monocot plant). In certain embodiments, the SUT protein expressed by a plant is Sucrose transport protein SUC2, or a plant SWEET (Sugars Will Eventually Be Exported Transporter) family member capable of transporting sucrose (e.g., AtSWEET12, AtSWEET15).

In certain embodiments, the SUT protein is expressed by a fungus that is Magnaporthe oryzae, Botrytis spp. (e.g., Botrytis cinerea), Puccinia spp., Fusarium graminearum, Fusarium oxysporum, Blumeria graminis, Mycosphaerella graminicola, Colletotrichum spp., Ustilago maydis, Melampsora lini, or Zymoseptoria tritici. In certain embodiments, the SUT protein expressed by a fungus is UmSrt1. In certain embodiments, the SUT protein is SUC2, AtSWEET12, or AtSWEET15.

As used herein, the term “a moiety or agent having affinity for a SUT” or “a SUT targeting moiety” or “a SUT targeting agent” are used interchangeably and refer to a molecule that specifically binds the SUT and/or is capable of being transported by the SUT (e.g., cross membrane transport). However, the term “SUT targeting agent” does not include the ion (proton H⁺) that may be co-transported by a SUT during the transportation of a molecule that specifically binds to the SUT (e.g., sucrose). In certain embodiments, the SUT targeting agent is a small molecule compound having a molecular weight of less than 1000 g/mol (e.g., <500 or <400 g/mol).

In certain embodiments, the SUT targeting agent (e.g., a disaccharide, such as sucrose) has higher SUT transport efficiency or higher affinity for the SUT compared to a monosaccharide (e.g., glucose). In certain embodiments, the SUT targeting agent has at least about 1, 2, 3, 4, 5, 6, 7, 8, 9, 10, 15, 20 or more-fold higher SUT transport efficiency for the SUT as compared to a monosaccharide. In certain embodiments, the SUT targeting agent has at least about 1, 2, 3, 4, 5, 6, 7, 8, 9, 10, 15, 20 or more-fold higher affinity for the SUT as compared to a monosaccharide.

In certain embodiments, the SUT targeting agent has a higher affinity for a SUT as compared to a GUT. In certain embodiments, the SUT targeting agent has at least about 1, 2, 3, 4, 5, 6, 7, 8, 9, 10, 15, 20 or more-fold higher affinity for a SUT than for a GUT. In certain embodiments, the SUT targeting agent has at least about 5-fold higher affinity for a SUT than for a GUT. In certain embodiments, the SUT targeting agent has at least about 10-fold higher affinity for a SUT than for a GUT.

In certain embodiments, the SUT targeting agent has a higher SUT transport efficiency as compared to the transport efficiency by a GUT (e.g., at least about 1, 2, 3, 4, 5, 6, 7, 8, 9, 10, 15, 20 or more-fold higher efficiency).

In certain embodiments, the SUT targeting agent is a saccharide. In certain embodiments, the SUT targeting agent is a disaccharide.

As used herein, the term “disaccharide” refers to a sugar molecule having two monosaccharides that are joined by a glycosidic linkage. Exemplary disaccharides include, but not limited to, sucrose (one glucose and one fructose joined by glycosidic linkage) and maltose (two glucose joined by glycosidic linkage).

In certain embodiments, the SUT targeting agent is a disaccharide comprising a glucose monosaccharide. In certain embodiments, the SUT targeting agent is sucrose.

Methods for determining SUT substrate binding affinity and/or SUT mediated transport are known in the art and described herein; Chandran, et al., J Biol Chem. 2003 Nov. 7; 278(45):44320-5 and Reinders, et al., Plant Cell Environ. 2006 October; 29(10):1871-80 are incorporated by reference herein. People skilled in the art would understand that in addition to SUT's cognate ligand sucrose, there are other substrates or ligands with binding affinity for sucrose transporter protein (SUT) and/or could be transported by a SUT. In certain embodiments, the SUT targeting agent is maltose.

In certain embodiments, the SUT targeting agent is a glucoside compound (e.g., salicin, phenyl α-D-glucoside, or p-nitrophenyl α-D-glucoside).

In certain embodiments, the SUT targeting agent is not a monosaccharide. In certain embodiments, the SUT targeting agent is not a GUT targeting agent. In certain embodiments, the SUT targeting agent is not glucose.

As used herein, the terms “cargo” or “chemical cargo” are used interchangeably and refer to an agent that is capable of producing a desired effect in a plant or fungus following delivery of a conjugate of the invention to the plant or fungus. For example, “cargo” may be an agent that confers benefit to the plant, such as promoting the health, growth, and/or disease treatment of a plant, such as a plant of desirable agriculture, horticulture, or forestry value. The “cargo” may also be an agent that confers a disadvantage to a plant or fungus, e.g., such as an undesirable weed (e.g., dandelion) or an invasive species that does not belong to the native local environment. In certain embodiments, the “cargo” is an agrochemical cargo when the target plant is of agricultural value or when the target plant is to be inhibited (e.g., a weed species) for the benefits of another plant of agricultural value. In certain embodiments, the “cargo” is an agrochemical (e.g., a fungicide), wherein the target fungus is undesired. In certain embodiments, the “cargo” is an agrochemical (e.g., a fungicide), wherein the target fungus is associated with (e.g., comprised within) a plant of agricultural value.

As used herein, the term “weed” refers to an undesirable plant species, for example, grass, dandelion, or broadleaf weeds in an agricultural setting such as farmland. “A weed” usually competes with the desirable plant (e.g., a cash crop) for space and/or nutrition and may be targeted for elimination (e.g., by a herbicide).

In certain embodiments, the cargo is a biomolecule (e.g., protein or nucleic acid). In certain embodiments, the cargo is a nucleic acid (e.g., a gene, siRNA, miRNA). In certain embodiments, the nucleic acid is DNA. In certain embodiments, the nucleic acid is cDNA. In certain embodiments, the nucleic acid is RNA (e.g., siRNA or miRNA). In certain embodiments, the nucleic acid is a DNA/RNA hybrid.

In certain embodiments, the nucleic acid is a pesticide (e.g., fungicide, such as an RNA based fungicide) described herein.

In certain embodiments, the nucleic acid (e.g., RNA) could be linked to a nanoparticle (e.g., carbon dot) described herein via electrostatic interactions. In certain embodiments, a nanoparticle may have a positive surface charge or functionalized with materials having a positive charge (e.g., a coating of a polymer, such as polyethylenimine (PEI)). For example, electrostatic interactions between a nanoparticle and nucleic acid is described in U.S. Pat. No. 11,186,845, which is incorporated by reference herein. In certain embodiments, the cargo is a herbicide, pesticide, or fertilizer. In certain embodiments, the cargo is an herbicide or pesticide. In certain embodiments, the cargo is a pesticide. In certain embodiments, the cargo is a herbicide. In certain embodiments, the cargo is a fertilizer.

In certain embodiments, the cargo is not a biomolecule (e.g., protein or nucleic acid). In certain embodiments, the cargo is not a nucleic acid (e.g., DNA or RNA). In certain embodiments, the cargo is not a protein.

As used herein, the term “herbicide” refers to a chemical agent used to destroy or inhibit the growth of an unwanted plant, such as a weed. Inhibition of an unwanted plant may indirectly confer a benefit for another plant of desirable agriculture, horticulture, or forestry value. A “herbicide” may be a natural or synthetic organic compound.

In certain embodiments, the herbicide is a small molecule compound having a molecular weight of less than 1000 g/mol (e.g., <800 or <700 g/mol).

In certain embodiments, the herbicide is a polypeptide or polynucleotide that inhibits the growth of an unwanted plant.

As used herein, the term “pesticide” refers to a chemical agent used to kill or inhibit a pest and/or pathogen. Pests include, but are not limited to, arthropods, e.g., insects, arachnids, and their larvae and eggs. Pathogens include, but are not limited to, fungi, viruses, and bacteria. In certain embodiments, a pest could be a transmission vector for a pathogen. Inhibition of a pest and/or a pathogen could promote the health and/or growth of a plant, and/or treat a disease of a plant infested or infected by a pest and/or a pathogen. Additionally, a pesticide may be used to inhibit a fungus by direct delivery to the fungus (i.e., a fungus that expresses SUTs or GUTs). A “pesticide” may be a natural or synthetic organic compound. In certain embodiments, the pesticide is an anti-microbial agent such as a fungicide or bactericide (e.g., antibiotic agent). In certain embodiments, the pesticide is an insecticide.

In certain embodiments, the pesticide is a small molecule compound having a molecular weight of less than 1000 g/mol (e.g., <800 or <700 g/mol).

In certain embodiments, the pesticide is a polypeptide or polynucleotide that kills or inhibits a pest and/or pathogen. Non-limiting examples of small molecule herbicide or pesticide compounds are described in U.S. Pat. Nos. 10,167,483, and 9,095,133, which are incorporated by reference herein.

In certain embodiments, the cargo may be selected from the following list of pesticides (e.g., fungicide), which is intended to illustrate possible combinations but does not limit them:

### A) Respiration Inhibitors

Inhibitors of complex III at Qₒ site: azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxy-strobin (A.1.13), pyraclostrobin (A.1.14), pyrametostrobin (A.1.15), pyraoxystrobin (A.1.16), trifloxystrobin (A.1.17), 2-(2-(3-(2,6-dichlorophenyl)-1-methyl-allylidene-aminooxymethyl)-phenyl)-2-methoxyimino-N-methyl-acetamide (A.1.18), pyribencarb (A.1.19), triclopyricarb/chlorodincarb (A.1.20), famoxadone (A.1.21), fenamidone (A.1.21), methyl-N-[2-[(1,4-dimethyl-5-phenyl-pyrazol-3-yl)oxylmethyl]phenyl]-N-methoxy-carbamate (A.1.22), metyltetraprole (A.1.25)
inhibitors of complex III at Qᵢ site: cyazofamid (A.2.1), amisulbrom (A.2.2), [(6S,7R,8R)-8-benzyl-3-[(3-hydroxy-4-methoxy-pyridine-2-carbonyl)amino]-6-methyl-4,9-dioxo-1,5-dioxonan-7-yl]2-methylpropanoate (A.2.3), fenpicoxamid (A.2.4), florylpicoxamid (A.2.5), metarylpicoxamid (A.2.6);
inhibitors of complex II: benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.15), penthiopyrad (A.3.16), pydiflumetofen (A.3.17), pyraziflumid (A.3.18), sedaxane (A.3.19), tecloftalam (A.3.20), thifluzamide (A.3.21), inpyrfluxam (A.3.22), pyrapropoyne (A.3.23), fluindapyr (A.3.28);
other respiration inhibitors: diflumetorim (A.4.1); nitrophenyl derivates: binapacryl (A.4.2), dinobuton (A.4.3), dinocap (A.4.4), fluazinam (A.4.5), meptyldinocap (A.4.6), ferimzone (A.4.7); organometal compounds: fentin salts, e.g. fentin-acetate (A.4.8), fentin chloride (A.4.9) or fentin hydroxide (A.4.10); ametoctradin (A.4.11); silthiofam (A.4.12);

### B) Sterol Biosynthesis Inhibitors (SBI Fungicides)

C14 demethylase inhibitors: triazoles: azaconazole (B.1.1), bitertanol (B.1.2), bromu-conazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothio-conazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), 2-(2,4-difluorophenyl)-1,1-difluoro-3-(tetrazol-1-yl)-1-[5-[4-(2,2,2-trifluoroethoxy)phenyl]-2-pyridyl]propan-2-ol (B.1.31), 2-(2,4-difluorophenyl)-1,1-difluoro-3-(tetrazol-1-yl)-1-[5-[4-(trifluoromethoxy)phenyl]-2-pyridyl]propan-2-ol (B.1.32), fluoxytioconazole (B.1.33), ipfentrifluconazole (B.1.37), mefentrifluconazole (B.1.38); imidazoles: imazalil (B.1.44), pefurazoate (B.1.45), prochloraz (B.1.46), triflumizol (B.1.47); pyrimidines, pyridines, piperazines: fenarimol (B.1.49), pyrifenox (B.1.50), triforine (B.1.51),
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);
Other Sterol biosynthesis inhibitors: chlorphenomizole (B.4.1);

### C) Nucleic Acid Synthesis Inhibitors

phenylamides or acyl amino acid fungicides: benalaxyl (C.1.1), benalaxyl-M (C.1.2), kiralaxyl (C.1.3), metalaxyl (C.1.4), metalaxyl-M (C.1.5), ofurace (C.1.6), oxadixyl (C.1.7);
other nucleic acid synthesis inhibitors: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxy)pyrimidin-4-amine (C.2.7), 5-fluoro-2-(4-chlorophenylmethoxy)pyrimidin-4 amine (C.2.8);

### D) Inhibitors of Cell Division and Cytoskeleton

tubulin inhibitors: benomyl (D.1.1), carbendazim (D.1.2), fuberidazole (D1.3), thiabendazole (D.1.4), thiophanate-methyl (D.1.5), pyridachlometyl (D.1.6), N-ethyl-2-[(3-ethynyl-8-methyl-6-quinolyl)oxy]butanamide (D.1.8);
other cell division inhibitors: diethofencarb (D.2.1), ethaboxam (D.2.2), pencycuron (D.2.3), fluopicolide (D.2.4), zoxamide (D.2.5), metrafenone (D.2.6), pyriofenone (D.2.7), phenamacril (D.2.8);

### E) Inhibitors of Amino Acid and Protein Synthesis

methionine synthesis inhibitors: cyprodinil (E.1.1), mepanipyrim (E.1.2), pyrimethanil (E.1.3);
protein synthesis inhibitors: blasticidin-S (E.2.1), kasugamycin (E.2.2), kasugamycin hydro-chloride-hydrate (E.2.3), mildiomycin (E.2.4), streptomycin (E.2.5), oxytetracyclin (E.2.6);

### F) Signal Transduction Inhibitors

MAP/histidine kinase inhibitors: fluoroimid (F.1.1), iprodione (F.1.2), procymidone (F.1.3), vinclozolin (F.1.4), fludioxonil (F.1.5);
G protein inhibitors: quinoxyfen (F.2.1);

### G) Lipid and Membrane Synthesis Inhibitors

Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7), zinc thiazole (G.2.8);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7);
compounds affecting cell membrane permeability and fatty acides: propamocarb (G.4.1);
inhibitors of oxysterol binding protein: oxathiapiprolin (G.5.1), fluoxapiprolin (G.5.3)
   H) Inhibitors with Multi Site Action
inorganic active substances: Bordeaux mixture (H.1.1), copper (H.1.2), copper acetate (H.1.3), copper hydroxide (H.1.4), copper oxychloride (H.1.5), basic copper sulfate (H.1.6), sulfur (H.1.7);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds: anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9),

### I) Cell Wall Synthesis Inhibitors

inhibitors of glucan synthesis: validamycin (I.1.1), polyoxin B (I.1.2);
melanin synthesis inhibitors: pyroquilon (I.2.1), tricyclazole (I.2.2), carpropamid (I.2.3), dicyclomet (I.2.4), fenoxanil (I.2.5);

### J) Plant Defence Inducers

acibenzolar-S-methyl (J.1.1), probenazole (J.1.2), isotianil (J.1.3), tiadinil (J.1.4), prohexa-dione-calcium (J.1.5); phosphonates: fosetyl (J.1.6), fosetyl-aluminum (J.1.7), phosphorous acid and its salts (J.1.8), calcium phosphonate (J.1.11), potassium phosphonate (J.1.12), potassium or sodium bicarbonate (J.1.9), 4-cyclopropyl-N-(2,4-dimethoxy-phenyl)thiadiazole-5-carboxamide (J.1.10);

### K) Unknown Mode of Action

bronopol (K.1.1), chinomethionat (K.1.2), cyflufenamid (K.1.3), cymoxanil (K.1.4), dazomet (K.1.5), debacarb (K.1.6), diclocymet (K.1.7), diclomezine (K.1.8), difenzoquat (K.1.9), di-fenzoquat-methylsulfate (K.1.10), diphenylamin (K.1.11), fenitropan (K.1.12), fenpyrazamine (K.1.13), flumetover (K.1.14), flumetylsulforim (K.1.60), flusulfamide (K.1.15), flutianil (K.1.16), harpin (K.1.17), methasulfocarb (K.1.18), nitrapyrin (K.1.19), nitrothal-isopropyl (K.1.20), tolprocarb (K.1.21), oxin-copper (K.1.22), proquinazid (K.1.23), seboctylamine (K.1.61), tebufloquin (K.1.24), tecloftalam (K.1.25), triazoxide (K.1.26).

In certain embodiments, the cargo is selected from the group consisting of chlorpyrifos, methyl viologen, oxyfluorfen, imazaquin, fluthiacet, diclofop, penoxsulam, norflurazon, trifludimoxazin, picolinafen, pyraclostrobin, boscalid, and acifluorfen.

In certain embodiments, the cargo is selected from the group consisting of allyl isothiocyanate, chlorpyrifos, methyl viologen, naphthalene, 4-chloro-2-methylphenoxyacetic acid (MCPA), norflurazon, and carbofuran.

In certain embodiments, the cargo is a fungicide that is a small molecule compound having a molecular weight of less than 1000 g/mol (e.g., <800 or <700 g/mol).

In certain embodiments, the fungicide is selected from the group consisting of Ametoctradin, Benthiavalicarb, chlorothalonil, cyazofamid, Dimoxystrobin, Etaconazole, fluopyram, myclobutanil, Oxathiapiprolin, pyraclostrobin, thiabendazole, and Spiroxamine.

In certain embodiments, the fungicide is selected from the group consisting of Ametoctradin, Benthiavalicarb, Etaconazole, fluopyram, Oxathiapiprolin, and Spiroxamine.

In certain embodiments, the fungicidal agent is a polypeptide or polynucleotide that kills or inhibits a fungus pathogen.

As used herein, the term “fertilizer” refers to a chemical agent used for its nutritional value in promoting the health or growth of a plant. A “fertilizer” may be an organic or inorganic compound.

As used herein, the term “molecular basket” refers to a cyclodextrin. Cyclodextrins are a family of cyclic oligosaccharides, consisting of a macrocyclic ring of glucose subunits (e.g., about 6-8 glucose subunits) joined by α-1,4 glycosidic bonds. Examples of molecular baskets include alpha-cyclodextrin, beta-cyclodextrin, and gamma-cyclodextrin.

In certain embodiments, the molecular basket comprises an alpha-cyclodextrin, beta-cyclodextrin or gamma-cyclodextrin. In certain embodiments, the molecular basket is alpha-cyclodextrin, beta-cyclodextrin, or gamma-cyclodextrin. Chemical cargo described herein may form a complex with the molecular basket (e.g., loaded into a molecular basket). The molecular basket may be directly or indirectly linked to a SUT or GUT targeting agent. The molecular basket may also be linked either directly or indirectly to a nanoparticle (e.g., a molecular basket may be comprised within a linker group). The molecular basket may comprise a group including, but not limited to, —COOH, amine, thiol, azide, maleimide, or boronic acid for linking with a SUT or GUT targeting agent and/or a nanoparticle. Exemplary cyclodextrins with such a functional group include, but are not limited to, succinyl-β-cyclodextrin, mono-(6-ethanediamine-6-deoxy)-β-Cyclodextrin, or mono-(6-mercapto-6-deoxy)-β-Cyclodextrin.

As used herein, the term “nanoparticle” or “nanomaterial” refers to a nanoparticle or nanomaterial selected from the group consisting of a quantum dot, carbon dot, carbon nanotube (e.g., single walled carbon nanotube (SWCNT)), silica nanoparticle (e.g., porous silica nanoparticle), lipid nanoparticle, liposome, metal or metal oxide nanoparticle (e.g., gold, silver, copper, zinc, zinc oxide, magnesium, magnesium oxide, cerium oxide, or iron oxide nanoparticle), and a micro or macro nutrient-based nanoparticle (e.g., nitrogen, phosphorous, copper, zinc, magnesium, etc.) In certain embodiments, the “nanoparticle” or “nanomaterial” has a dimension in the range of about 1 nm to 1000 nm. For example, the nanostructure (e.g., nanoparticle) may have a longest dimension (e.g., diameter) in the range of about 1˜900 nm, 1˜800 nm, 1˜700 nm, 1˜600 nm, 1˜500 nm, 1˜400 nm, 1˜300 nm, 1˜250 nm, 1˜200 nm, 1˜150 nm, 1˜100 nm, 1˜90 nm, 1˜80 nm, 1˜70 nm, 1˜60 nm, 1˜50 nm, 1˜40 nm, 1˜30 nm, 1˜25 nm, 1˜20 nm, 1˜15 nm, 1˜10 nm or 1˜5 nm. The “nanoparticle” or “nanomaterial” may be approximately spherical, or non-spherical. Methods for characterizing nanoparticles or nanomaterials are known in the art and are described herein (e.g., electron microscopy, dynamic light scattering, or atomic force microscopy).

In certain embodiments, the nanoparticle or nanomaterial may carry a cargo. For example, cargo may be loaded (e.g., encapsulated or partitioned) within the nanoparticle, e.g., in a lipid nanoparticle, or liposome (in lipid layer and/or in aqueous core of liposome). However, the cargo may also by conjugated or linked to the surface of the nanoparticle.

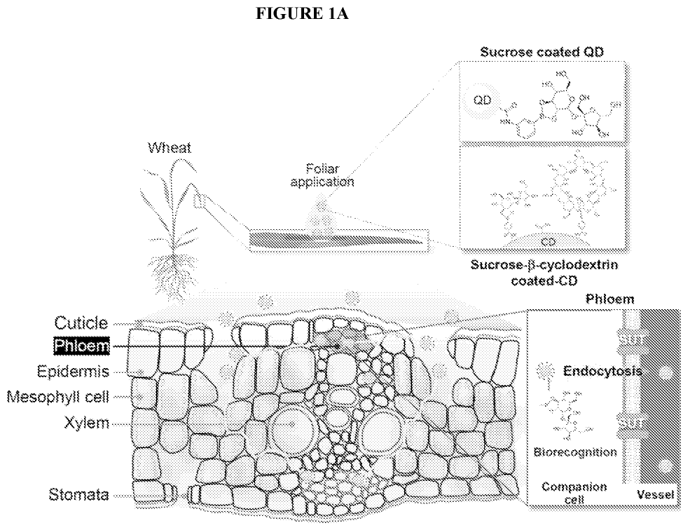

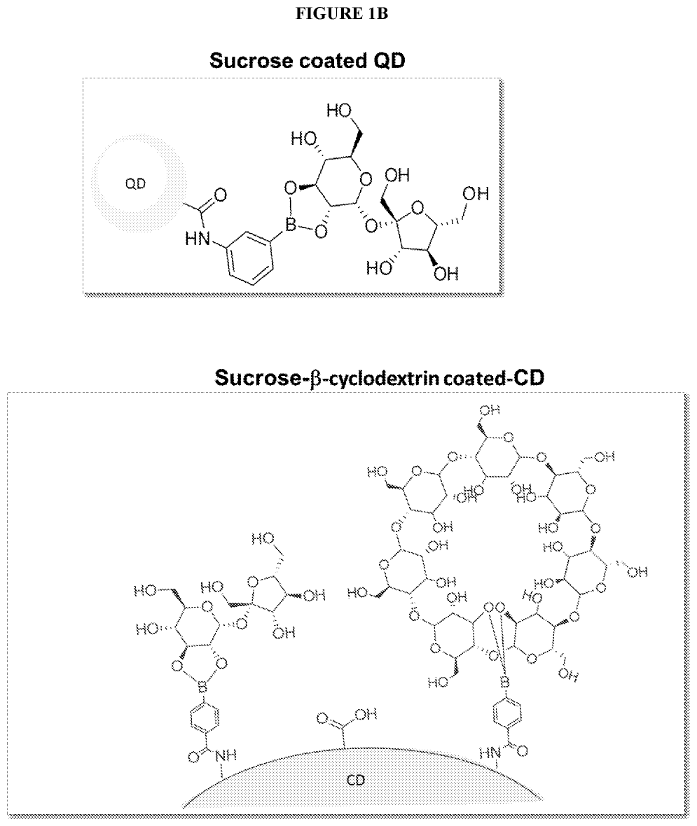

In certain embodiment, the nanoparticle surface (e.g., a carbon dot, see FIG. 1) may be dual-functionalized with a cyclodextrin molecular basket and a SUT targeting agent (e.g., sucrose), wherein cargo may be loaded within the cyclodextrin molecular basket.

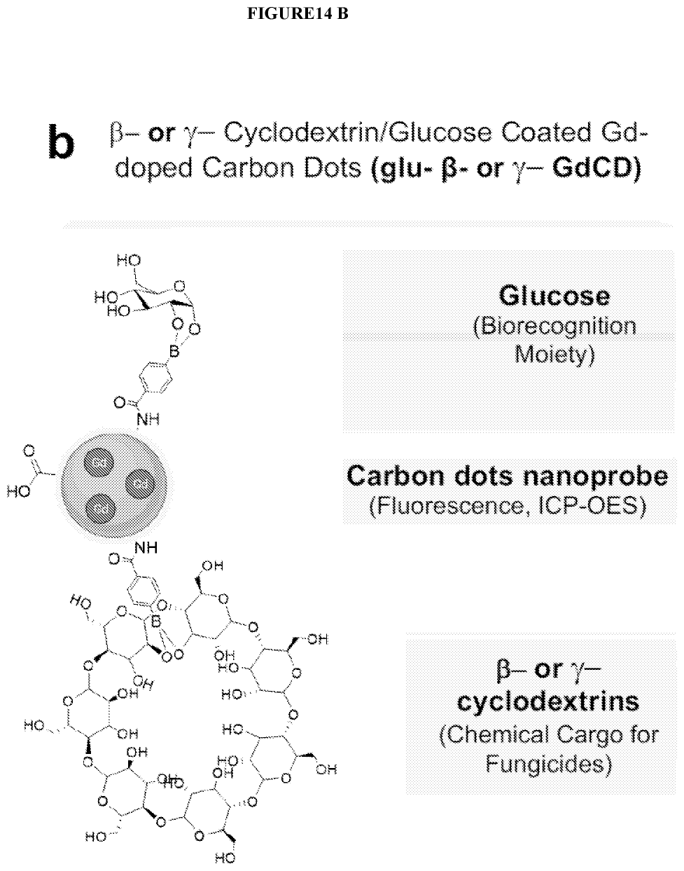

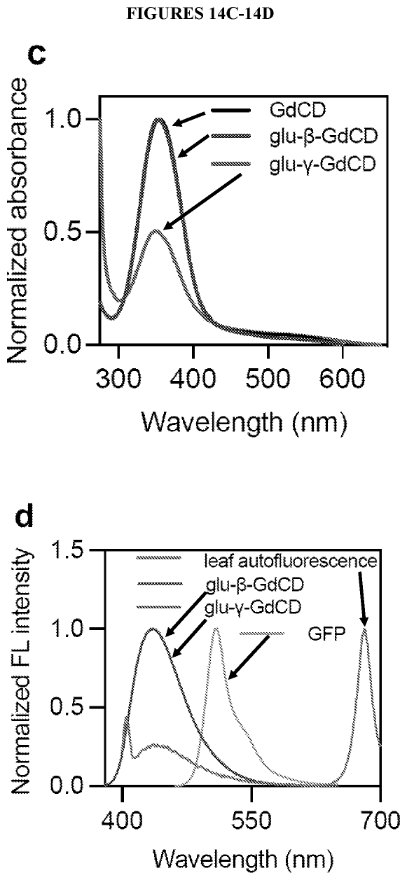

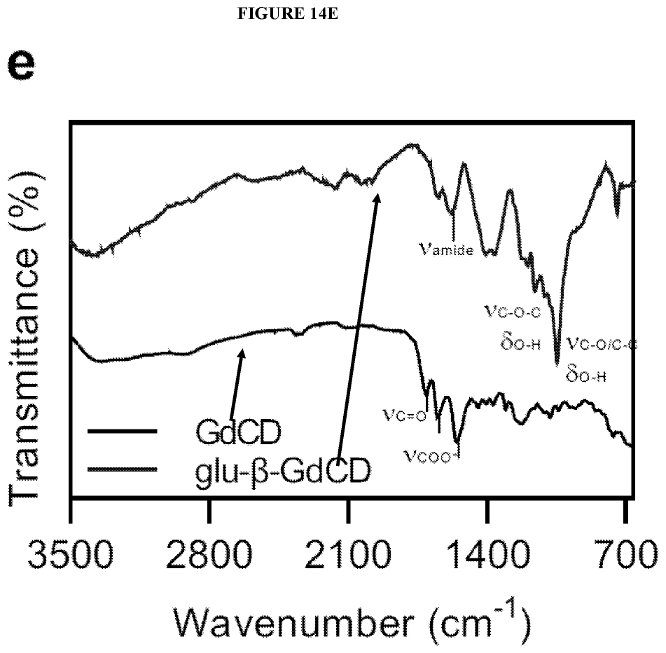

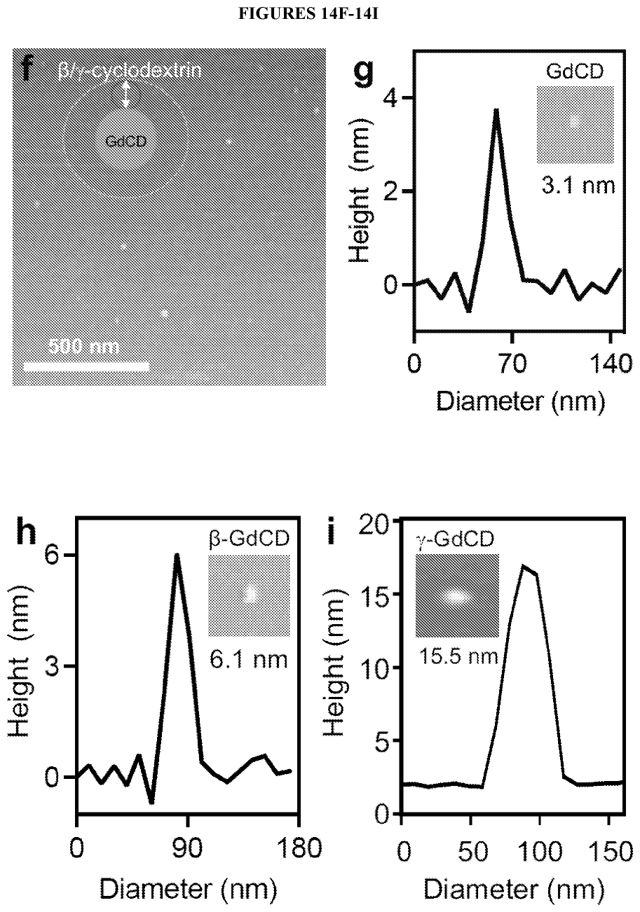

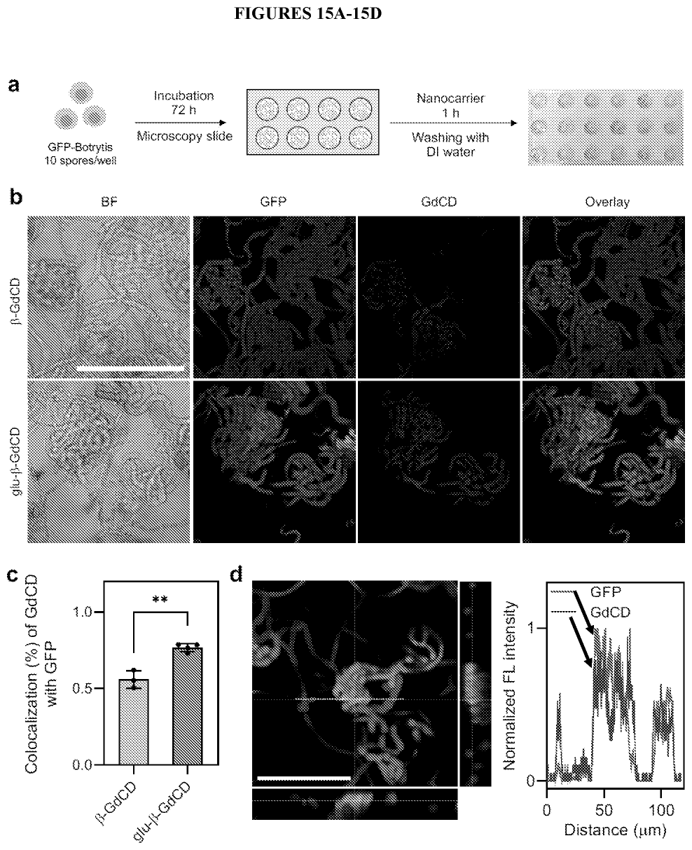

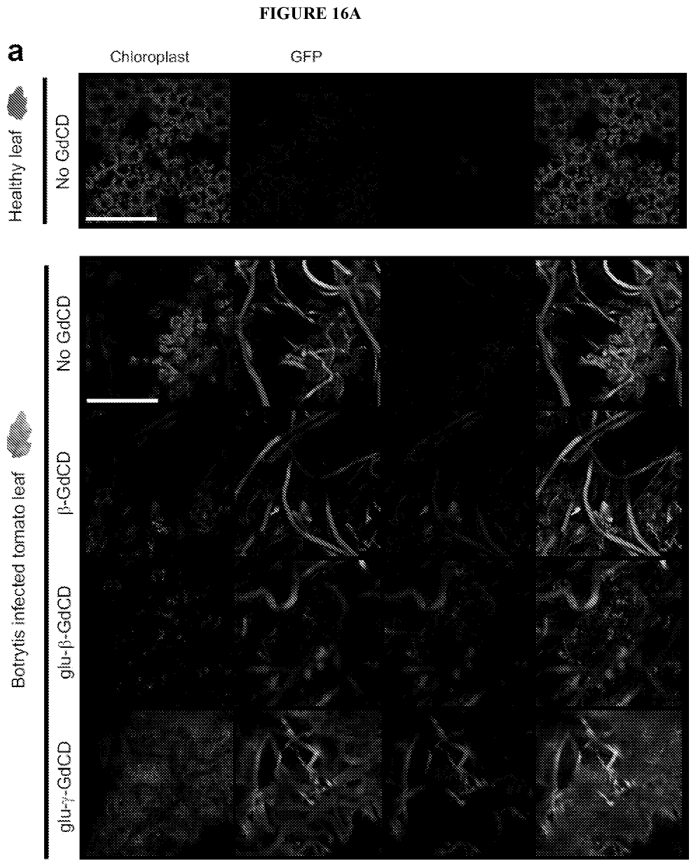

In certain embodiment, the nanoparticle surface (e.g., a carbon dot, see FIG. 14) may be dual-functionalized with a cyclodextrin molecular basket and a GUT targeting agent (e.g., glucose), wherein cargo may be loaded within the cyclodextrin molecular basket.

In certain embodiments, the nanoparticle is a quantum dot, carbon dot, carbon nanotube, silica nanoparticle (e.g., porous silica nanoparticle), metal or metal oxide nanoparticle, lipid nanoparticle, or liposome.

In certain embodiments, the nanoparticle is a carbon dot, carbon nanotube, silica nanoparticle (e.g., porous silica nanoparticle), metal or metal oxide nanoparticle, lipid nanoparticle, or liposome.

In certain embodiments, the nanoparticle is a carbon dot, carbon nanotube, silica nanoparticle (e.g., porous silica nanoparticle), lipid nanoparticle, or liposome.

In certain embodiments, the nanoparticle is a carbon dot, carbon nanotube, or silica nanoparticle (e.g., porous silica nanoparticle).

In certain embodiments, the nanoparticle is a quantum dot. In certain embodiments, the nanoparticle is not a quantum dot.

In certain embodiments, the nanoparticle is a carbon dot. In certain embodiments, the nanoparticle is not a carbon dot.

In certain embodiments, the nanoparticle is a silica nanoparticle (e.g., mesoporous silica nanoparticle). In certain embodiments, the nanoparticle is not a silica nanoparticle.

In certain embodiments, the nanoparticle is a metal or metal oxide nanoparticle (e.g., gold, silver, copper, zinc, zinc oxide, magnesium, magnesium oxide, cerium oxide, or iron oxide nanoparticle). In certain embodiments, the nanoparticle is not a metal or metal oxide nanoparticle (e.g., gold, silver, or iron oxide nanoparticle).

In certain embodiments, the nanoparticle is a carbon dot comprising metal (e.g., metal doped carbon dot). In certain embodiments, the nanoparticle is a carbon dot that does not comprise metal.

In certain embodiments, the nanoparticle is a micro or macro nutrient-based nanoparticle that could serve as a nano-fertilizer that supplements a plant with micro or macro nutrient(s) (e.g., nitrogen, phosphorus, copper, zinc, or magnesium). In certain embodiments, the nanoparticle is a phosphorus nano-fertilizer such as nano-sized hydroxyapatite (Ca₅(PO₄)₃OH). In certain embodiments, the nanoparticle is a urea-modified hydroxyapatite nanoparticle. In certain embodiments, the nanoparticle is not a micro or macro nutrient-based nanoparticle.

Surface modification methods for nanoparticles (e.g., hydroxyapatite, metal, or metal oxide nanoparticles) are known in the art and described herein. In certain embodiments, the surface of a hydroxyapatite, metal or metal oxide nanoparticle may have a layer of silica coating (SiO₂). In certain embodiments, the surface of a hydroxyapatite, metal or metal oxide nanoparticle may be functionalized with a linker described herein including a silane-based molecule or a polymer such as PEG that could be further functionalized with a SUT targeting agent (e.g., sucrose) as described herein.

In certain embodiments, the nanoparticle is a lipid nanoparticle or liposome. In certain embodiments, the nanoparticle is not a lipid nanoparticle or liposome.

As used herein, the term “linked” refers to a linkage of two elements in a functional relationship. For example, “linked” may refer to a linkage of a cargo (e.g., herbicide or pesticide) and a targeting agent (e.g., SUT targeting agent, such as sucrose; or GUT targeting agent, such as glucose) in a functional relationship. The term “linked” also refers to the linkage/association of two chemical moieties so that the location or biodistribution of one might be affected by the other. For example, a cargo is said to be “linked to” or “associated with” a targeting moiety, wherein after the introduction of a cargo to a plant or fungus in need thereof, the cargo's transport/biodistribution into and within the plant/fungus is affected by the linked targeting moiety. Thus, as used herein, the functional relationship between the cargo and the linked targeting moiety may involve co-transportation and/or colocalization within certain plant compartments (e.g., leaf, stem, root, or vasculature such as phloem) or fungal compartments during a certain stage of the transport.

The cargo may be directly or indirectly linked with the targeting moiety. The cargo is said to be directly linked with the targeting agent when the cargo molecule is covalently bonded with the targeting agent.

The cargo is said to be indirectly linked with the targeting agent when the cargo is linked to the targeting agent through, for example, a linker and/or other materials (e.g., NP or cyclodextrin). For example, the cargo may be loaded within a nanoparticle or a cyclodextrin molecular basket, while the nanoparticle or molecular basket is functionalized with the targeting moiety. Thus, in certain embodiments, although the cargo may not be covalently linked with the targeting moiety, the cargo is “linked to” or “associated with” the targeting moiety through the nanoparticle and/or molecular basket. In certain embodiments, the cargo is loaded in a molecular basket, which is linked either directly or indirectly to a nanoparticle, and wherein the nanoparticle is linked either directly or indirectly to the targeting agent.

Accordingly, in certain embodiments, the cargo is indirectly linked to the targeting agent via a nanoparticle and/or a cyclodextrin molecular basket. In certain embodiments, the cargo is indirectly linked to the SUT targeting agent via a nanoparticle and/or a cyclodextrin molecular basket. In certain embodiments, the cargo is indirectly linked to the GUT targeting agent via a nanoparticle and/or a cyclodextrin molecular basket.

In certain embodiments, the cargo is loaded within the nanoparticle or cyclodextrin molecular basket.

In certain embodiments, the cargo is loaded within the nanoparticle.

In certain embodiments, the cargo is loaded within the cyclodextrin molecular basket.

In certain embodiments, the cargo is conjugated onto the surface of the nanoparticle.

In certain embodiments, the conjugate comprises or consists of a conjugate of Formula I:

NP-(linker-TA)ₙ (Formula I)

wherein: NP is the nanoparticle; TA is the Sucrose Transporter protein (SUT) targeting agent or the Glucose Transporter protein (GUT) targeting agent; the linker has a molecular weight of from about 20 daltons to about 20,000 daltons; and n is an integer≥1. In certain embodiments, the TA is the SUT targeting agent. In certain embodiments, the TA is the GUT targeting agent. In certain embodiments, the conjugate comprises a mixture of SUT and GUT targeting agents.

As described herein, a nanoparticle (NP) has a surface area that may be functionalized with one or more targeting agents. For example, the integer “n” indicates that the nanoparticle surface may comprise a plurality of linker-SUT targeting agents (e.g., linker-Sucrose) or a plurality of linker-GUT targeting agents (e.g., linker-glucose). Accordingly, the conjugates described herein may comprise a nanoparticle (NP) linked to one or more Sucrose Transporter protein (SUT) targeting agents (that may be same or different SUT targeting agents). Namely, a NP surface could be coated with “n” copy number of the SUT targeting agent (e.g., Sucrose). Alternatively, certain conjugates described herein may comprise a nanoparticle (NP) linked to one or more glucose Transporter protein (GUT) targeting agents (that may be same or different GUT targeting agents). Thus, a NP surface could be coated with “n” copy number of the GUT targeting agent (e.g., glucose). In certain embodiments, a NP surface could be coated with “n” copy number of the SUT targeting agents (e.g., sucrose) and GUT targeting agents (e.g., glucose). Depending on the NP size and the surface functionalization reaction, the copy number of the targeting agents presented on the NP surface may vary. In certain embodiments, “n” is about 10, 10², 10³, 10⁴, 10⁵, 10⁶, 10⁷, 10⁸, 10⁹, or more. In certain embodiments, “n” is from about 1 to 10⁹, 1 to 10⁸, 1 to 10⁷, 1 to 10⁶, 1 to 10⁵, 1 to 10⁴, 1 to 10³, 1 to 10², or 1 to 10. In certain embodiments, “n” is from about 1 to 10⁶, or 10 to 10⁴.

In certain embodiments, the nanoparticle is selected from the group consisting of a carbon dot, carbon nanotube, silica nanoparticle (e.g., porous silica nanoparticle), lipid nanoparticle, liposome, metal or metal oxide nanoparticle, and a micro or macro nutrient-based nanoparticle.

In certain embodiments, the nanoparticle is selected from the group consisting of a carbon dot, carbon nanotube, silica nanoparticle (e.g., porous silica nanoparticle), lipid nanoparticle, liposome, and metal or metal oxide nanoparticle.

In certain embodiments, the conjugate comprises or consists of a conjugate of Formula Ia:

NP-(linker-Sucrose)ₙ (Formula Ia).

In certain embodiments, one terminal of the linker comprises a boronic acid group that binds the SUT targeting agent (e.g., a disaccharide such as sucrose).

In certain embodiments, the conjugate comprises or consists of a conjugate of Formula Ia′:

NP-(linker-glucose)ₙ (Formula Ia′).

In certain embodiments, one terminal of the linker comprises a boronic acid group that binds the GUT targeting agent (e.g., a monosaccharide such as glucose).

In certain embodiments, the “linked” cargo, and SUT targeting agent or GUT targeting agent, are co-colocalized within a formulation before introduction to a target plant or fungus, or once introduced to a plant/fungus are co-colocalized during a certain stage of transportation within the plant/fungus (e.g., during transport from a leaf surface to leaf phloem vein) so that the distance between the cargo and linked targeting agent are usually within micron/submicron range. The distance between a cargo and a linked targeting moiety may depend on the cargo-targeting moiety arrangement such as size of linker and/or size of nanoparticle. For example, the distance between a cargo and linked targeting agent may be within about 1 nm to 1000 nm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 90 nm, 1 nm to 80 nm, 1 nm to about 70 nm, 1 nm to 60 nm, 1 nm to 50 nm, 1 nm to about 40 nm, 1 nm to 30 nm, 1 nm to 20 nm, 1 nm to 10 nm, or 1 nm to 5 nm.

In certain embodiments, during the initial stage of mass transport once introduced to a plant or fungus, a cargo and linked targeting moiety may be colocalized with each other within a distance of about 1000 nm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm or less.

In certain embodiments, the nanoparticle or a conjugate (e.g., the conjugate of Formula I) described herein has a diameter of about 5 nm, 10 nm, 15 nm, 20 nm, 25 nm, 30 nm, 40 nm, 50 nm, 60 nm, 70 nm, 80 nm, 90 nm, 100 nm, 150 nm, 200 nm, 250 nm, 300 nm, 400 nm, 500 nm, 600 nm, 700 nm, 800 nm, 900 nm, or 1000 nm. In certain embodiments, a nanoparticle or a conjugate described herein has a diameter of about 5, 10, 15, 20, 25, 30, 40, 50, 60, 70, 80, 90, 100, 150, 200, 250, or 300 nm. In certain embodiments, the nanoparticle or a conjugate described herein has a diameter of about 5 nm, 10 nm, 15 nm, 20 nm, 25 nm, 30 nm, 40 nm, 50 nm, 60 nm, 70 nm, 80 nm, 90 nm, or 100 nm. In certain embodiments, the nanoparticle or a conjugate described herein has a diameter of about 15 nm, 20 nm, 25 nm, 30 nm, 40 nm, 50 nm, 60 nm, or 70 nm. In certain embodiments, a nanoparticle or a conjugate described herein has a diameter of about 5, 10, 15, 20, 25, 30, or 40 nm.

In certain embodiments, a nanoparticle or a conjugate (e.g., the conjugate of Formula I) described herein has a diameter range of about 1-1000 nm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 90 nm, 1 nm to 80 nm, 1 nm to 70 nm, 1 nm to 60 nm, 1 nm to 50 nm, 1 nm to about 40 nm, 1 nm to 30 nm, 1 nm to 20 nm, 1 nm to 10 nm, or 1 nm to 5 nm. In certain embodiments, a nanoparticle or a conjugate described herein has a diameter range of about 5 nm to 400 nm, 5 nm to 350 nm, 5 nm to 300 nm, 5 nm to 250 nm, 5 nm to 200 nm, 5 nm to 150 nm, 5 nm to 100 nm, 5 nm to 90 nm, 5 nm to 80 nm, 5 nm to 70 nm, 5 nm to 60 nm, or 5 nm to 50 nm. In certain embodiments, a nanoparticle or a conjugate described herein may have a diameter range of about 1 nm to 200 nm, 5 nm to 150 nm, 10 nm to 120 nm, 15 nm to 100 nm, or 20 nm to 90 nm. In certain embodiments, a nanoparticle or a conjugate described herein may have a diameter range of about 1 nm to 40 nm, 5 nm to 40 nm, 10 to 40 nm, 15 to 40 nm, 20 to 40 nm, or 25 to 40 nm. In certain embodiments, a nanoparticle or a conjugate described herein may have a diameter range of about 5 nm to 15 nm, 10 nm to 25 nm, 15 to 30 nm, or 20 to 50 nm.

In certain embodiments, a nanoparticle or a conjugate described herein may have a diameter of at least about 5 nm, 10 nm, 15 nm, 20 nm, 25 nm, 30 nm, or larger (e.g., at least 5 nm, 10 nm, or 15 nm).

In certain embodiments, a nanoparticle or a conjugate described herein may have a diameter of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 nm. In certain embodiments, a nanoparticle or a conjugate described herein may have a diameter of at least about 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, or larger.

In certain embodiments, the nanoparticle or a conjugate diameter is a hydrodynamic diameter (e.g., determined by dynamic light scattering). In certain embodiments, the nanoparticle or a conjugate diameter is determined by electron microscopy. In certain embodiments, the nanoparticle or a conjugate diameter is determined by atomic force microscopy (AFM).

In certain embodiments, a nanoparticle or a conjugate (e.g., the conjugate of Formula I) described herein may have a negative zeta potential of about −5 to −90, −10 to −80, −15 to −70, or −20 to −60 mV. In certain embodiments, a nanoparticle or a conjugate (e.g., the conjugate of Formula I) described herein may have a negative zeta potential of about −5, −10, −15, −20, −30, −40, −50, −60, or −70 mV. In certain embodiments, a nanoparticle or a conjugate (e.g., the conjugate of Formula I) described herein may have a negative zeta potential of at least about −5, −10, −15, −20, −30, −40, −50, −60, −70 mV, or higher in absolute value of the negative zeta potential (e.g., at least −20, or −30 mV).

In certain embodiments, a nanoparticle or a conjugate (e.g., the conjugate of Formula I) described herein may have a positive zeta potential of about 5 to 90, 10 to 80, 15 to 70, or 20 to 60 mV. In certain embodiments, a nanoparticle or a conjugate (e.g., the conjugate of Formula I) described herein may have a positive zeta potential of about 5, 10, 15, 20, 30, 40, 50, 60, or 70 mV. In certain embodiments, a nanoparticle or a conjugate (e.g., the conjugate of Formula I) described herein may have a positive zeta potential of at least about 5, 10, 15, 20, 30, 40, 50, 60, 70 mV, or higher (e.g., at least 20, or 30 mV).

As used herein, the term “Linker” or “Linking moiety” refers to a functional group that covalently bonds two or more moieties in a compound or material. For example, the linking moiety can serve to covalently bond a SUT targeting agent to a cargo, a nanoparticle, and/or a molecular basket. The linking moiety can serve to covalently bond a GUT targeting agent to a cargo, a nanoparticle, and/or a molecular basket. Similarly, the linking moiety can serve to covalently bond a molecular basket to a nanoparticle. Useful bonds for connecting linking moieties to a compound and other materials include, but are not limited to, amides, amines, esters, carbamates, ureas, thioethers, thiocarbamates, thiocarbonates, thioureas, siloxane, and boron-oxygen bond. For example, exemplary useful bonds may include boron-oxygen bond —B(R_{c})₂, wherein R_{c} is each O—; and siloxane bond —Si(R_{b})₃, wherein R_{b} is each independently —OH, O—, or (C₁-C₄)alkoxy, each O— of the siloxane bond may be bonded to the surface of a silica nanoparticle or may be bonded to a neighboring Si atom. In certain embodiments, the boron-oxygen bond is —B(O—)₂.

In certain embodiments, the linker comprises a boronic acid group —B(O—)₂, wherein each O— is bonded to the targeting agent (TA).

In certain embodiments, the linker has a molecular weight of from about 20 daltons to about 20,000 daltons.

In certain embodiments, the linker has a molecular weight of from about 20 daltons to about 10,000 daltons.

In certain embodiments, the linker has a molecular weight of from about 20 daltons to about 5,000 daltons.

In certain embodiments, the linker has a molecular weight of from about 20 daltons to about 3,000 daltons.

In certain embodiments, the linker has a molecular weight of from about 20 daltons to about 2,000 daltons.

In certain embodiments, the linker has a molecular weight of from about 20 daltons to about 1,000 daltons.

In certain embodiments, boron-oxygen bond can form bidentate bonds with two hydroxy groups (e.g., syn-periplanar dihydroxy groups) of a saccharide moiety.

In certain embodiments, one terminal of the linker comprises a boronic acid group that binds the SUT targeting agent (e.g., a disaccharide such as sucrose).

In certain embodiments, one terminal of the linker comprises a boronic acid group that binds the GUT targeting agent (e.g., a monosaccharide such as glucose).

In certain embodiments, the linker or linking moiety comprises a divalent, saturated or unsaturated, branched or unbranched (C₂-C₁₈)hydrocarbon chain, wherein one or more carbon of the hydrocarbon chain is optionally replaced with —O—, —N(Rₛ)—, —S—, aryl (e.g., —C₆H₄—), or heteroaryl, and wherein the hydrocarbon chain is optionally substituted on carbon with one or more substituents selected from the group consisting of halo, hydroxy, mercapto, oxo (═O) and thioxo (═S); and Rₛ is H or (C₁-C₆) alkyl.

In certain embodiments, the linker has structure —X—Y—Z—:
X is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂,
Z is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂;
Rₐ is H or (C1-C₆)alkyl;
each R_{b} is independently O—, —OH or (C₁-C₄)alkoxy;
each R_{c} is O— that is linked to TA;
Y is a divalent, saturated or unsaturated, branched or unbranched (C₂-C₁₈) hydrocarbon chain, wherein one or more carbon of the hydrocarbon chain is optionally replaced with —O—, —N(Rₛ)—, —S—, aryl (e.g., —C₆H₄—), or heteroaryl, and wherein the hydrocarbon chain is optionally substituted on carbon with one or more substituents selected from the group consisting of halo, hydroxy, mercapto, oxo (═O) and thioxo (═S); and Rₛ is H or (C₁-C₆) alkyl.

In certain embodiments, X is —Si(R_{b})₃.

In certain embodiments, Z is —B(O—)₂.

In certain embodiments, the linker or linking moiety comprises a polyethylene glycol (PEG) segment with formula —(OCH₂CH₂)ₘ—, wherein m is an integer from 2 to 120 (e.g., m is 24, 43, 80, or 113). For example, the linker or linking moiety may comprises a PEG segment of PEG(400), PEG(600), PEG(1000), PEG(2000), or PEG(5000).

In certain embodiments, the linker may comprise a PEG portion and a hydrocarbon chain portion as described above, wherein the hydrocarbon chain portion is capable of anchoring onto a nanoparticle. For example, a linker may comprise a PEG portion, and a chain (e.g., C₂₋₈ alkyl) capable of anchoring onto a nanoparticle. Such non-limiting exemplary linker examples include Si(R_{b})₃—(CH₂)ₙ—PEG-, or Si(R_{b})₃—(CH₂)₃—NHC(═O)NH—(CH₂)₂-PEG-, or —S—(CH₂)ₙ-PEG-, or —S—(CH₂)₂—C(═O)NH—(CH₂)₂-PEG-, wherein the alkyl chain may be anchored onto a silica nanoparticle via siloxane bond or may be anchored onto a metal nanoparticle via thiol bond, and the PEG could be functionalized, e.g., with amine, carboxy group, or boronic acid as described above for conjugation with a targeting moiety.

In certain embodiments, the linker may be an amphiphilic linker comprising a relatively hydrophilic portion (e.g., PEG) and a hydrophobic portion, wherein the hydrophobic portion is capable of partitioning into a nanoparticle. For example, a linker may comprise a PEG portion and a hydrophobic portion of lipid tail capable of partitioning into lipid nanoparticle or lipid layer of liposome, such non-limiting exemplary linker examples include phospholipid derivatives (e.g., phospholipid-PEG-), such as 1,2-distearoyl-sn-glycero-3-phosphoethanolamine-N-polyethylene glycol (DSPE-PEG-) and 1,2-dioleoyl-sn-glycero-3-phosphoethanolamine-N-polyethylene glycol (DOPE-PEG-), wherein the PEG could be functionalized, e.g., with amine, carboxy group, or boronic acid as describe above for conjugation with a targeting moiety.

In certain embodiments, the linker comprises a phenylboronic acid (PBA) group. In certain embodiments, the linker is terminated with —(C₆H₄)—B(O—)₂.

In certain embodiments, the linker comprises an animo-phenylboronic acid (APBA) group (e.g., 3-animo-phenylboronic acid). In certain embodiments, the linker is terminated with —C(═O)NH—(C₆H₄)—B(O—)₂. In certain embodiments, the linker is —C(═O)NH—(C₆H₄)—B(O—)₂.

In certain embodiments, the linker comprises a carboxy-phenylboronic acid (CPBA) group (e.g., 4-carboxy-phenylboronic acid). In certain embodiments, the linker is terminated with —NHC(═O)—(C₆H₄)—B(O—)₂. In certain embodiments, the linker is —NHC(═O)—(C₆H₄)—B(O—)₂.

In certain embodiments, the conjugate comprises or consists of a conjugate of Formula Ib1 or Formula Ib2.

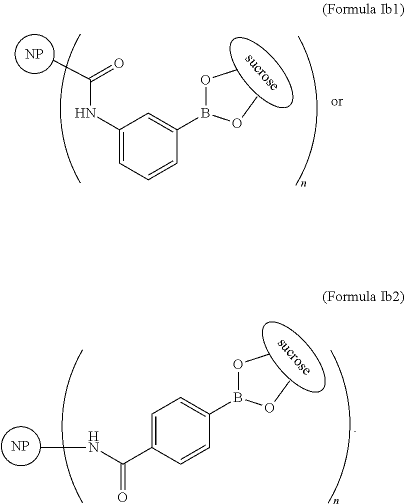

In certain embodiments, the conjugate comprises or consists of a conjugate of Formula Ib3 or Formula Ib4:

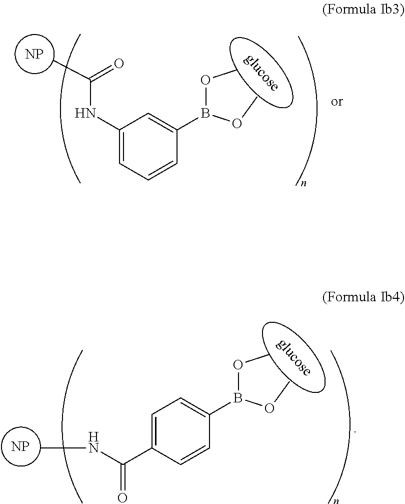

In certain embodiments, the conjugate comprises or consists of a conjugate of Formula Ic1 or Formula Ic2:

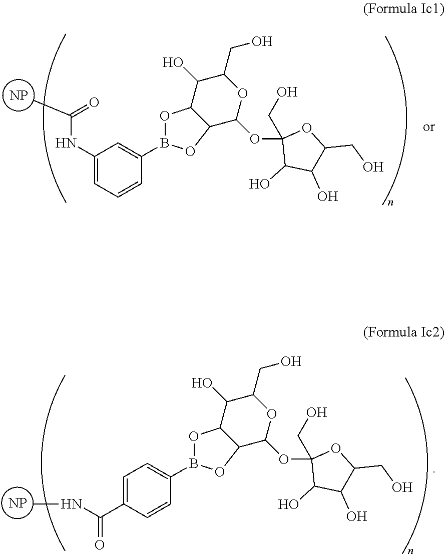

In certain embodiments, the conjugate comprises or consists of formula Ic3 or formula Ic4:

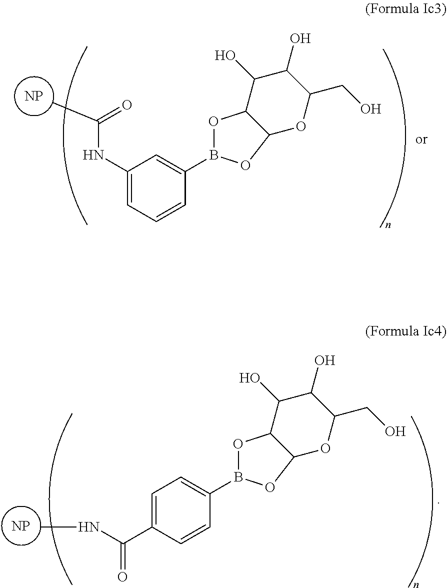

In certain embodiments, the conjugate comprises or consists of formula Ic5 or formula Ic6:

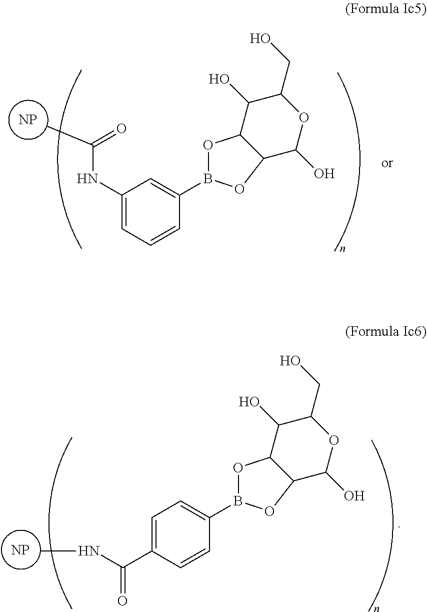

In certain embodiments, the conjugate comprises or consists of a conjugate of Formula Id1 or Formula Id2:

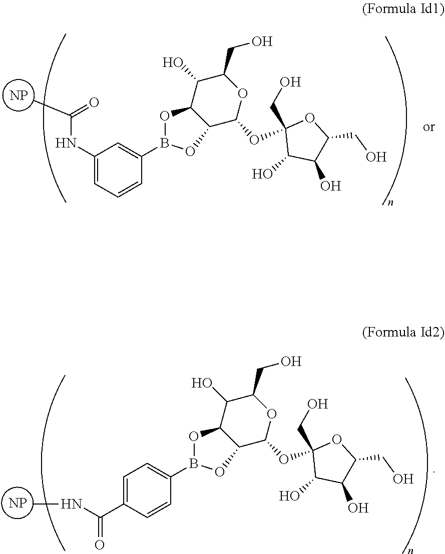

In certain embodiments, the conjugate comprises or consists of a conjugate of Formula

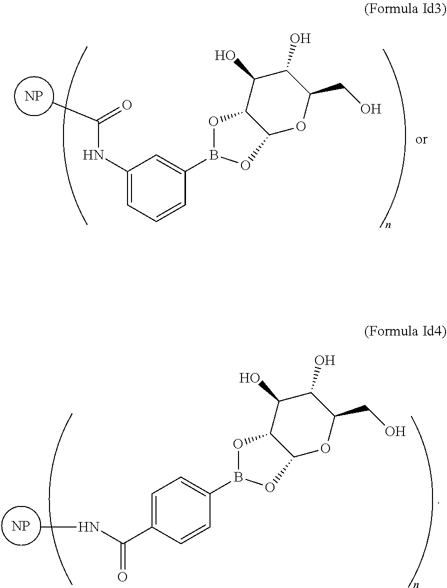

In certain embodiments, the conjugate comprises or consists of a conjugate of Formula Id5 or Formula Id6:

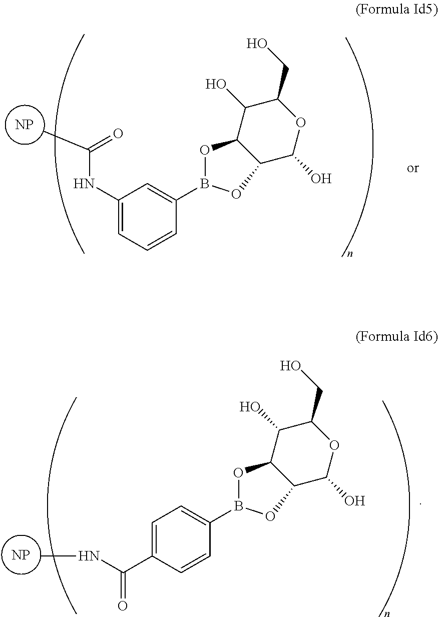

People skilled in the art would appreciate that the linker that binds a targeting moiety at one end also has another end that binds the nanoparticle surface or partitions into the nanoparticle. Following examples are illustrative.

As a non-limiting example, a quantum dot may be a nanocrystal and has a core-shell structure. For example, a quantum dot may comprise nanocrystals of a semiconductor material (e.g., CdSe), which are shelled with an additional semiconductor layer (ZnS). The quantum dot may have carboxyl modified surface and/or coating. For example, the QD may be surface-modified with an acid (e.g., oleic acid or 3-mercaptopropionic acid) or the QD may be coated with a layer of polymeric coating with carboxy terminals (e.g., PEG-COOH). Such carboxy terminals could be further functionalized with amino-phenylboronic acid (APBA) that is capable of binding a SUT targeting agent, such as sucrose, or a GUT targeting agent, such as glucose.

As a non-limiting example, a mesoporous silica nanoparticle could be functionalized by a silane-based molecule, including but not limited to a triethoxysilane based molecule, such as (3-triethoxysilyl)propylsuccinic anhydride (TESP), or 3-Aminopropyl triethoxysilane (APTES). The silane-based molecule could anchor itself on the surface of a silica nanoparticle (e.g., via the triethoxysilane end). In certain embodiments, the silane-based molecule may comprise a hydrocarbon chain of C₂₋₁₈ (e.g., C₂₋₈), wherein one or more carbon is optionally replaced with —O—, —N(Rₐ)—, or —S—, wherein Rₐ is H or (C₁-C₆) alkyl, and the hydrocarbon chain could therefore be presented on the surface of the nanoparticle. The silane-based molecule may be terminated with a group including, but not limited to, —COOH, amine, thiol, azide, maleimide, or boronic acid. Eventually, a SUT targeting agent could be linked to the silane-based molecule, for example, forming a SUT targeting agent terminated silane-based molecule. Similarly, a GUT targeting agent could be linked to the silane-based molecule, for example, forming a GUT targeting agent terminated silane-based molecule.

As a non-limiting example, a liposome or lipid nanoparticle could be functionalized by an amphiphilic phospholipid molecule (e.g., a phospholipid-PEG-), wherein the hydrophobic lipid tail partitions into the liposome lipid layer or lipid nanoparticle, and the hydrophilic head is presented on the surface of the liposome or lipid nanoparticle. The hydrophilic head may comprise a PEG chain and/or may be terminated with a group including, but not limited to, —COOH, amine, thiol, azide, maleimide, or boronic acid. Eventually, a SUT targeting agent could be linked to the hydrophilic head, for example, forming a SUT targeting agent terminated hydrophilic head. Similarly, a GUT targeting agent could be linked to the hydrophilic head, for example, forming a GUT targeting agent terminated hydrophilic head.

In certain embodiments, the nanoparticle (e.g., carbon dot) surface in a conjugate comprising a conjugate of formula I as describe herein is further functionalized with one or more cyclodextrin molecular baskets, wherein cargo may be loaded within the molecular basket (see Example 1, FIG. 1; or see Example 2, FIG. 14). In certain embodiments, the nanoparticle in the conjugate comprising a conjugate of formula I as describe herein is further functionalized with one or more cyclodextrin molecular baskets via a linker described herein. As non-limiting examples, in certain embodiments, the linker comprises a phenylboronic acid (PBA) group. In certain embodiments, the linker is terminated with —(C₆H₄)—B(O—)₂, wherein the boron-oxygen bond can form bidentate bonds with two hydroxy groups of the cyclodextrin. In certain embodiments, the linker is terminated with —NHC(═O)—(C₆H₄)—B(O—)₂. In certain embodiments, the linker is —NHC(═O)—(C₆H₄)—B(O—)₂.

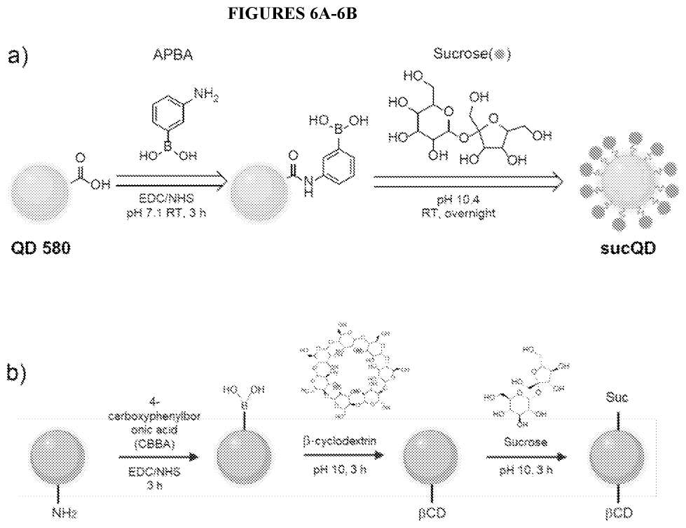

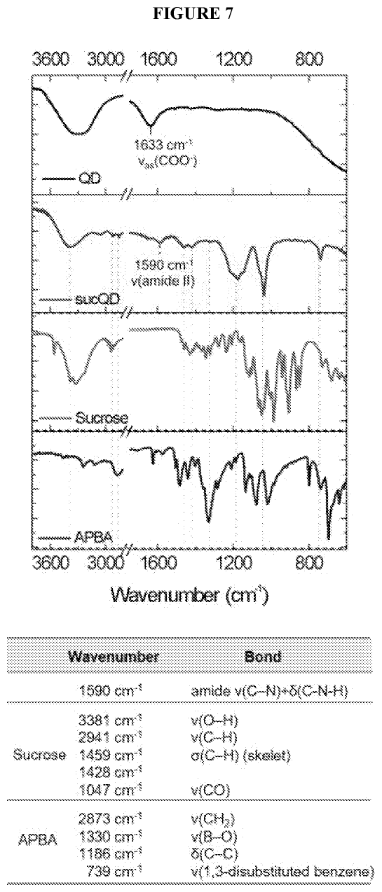

In certain embodiments, a nanoparticle (e.g., carbon dot) surface may have amino group (—NH₂), which could be covalently linked with a carboxy-phenylboronic acid (CPBA). In certain embodiments, a nanoparticle (e.g., carbon dot) surface may have carboxy group (—COOH), which could be covalently linked with an amino-phenylboronic acid (APBA). Such nanoparticles could be further dual functionalized with both cyclodextrin(s) and SUT targeting agent(s) (e.g., sucrose) via the boronic acid groups to form SUT targeting agent and cyclodextrin coated nanoparticles (e.g., see FIG. 1 and FIG. 6B). Such nanoparticles could be dual functionalized with both cyclodextrin(s) and GUT targeting agent(s) (e.g., glucose) via the boronic acid groups to form GUT targeting agent and cyclodextrin coated nanoparticles (e.g., see FIG. 14). In certain embodiments, cargo could be loaded within cyclodextrin.

In certain embodiments, a dual-functionalized NP surface could be coated with “n” copy number of SUT targeting agents (e.g., sucrose) as described above and “m” copy number of molecular basket(s) (MB). In certain embodiments, a dual-functionalized NP surface could be coated with “n” copy number of GUT targeting agents (e.g., glucose) as described above and “m” copy number of molecular basket(s) (MB). In certain embodiments, a functionalized NP surface could be coated with “n” copy number of SUT and GUT targeting agents as described above and “m” copy number of molecular basket(s) (MB). In certain embodiments, cargo is loaded within the MB. Depending on the NP size and the surface functionalization reaction, the copy number of MB presented on the NP surface may vary. In certain embodiments, “m” is about 1, 10, 10², 10³, 10⁴, 10⁵, 10⁶, or more. In certain embodiments, “m” is from about 1 to 10⁶, 1 to 10⁵, 1 to 10⁴, 1 to 10³, 1 to 10², or 1 to 10. In certain embodiments, “m” is from about 1 to 100, or 1000 to 10000.

In certain embodiments, the conjugate comprises or consists of a conjugate of Formula Ie:

(MB-linker)ₘ-NP-(linker-TA)ₙ (Formula Ie)
wherein: MB is a molecular basket; NP is the nanoparticle; TA is the Sucrose Transporter protein (SUT) targeting agent or the Glucose Transporter protein (GUT) targeting agent; each linker is independently selected from a linker having a molecular weight of from about 20 daltons to about 20,000 daltons; m is an integer≥1; and n is an integer≥1. In certain embodiments, TA is the SUT targeting agent. In certain embodiments, TA is the GUT targeting agent. In certain embodiments, the conjugate comprises a mixture of SUT and GUT targeting agents.

In certain embodiments, the conjugate comprises or consists of a conjugate of Formula Ie1 or Formula Ie2:

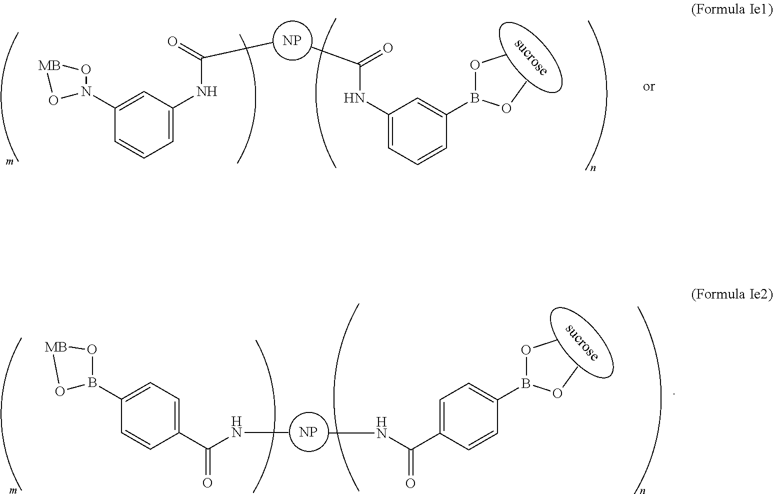

In certain embodiments, the conjugate of Formula Ie1 or Formula Ie2 comprises a sucrose structure according to Formula Ic1, Formula Ic2, Formula Id1, or Formula Id2.

In certain embodiments, the conjugate comprises or consists of a conjugate of formula Ie3 or formula Ie4:

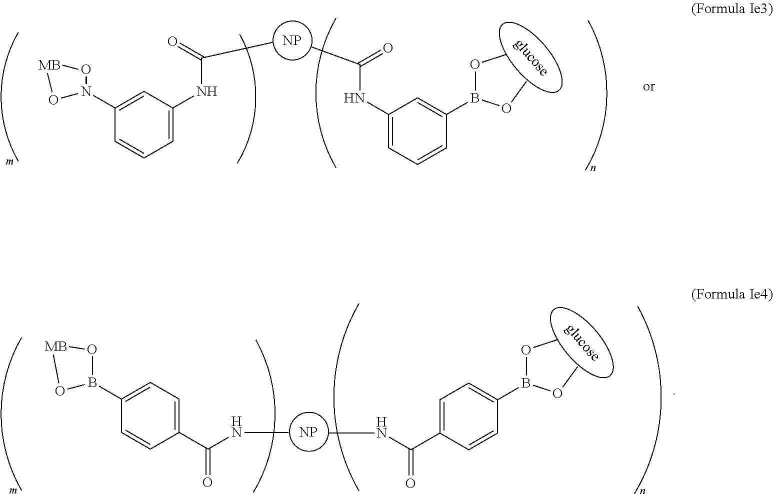

In certain embodiments, the conjugate of Formula Ie3 or Formula Ie4 comprises a glucose structure according to Formula Ic3, Formula Ic4, Formula Id3, or Formula Id4.

In certain embodiments, the conjugate of Formula I, Formula II, or Formula III as described herein (e.g., TA and/or linker in Formula I, Formula II, or Formula III) comprises a glucose and/or linker structure according to the glucose and/or linker structure as shown in a Figure (e.g., FIG. 14b or FIG. 19).

In certain embodiments, a conjugate as described herein comprises a conjugate of formula (I), cargo, and optionally, one or more molecular baskets, wherein the cargo is associated with the nanoparticle and/or molecular basket. In certain other embodiments, a conjugate as described herein comprises a conjugate of formula (I) but does not comprise cargo.

Cargo, associated with (e.g., loaded within) a nanoparticle and/or molecular basket, may release from the nanoparticle or molecular basket. For example, in certain embodiments, cargo loaded within a porous silica nanoparticle, or lipid nanoparticle could be released (via diffusion and/or degradation of the NP) in a sustained manner over time once delivered into the plant/fungus or at desired site of action (e.g., phloem, stem, and/or root).

A linker as described above or herein may be used in a conjugate described herein (e.g., a conjugate of formula I, formula II, or formula III), for example, may link a targeting agent to a cargo, a nanoparticle, and/or a molecular basket, or may link a nanoparticle to a molecular basket.

In certain embodiments, the conjugate comprises or consists of a conjugate of formula II:

cargo-linker-TA (II)

wherein: TA is the Sucrose Transporter protein (SUT) targeting agent or the Glucose Transporter protein (GUT) targeting agent; and the linker has a molecular weight of from about 20 daltons to about 20,000 daltons. In certain embodiments, the TA is a SUT targeting agent.

In certain embodiments, the TA is a GUT targeting agent. In certain embodiments, the conjugate comprises a mixture of SUT and GUT targeting agents.

In certain embodiments, a conjugate comprises or consists of a conjugate of Formula IIa:

cargo-linker-Sucrose (Formula IIa).

In certain embodiments, one terminal of the linker comprises a boronic acid group that binds the SUT targeting agent (e.g., a disaccharide such as sucrose).

In certain embodiments, a conjugate comprises or consists of a conjugate of Formula IIa′:

cargo-linker-Glucose (Formula IIa′).

In certain embodiments, one terminal of the linker comprises a boronic acid group that binds the GUT targeting agent (e.g., a monosaccharide such as glucose).

In certain embodiments, the linker comprises a phenylboronic acid (PBA) group. In certain embodiments, the linker is terminated with —(C₆H₄)—B(O—)₂.

In certain embodiments, the linker comprises an animo-phenylboronic acid group. In certain embodiments, the linker is terminated with —C(═O)NH—(C₆H₄)—B(O—)₂. In certain embodiments, the linker is —C(═O)NH—(C₆H₄)—B(O—)₂.

In certain embodiments, the linker comprises a carboxy-phenylboronic acid (CPBA) group. In certain embodiments, the linker is terminated with —NHC(═O)—(C₆H₄)—B(O—)₂. In certain embodiments, the linker is —NHC(═O)—(C₆H₄)—B(O—)₂.

In certain embodiments, the linker is a cleavable linker (e.g., comprising ester bond, disulfide bond, peptide amide bond, or other bond(s) susceptible to cleavage or hydrolysis with or without enzyme catalysis). For example, the linked cargo and SUT targeting agent may separate within a plant/fungus (e.g., in a plant/fungal tissue or cell) or at desired site of action (e.g., phloem, stem, and/or root). For example, the conjugate may degrade within phloem, stem, and/or root, releasing cargo, NP, and/or molecular basket from the previously linked SUT targeting agent.

In certain embodiments, the linked cargo and GUT targeting agent may separate within a fungus. For example, the conjugate may degrade within a fungus, releasing cargo, NP, and/or molecular basket from the previously linked GUT targeting agent.

In certain embodiments, a conjugate described herein comprises or consists of a conjugate of Formula IIb1 or Formula IIb2:

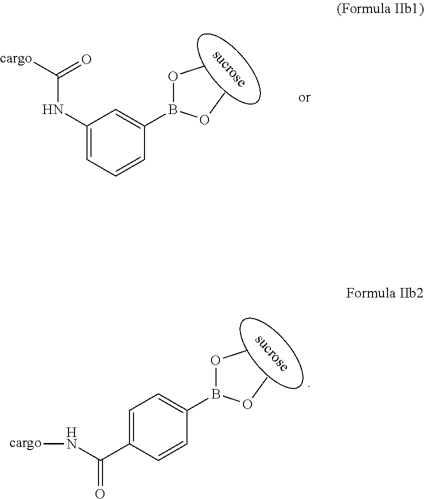

In certain embodiments, a conjugate described herein comprises or consists of a conjugate of Formula IIb3 or Formula IIb4:

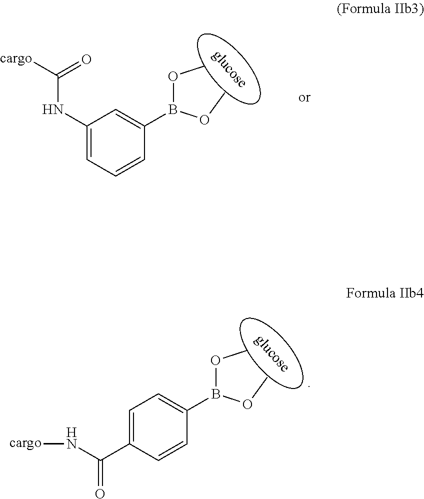

In certain embodiments, a conjugate described herein comprises or consists of a conjugate of Formula IIc1 or Formula IIc2:

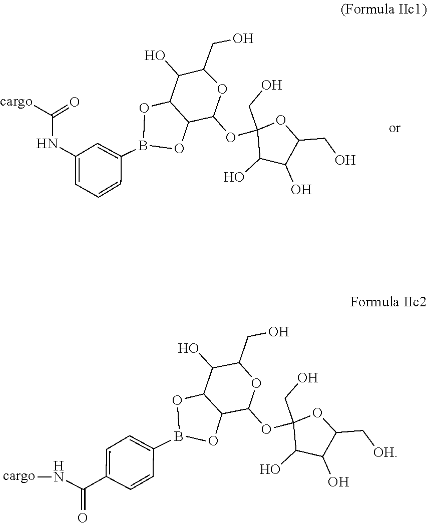

In certain embodiments, a conjugate described herein comprises or consists of a conjugate of Formula IIc3 or Formula IIc4:

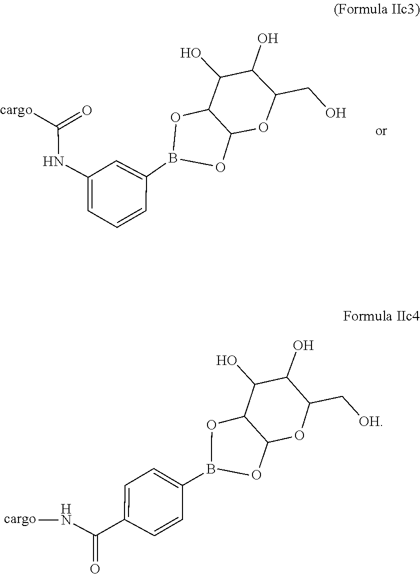

In certain embodiments, a conjugate described herein comprises or consists of a conjugate of Formula IIc5 or Formula IIc6:

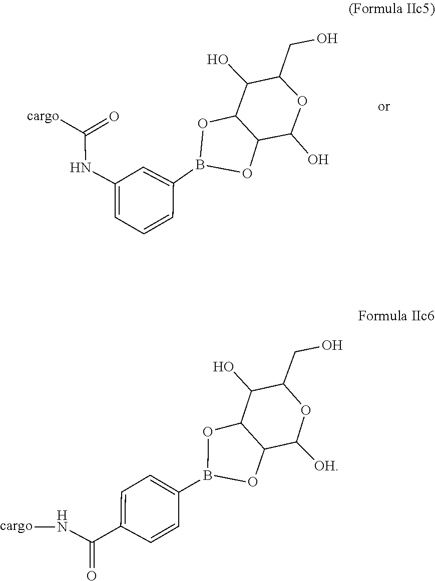

In certain embodiments, a conjugate described herein comprises or consists of a conjugate of Formula IId1 or Formula IId2:

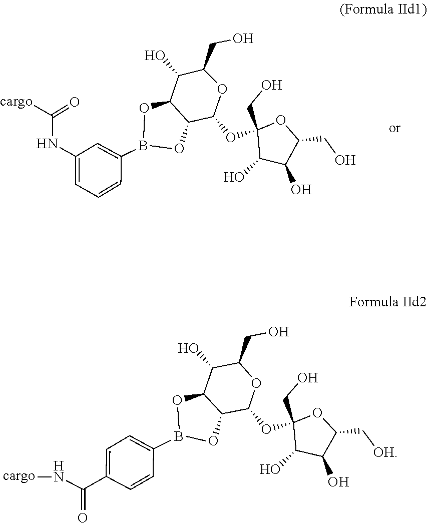

In certain embodiments, a conjugate described herein comprises or consists of a conjugate of Formula IId3 or Formula IId4:

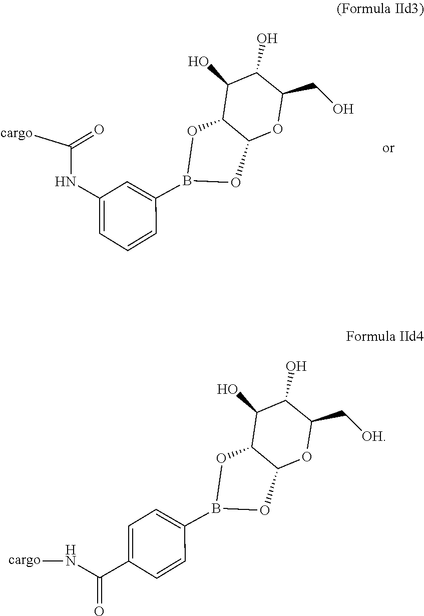

In certain embodiments, a conjugate described herein comprises or consists of a conjugate of Formula IId5 or Formula IId6:

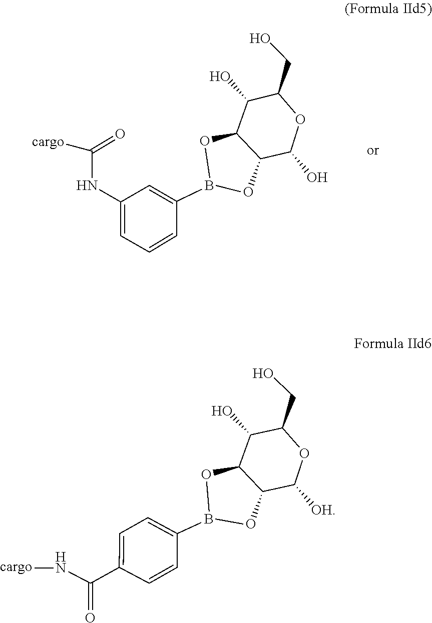

In certain embodiments, the conjugate comprises or consists of a conjugate of Formula III:

MB-(linker-TA)ₙ (III)
wherein: MB is the molecular basket; and TA is the Sucrose Transporter (SUT) protein targeting agent or the Glucose Transporter protein (GUT) targeting agent; the linker has a molecular weight of from about 20 daltons to about 20,000 daltons; and n is an integer≥1. In certain embodiments, the TA is a SUT targeting agent. In certain embodiments, the TA is a GUT targeting agent. In certain embodiments, the conjugate comprises a mixture of SUT and GUT targeting agents.

In certain embodiments, exemplary cyclodextrins with a functional group (e.g., amino, carboxy, or mercapto) for functionalization with linker-targeting agent include, but are not limited to, hexakis-(6-amino-6-deoxy)-alpha-Cyclodextrin, hexakis-(6-deoxy-6-mercapto)-alpha-Cyclodextrin, succinyl-β-cyclodextrin, mono-(6-ethanediamine-6-deoxy)-β-Cyclodextrin, Heptakis-(6-ethanediamine-6-deoxy)-β-Cyclodextrin, mono-(6-mercapto-6-deoxy)-β-Cyclodextrin, Heptakis-(6-deoxy-6-mercapto)-beta-Cyclodextrin, or Octakis-(6-deoxy-6-mercapto)-gamma-Cyclodextrin. As described herein, one or more targeting agents may be each independently linked to the molecular basket. Thus, in certain embodiments, n is 1, 2, 3, 4, 5, 6, 7, or more. In certain embodiments, n is from about 1 to 8, 1 to 7, 1 to 6, or 1 to 3. In certain embodiments, n is 1, 6, 7, or 8.

In certain embodiments, the conjugate comprises or consists of a conjugate of Formula IIIa:

MB-(linker-sucrose)ₙ (IIIa).

In certain embodiments, the conjugate comprises or consists of a conjugate of Formula IIIa′:

MB-(linker-glucose)ₙ (IIIa′).

In certain embodiments, the conjugate described herein comprises a nanoparticle (e.g., a carbon dot) and a cyclodextrin molecular basket. For example, a nanoparticle could be covalently linked with a cyclodextrin. Thus, a SUT targeting agent may be linked with the nanoparticle and/or the cyclodextrin and a cargo may be loaded within the nanoparticle and/or the cyclodextrin. Similarly, a GUT targeting agent may be linked with the nanoparticle and/or the cyclodextrin and a cargo may be loaded within the nanoparticle and/or the cyclodextrin. Thus, in certain embodiments, a conjugate as described herein comprises a conjugate of formula (III), cargo, and optionally, a nanoparticle, wherein the cargo is associated with the nanoparticle and/or molecular basket. In certain other embodiments, a conjugate as described herein comprises a conjugate of formula (III) but does not comprise cargo.

Certain embodiments of the invention provide a composition comprising a conjugate as described herein.

A conjugate as described herein may be formulated into a suitable dosage form for plant or fungal application/introduction.

Common agrochemical and/or nanomaterial formulations are known in the field and include liquid and solid formulations. Exemplary formulations include gel, aqueous or oil-based solutions, dispersions, suspensions or emulsions, such as those described in U.S. Pat. Nos. 5,139,152; 6,403,529; 6,878,674; 7,094,831; 7,109,267 and 9,706,771.

In certain embodiments, the conjugate may be present in a liquid formulation, which may be administered or sprayed onto a plant or fungus using, e.g., ground/aerial spraying.

In certain embodiments, the conjugate may be formulated in pellet or tablet formulations. Such formulations may be capable of rapid break-up in water using minimal or no agitation while providing fine dispersions of the active ingredient (see, e.g., U.S. Pat. Nos. 5,180,587 and 7,550,156).

In certain embodiments, the composition comprises agriculturally acceptable additives or excipients. Suitable additives or excipients which may be present in the formulations include organic solvents, solubilizers, emulsifiers, surfactants, dispersants, preservatives, colorants, fillers, diluents, binders, glidants, lubricants, disintegrants, antiadherents, sorbents, coatings, wetting agents, penetrants and vehicles. Well known additives, excipients and agrochemical formulations are described in U.S. Pat. No. 6,602,823 and the aforementioned US Patents.

In certain embodiments, a composition described herein comprises a surfactant. In certain embodiments, the surfactant is a non-ionic surfactant (e.g., organosilicone surfactant Silwet, such as Silwet L-77). In certain embodiments, the surfactant may improve the spreading of the composition (e.g., liquid composition) on the leaf surface, and/or may facilitate the uptake of a conjugate described herein across the leaf lamina. In certain embodiments, the surfactant may facilitate uptake into leaf stomatal pores and/or increase permeability in the leaf epidermal layer, e.g., through partial removal of the cuticular layer.

In certain embodiments, the composition is in a powder dosage form.

In certain embodiments, the composition (e.g., comprising nanoparticle) is in a lyophilized form and can be readily reconstituted into liquid form before use.

While formulations may optionally contain excipients of free sugar molecules (e.g., for osmolarity modulation or for cryo-lyoprotection in a freeze-dried formulation), people skilled in the art would understand that such free-flowing sugar solute dissolved in a liquid is free to move/diffuse on its own and is not linked to or co-localized with the cargo, NP and/or molecular basket, and thus is not part of a conjugate as described herein.

### Methods

The methods described herein may be used to improve delivery of certain exogenous materials (e.g., a cargo described herein) into the phloem, stem and/or roots of a plant and/or to a fungus or particular tissues or compartments of a fungus.

Certain embodiments of the invention provide a method of introducing a conjugate to a plant in need thereof, the method comprising contacting the plant with a conjugate comprising a cargo, a nanoparticle, and/or a cyclodextrin molecular basket that is linked to a SUT targeting agent (e.g., a conjugate described herein). In certain embodiments, such a plant comprises a pest or a pathogen (e.g., a fungus).

It will be appreciated by those skilled in the art that the fungus growth stages start in form of a conidia or a spore, which is a dormant (inactive) stage. During this stage no uptake of nutrient, such as glucose or sucrose, is observed. Upon exposure to food or plants, conidia or spores start germination and production of hyphae (active stage). Hyphae proliferate and uptake nutrients such as glucose or sucrose. Once food source is not present and/or environmental conditions are not favorable, fungus will turn into dormant stage by producing conidia or spores. A conjugate may be contacted with the plant and/or fungus during germination, after germination, during proliferation, when fungus forms hyphae, or at sporulation.

Certain embodiments of the invention also provide a method of introducing a conjugate to a fungus in need thereof, the method comprising contacting the fungus with a conjugate comprising a cargo, a nanoparticle, and/or a cyclodextrin molecular basket that is linked to a SUT targeting agent (e.g., a conjugate described herein). Certain embodiments of the invention also provide a method of introducing a conjugate to a fungus in need thereof, the method comprising contacting the fungus with a conjugate comprising a cargo, a nanoparticle, and/or a cyclodextrin molecular basket that is linked to a GUT targeting agent (e.g., a conjugate described herein). In certain embodiments, the fungus is contacted directly with the conjugate. In certain embodiments, the fungus is contacted with the conjugate by introducing the conjugate to a plant comprising the fungus. For example, the fungus may be contacted with the conjugate by introducing the conjugate to the leaf, stem, fruit and/or root of a plant (e.g., foliage application as described herein, e.g., foliar topical delivery shown in Example 1, 2 or 4 or spraying a composition comprising the conjugate to the leaf).

In certain embodiments the conjugate comprises a SUT targeting agent linked to a cargo.

In certain embodiments, the cargo is selected from the group consisting of a pesticide, herbicide, and a fertilizer (e.g., a pesticide, herbicide or fertilizer described herein).

In certain embodiments the conjugate comprises a GUT targeting agent linked to a cargo (e.g., a fungicide).

In certain embodiments, the conjugate comprises or consists of a conjugate of Formula (II).

In certain embodiments the conjugate comprises a SUT targeting agent linked to a nanoparticle. In certain embodiments the conjugate comprises a GUT targeting agent linked to a nanoparticle. In certain embodiments, a cargo is associated with the nanoparticle. In certain embodiments, a cargo is not associated with the nanoparticle.

In certain embodiments, the conjugate comprises or consists of a conjugate of Formula (I), which optionally comprises a cargo. In certain embodiments, the conjugate comprising or consisting of a conjugate of Formula (I) does not comprise a cargo. In certain embodiments, the conjugate comprising or consisting of a conjugate of Formula (I) comprises a cargo. For example, a cargo may be associated with (e.g., loaded within) the nanoparticle. In certain embodiments, the conjugate comprising a conjugate of Formula (I) is a multi-functionalized nanoparticle (e.g., dual-functionalized NP) that comprises one or more SUT targeting agents (e.g., sucrose) and one or more molecular baskets linked to the NP, wherein a cargo is loaded within the molecular basket. In certain embodiments, the conjugate comprising a conjugate of Formula (I) is a multi-functionalized nanoparticle (e.g., dual-functionalized NP) that comprises one or more GUT targeting agents (e.g., glucose) and one or more molecular baskets linked to the NP, wherein a cargo is loaded within the molecular basket.

In certain embodiments the conjugate comprises a SUT targeting agent linked to a cyclodextrin molecular basket. In certain embodiments the conjugate comprises a GUT targeting agent linked to a cyclodextrin molecular basket. In certain embodiments, a cargo is associated with the molecular basket. In certain embodiments, a cargo is not associated with the molecular basket.

In certain embodiments, the conjugate comprises or consists of a conjugate of Formula (III), which optionally comprises a cargo. In certain embodiments, the conjugate comprising or consisting of a conjugate of Formula (III) does not comprise a cargo. In certain embodiments, the conjugate comprising or consisting of a conjugate of Formula (III) comprises a cargo.

In certain embodiments, the conjugate is a conjugate as described herein.

Certain embodiments of the invention provide a method of treating a plant (e.g., comprising a pest, or a pathogen such as a fungus) in need thereof, the method comprising contacting the plant with an effective amount of a conjugate as described herein. For example, certain embodiments of the invention provide a method of treating a plant in need thereof, wherein the plant has a phloem pathogen or a root pathogen, the method comprising contacting the plant with an effective amount of a conjugate as described herein.

In certain embodiments, contacting the plant comprises contacting a leaf of the plant. In certain embodiments, contacting the plant comprises contacting the top surface of a leaf of the plant.

In certain embodiments, the delivered conjugate is more enriched within the phloem veins of the leaf after the contacting, as compared to a control material that is not linked with the SUT targeting agent.

For example, in certain embodiments, the delivered cargo is more enriched within the phloem veins of the leaf after the contacting, as compared to a cargo that is not linked with the SUT targeting agent.

In certain embodiments, the delivered nanoparticle is more enriched within the phloem veins of the leaf after the contacting, as compared to a nanoparticle that is not linked with the SUT targeting agent.

In certain embodiments, the delivered cyclodextrin molecular basket is more enriched within the phloem veins of the leaf after the contacting, as compared to a cyclodextrin molecular basket that is not linked with the SUT targeting agent.

In certain embodiments, the delivered conjugate (e.g., cargo, NP, and/or molecular basket) is more enriched within the phloem veins of the leaf by at least about 10%, at least about 15%, at least about 20%, at least about 25%, at least about 30%, at least about 40%, at least about 50%, at least about 60%, at least about 70%, at least about 80%, at least about 90%, at least about 100%, at least about 200%, at least about 300%, at least about 400%, at least about 500%, at least about 600% or more as compared to a control (e.g., equivalent or counterpart material not linked with the SUT targeting agent). Methods for detecting or measuring the delivered materials are known in the art and described herein (e.g., fluorescent imaging, liquid chromatography-based methods such as HPLC and/or LC-MS). For example, an assay described herein may be used (see Example 1).

In certain embodiments, the delivered conjugate is more efficiently delivered into the stem and/or root of the plant as compared to a control material that is not linked with the SUT targeting agent.

For example, in certain embodiments, the delivered cargo is more efficiently delivered into the stem and/or root after the contacting, as compared to a cargo that is not linked with the SUT targeting agent.

In certain embodiments, the delivered nanoparticle is more efficiently delivered into the stem and/or root after the contacting, as compared to a nanoparticle that is not linked with the SUT targeting agent.

In certain embodiments, the delivered cyclodextrin molecular basket is more efficiently delivered into the stem and/or root after the contacting, as compared to a cyclodextrin molecular basket that is not linked with the SUT targeting agent.

In certain embodiments, the delivered conjugate (e.g., cargo, NP, and/or molecular basket) is more efficiently delivered into the stem and/or root of the plant by at least about 10%, at least about 15%, at least about 20%, at least about 25%, at least about 30%, at least about 40%, at least about 50%, at least about 60%, at least about 70%, at least about 80%, at least about 90%, at least about 100%, at least about 200%, at least about 300%, at least about 400%, at least about 500%, at least about 600% or more as compared to a control (e.g., equivalent or counterpart material not linked with the SUT targeting agent).

In certain embodiments, a conjugate described herein is delivered into the phloem veins of a leaf within 60 min, 50 min, 40 min, 30 min, 20 min, 10 min, 5 min, 4 min, 3 min, 2 min, or 1 minute (e.g., within 40 or 30 min) after the leaf is contacted with the conjugate.

In certain embodiments, as described herein the delivered conjugate is more enriched within the phloem veins of the leaf, and/or more efficiently delivered into the stem and/or root of the plant, as compared to a control material that is not linked with the SUT targeting agent at about 30 min, 40 min, 50 min, 1 h, 2 hrs, 4 hrs, 8 hrs, 12 hrs, 16 hrs, 20 hrs, 24 hours or longer after the plant (e.g., topical application to leaf) is contacted with the conjugate.

In certain embodiments, at least about 40%, 45%, 50%, 55%, 60%, 65%, or 70% of phloem loaded conjugates described herein is delivered to the root of the plant. For example, at least about 50%, 60%, or 70% of phloem loaded conjugates (i.e., conjugates that entered leaf phloem veins after contacting with leaf surface) eventually reaches the root of the plant.

In certain embodiments, the methods described herein allow delivery of certain exogenous materials (e.g., a cargo described herein) into the phloem, stem and/or roots of a plant without contacting the soils surrounding the roots of the plant. Hence, in certain embodiments, the method does not comprise contacting the soils surrounding the plant with the conjugate.

In certain embodiments, the plant is a plant selected from the group consisting of wheat, oat, corn, rice, barley, a vegetable (e.g., lettuce, broccoli, carrot, spinach, or pepper), a fruit plant (e.g., apple, orange, pear, grape, or peach), a nut tree (e.g., almond, walnut, or pecan), or a plant that provides fiber materials (e.g., cotton).

In certain embodiments, the plant is a weed.

In certain embodiments, the plant in need thereof has a disease caused by a phloem pathogen. Exemplary microbial phloem pathogens include, but are not limited to, Candidatus Liberibacter asiaticus (citrus greening), Arsenophonus bacteria, Serratia marcescens (cucurbit yellow vine disease), Candidatus Phytoplasma asteris (Aster Yellows Witches' Broom), and Spiroplasma kunkeli.

In certain embodiments, the plant in need thereof has a disease caused by a root pathogen (e.g., Ralstonia solanacearum or a pathogen that invades and/or colonizes the root of a plant).

In certain embodiments, a plant in need thereof is infected with a fungus (e.g., a fungus described herein, such as a fungus expressing a SUT or a GUT).

Certain embodiments of the invention provide a method for introducing a conjugate as described herein (e.g., that comprises a Glucose Transporter protein (GUT) targeting agent linked to a cargo) to a fungus, comprising contacting the fungus with the conjugate.

In certain embodiments, the conjugate is delivered more efficiently into the fungus (e.g., enhanced intracellular delivery into the fungus), as compared to a control material that is not linked with the GUT targeting agent.

In certain embodiments, the delivered conjugate is more enriched within the fungus, as compared to a control material that is not linked with the GUT targeting agent.

For example, in certain embodiments, a delivered cargo is more enriched within the fungus, as compared to a cargo that is not linked with the GUT targeting agent.

In certain embodiments, a delivered nanoparticle is more enriched within the fungus, as compared to a nanoparticle that is not linked with the GUT targeting agent.

In certain embodiments, a delivered cyclodextrin molecular basket is more enriched within the fungus, as compared to a cyclodextrin molecular basket that is not linked with the GUT targeting agent.

In certain embodiments, the delivered conjugate (e.g., cargo, NP, and/or molecular basket) is more enriched within the fungus by at least about 10%, at least about 15%, at least about 20%, at least about 25%, at least about 30%, at least about 40%, at least about 50%, at least about 60%, at least about 70%, at least about 80%, at least about 90%, at least about 100%, at least about 200%, at least about 300%, at least about 400%, at least about 500%, at least about 600% or more (e.g., 7, 8, 9, 10, 15, or 20 times more) as compared to a control (e.g., equivalent or counterpart material not linked with the GUT targeting agent). Methods for detecting or measuring the delivered materials are known in the art and described herein (e.g., fluorescent imaging, liquid chromatography-based methods such as HPLC and/or LC-MS). For example, an assay described herein may be used (see Example 2).

Certain embodiments of the invention provide a method of inhibiting a fungus, the method comprising contacting the fungus with an effective amount of a conjugate as described herein (e.g., a conjugate described herein comprising a fungicide). In certain embodiments, the fungus is contacted directly with the conjugate. In certain embodiments, the fungus is contacted with the conjugate by introducing the conjugate to a plant comprising the fungus. As used herein, the term “inhibiting” refers to reducing the viability of a fungus so that the growth of the fungus is slowed or stopped, and/or the presence of the fungus is eliminated.

Accordingly, the invention described herein also provide a method of treating a fungus infection in a plant, wherein the method comprises contacting the plant and/or fungus with a conjugate as described herein.

In certain embodiments, the plant is infected by the fungus on leaf, stem, fruit, and/or root. In certain embodiments, the plant is infected by the fungus on a leaf. In certain embodiments, the plant is infected by the fungus on a stem. In certain embodiments, the plant is infected by the fungus on a root. In certain embodiments, the plant is infected by the fungus on a fruit of the plant.

In certain embodiments, the method comprises contacting the fungus with the conjugate.

In certain embodiments, the method comprises contacting the plant with the conjugate. The plant could be contacted with the conjugate on one or more organs/locations. In certain embodiments, the method comprises contacting the plant with the conjugate on the leaf (e.g., topical application such as spraying or depositing the conjugate or composition on the leaf). In certain embodiments, the method comprises contacting the plant with the conjugate on the stem (e.g., topical application such as spraying or depositing the conjugate or composition on the stem). In certain embodiments, the method comprises contacting the plant with the conjugate on the fruit of the plant (e.g., topical application such as spraying or depositing the conjugate or composition on the fruit). In certain embodiments, the method comprises contacting the plant with the conjugate on the root. In certain embodiments, when the plant is infected with a fungus on a root that is near the ground or underground, contacting the plant may comprise contacting the soils surrounding the plant or root.

In certain embodiments, the fungus is a fungus selected from the group consisting of Magnaporthe oryzae, Botrytis spp. (e.g., Botrytis cinerea), Puccinia spp., Fusarium graminearum, Fusarium oxysporum, Blumeria graminis, Mycosphaerella graminicola, Colletotrichum spp., Ustilago maydis, Melampsora lini, and Zymoseptoria tritici.

In certain embodiments, the fungus is a fungus selected from the group consisting of Alternaria spp., Bipolaris spp., Botrytis spp., Cochliobolus spp., Colletotrichum spp., Erysiphe spp., Endocronartium spp., Fusarium spp., glomerell spp., Phragmidium spp., and Puccinia spp.

In certain embodiments, the fungus is a Botrytis sp. fungus.

In certain embodiments, the plant has a fungal infection disease selected from the group consisting of gray mold, anthracnose, leaf blight, leaf spot, leaf rust, Gall rust, Fusarium wilt, early blight, and powdery mildew.

In certain embodiments, conjugates as described herein comprising appropriate active ingredient cargo (e.g., a cargo described herein) are suitable for controlling the following illustrative causal agents of plant diseases: Albugo spp. (white rust) on ornamentals, vegetables (e.g. A. candida) and sunflowers (e.g. A. tragopogonis); Alternaria spp. (Alternaria leaf spot) on vegetables (e.g. A. dauci or A. porri), oilseed rape (A. brassicicola or brassicae), sugar beets (A. tenuis), fruits (e.g. A. grandis), rice, soybeans, potatoes and tomatoes (e.g. A. solani, A. grandis or A. alternata), tomatoes (e.g. A. solani or A. alternata) and wheat (e.g. A. triticina); Aphano-myces spp. on sugar beets and vegetables; Ascochyta spp. on cereals and vegetables, e.g. A. tritici (anthracnose) on wheat and A. hordei on barley; Aureobasidium zeae (syn. Kapatiella zeae) on corn; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages); B. squamosa or B. allii on onion family), oilseed rape, ornamentals (e.g. B. eliptica), vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladobotryum (syn. Dactylium) spp. (e.g. C. mycophilum (formerly Dactylium dendroides, teleomorph: Nectria albertinii, Nectria rosella syn. Hypomyces rosellus) on mushrooms; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthianum), soybeans (e.g. C. truncatum or C. gloeosporioides), vegetables (e.g. C. lagenarium or C. capsici), fruits (e.g. C. acutatum), coffee (e.g. C. coffeanum or C. kahawae) and C. gloeosporioides on various crops; Corticium spp., e.g. C. sasakii (sheath blight) on rice; Corynespora cassiicola (leaf spots) on soybeans, cotton and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (formerly Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, oilseed rape (e.g. E. crucife-rarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani (f sp. glycines now syn. F. virguliforme) and F. tucumaniae and F. brasiliense each causing sudden death syndrome on soybeans, and F. verticillioides on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypii on cotton; Grainstaining complex on rice; Guignardia bidwelii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals, potatoes and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monilinia spp., e.g. M laxa, M. fructicola and M. fructigena (syn. Monilia spp.: bloom and twig blight, brown rot) on stone fruits and other rosaceous plants; Mycosphaerella spp. on cereals, bananas, soft fruits and ground nuts, such as e.g. M. graminicola (anamorph: Zymoseptoria tritici formerly Septoria tritici: Septoria blotch) on wheat or M. fijiensis (syn. Pseudocercospora fijiensis: black Sigatoka disease) and M. musicola on bananas, M. arachidicola (syn. M. arachidis or Cercospora arachidis), M. berkeleyi on peanuts, M. pisi on peas and M. brassiciola on brassicas; Peronospora spp. (downy mildew) on cabbage (e.g. P. brassicae), oilseed rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (syn. Leptosphaeria biglobosa and L. maculans: root and stem rot) on oilseed rape and cabbage, P. betae (root rot, leaf spot and damping-off) on sugar beets and P. zeae-maydis (syn. Phyllostica zeae) on corn; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, oilseed rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits (e.g. P. leucotricha on apples) and curcurbits (P. xanthii); Polymyxa spp., e.g. on cereals, such as barley and wheat (P. graminis) and sugar beets (P. betae) and thereby transmitted viral diseases; Pseudocercosporella herpotrichoides (syn. Oculimacula yallundae, O. acuformis: eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or, rotbrenner', anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenopeziza spp., e.g. P. brassicae on oilseed rape; Pyrenophora (anamorph: Drechslera) tritici-repentis (tan spot) on wheat or P. teres (net blotch) on barley; Pyricularia spp., e.g. P. oryzae (teleomorph: Magnaporthe grisea: rice blast) on rice and P. grisea on turf and cereals; Pythium spp. (damping-off) on turf, rice, corn, wheat, cotton, oilseed rape, sunflowers, soybeans, sugar beets, vegetables and various other plants (e.g. P. ultimum or P. aphanidermatum) and P. oligandrum on mushrooms; Ramularia spp., e.g. R. collo-cygni (Ramularia leaf spots, Physiological leaf spots) on barley, R. areola (teleomorph: Mycosphaerella areola) on cotton and R. beticola on sugar beets; Rhizoctonia spp. on cotton, rice, potatoes, turf, corn, oilseed rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis and R. commune (scald) on barley, rye and triticale; Sarocladium oryzae and S. attenuatum (sheath rot) on rice; Sclerotinia spp. (stem rot or white mold) on vegetables (S. minor and S. sclerotiorum) and field crops, such as oilseed rape, sunflowers (e.g. S. sclerotiorum) and soybeans, S. rolfsii (syn. Athelia rolfsii) on soybeans, peanut, vegetables, corn, cereals and ornamentals; Septoria spp. on various plants, e.g. S. glycines (brown spot) on soybeans, S. tritici (syn. Zymoseptoria tritici, Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setosphaeria spp. (leaf blight) on corn (e.g. S. turcicum, syn. Helminthosporium turcicum) and turf, Sphacelotheca spp. (smut) on corn, (e.g. S. reiliana, syn. Ustilago reiliana: head smut), sorghum und sugar cane; Sphaerotheca fuliginea (syn. Podosphaera xanthii: powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria]nodorum, syn. Septoria nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Trichoderma harzianum on mushrooms; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli), sugar beets (e.g. U. betae or U. beticola) and on pulses (e.g. U. vignae, U. pisi, U. viciae-fabae and U. fabae); Ustilago spp. (loose smut) on cereals (e.g. U. nuda and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. longisporum on oilseed rape, V. dahliae on strawberries, oilseed rape, potatoes and tomatoes, and V. fungicola on mushrooms; Zymoseptoria tritici on cereals.

In certain embodiments, conjugates as described herein comprising appropriate active ingredient cargo (e.g., a cargo described herein) are suitable for controlling the following illustrative causal agents of plant diseases: rusts on soybean and cereals (e.g. Phakopsora pachyrhizi and P. meibomiae on soy; Puccinia tritici and P. striiformis on wheat); molds on specialty crops, soybean, oil seed rape and sunflowers (e.g. Botrytis cinerea on strawberries and vines, Sclerotinia sclerotiorum, S. minor and S. rolfsii on oil seed rape, sunflowers and soybean); Fusarium diseases on cereals (e.g. Fusarium culmorum and F. graminearum on wheat); downy mildews on specialty crops (e.g. Plasmopara viticola on vines, Phytophthora infestans on potatoes); powdery mildews on specialty crops and cereals (e.g. Uncinula necator on vines, Erysiphe spp. on various specialty crops, Blumeria graminis on cereals); and leaf spots on cereals, soybean and corn (e.g. Septoria tritici and S. nodorum on cereals, S. glycines on soybean, Cercospora spp. on corn and soybean).

The terms “introduce” and “introduction” refers to contacting a plant or fungus, or a portion thereof, with a material (e.g., a conjugate described herein). For example, a conjugate or a composition comprising the conjugate may be applied to the plant or fungus, or a portion thereof (e.g., leaf or spore). In certain embodiments, the plant or fungus, or a portion thereof (e.g., foliage and/or other tissues), is sprayed with the conjugate or a composition comprising the conjugate. In certain embodiments, the plant or fungus, or a portion thereof, is coated with the conjugate or a composition comprising the conjugate (e.g., a leaf dipped in a composition). In certain embodiments, the conjugate or a composition comprising the conjugate is administered to the plant or fungus (e.g., via injection).

The terms “treat” and “treatment” refer to both therapeutic treatment and prophylactic or preventative measures, wherein the object is to prevent or decrease an undesired change, condition or disease in a plant. For purposes of this invention, beneficial or desired results include, but are not limited to, alleviation of symptoms, diminishment of extent of disease, stabilized (i.e., not worsening) state of disease, delay or slowing of disease progression or transmission, and amelioration of the disease state, whether detectable or undetectable. A plant in need thereof treatment include plants already with the condition or disease as well as those prone to have the condition or disease or those in which the condition or disease is to be prevented.

The phrase “effective amount” means an amount of a conjugate as described herein that (i) treats the particular disease, condition, or disorder, (ii) attenuates, ameliorates, or eliminates one or more symptoms of the particular disease, condition, or disorder, or (iii) prevents or delays the onset of one or more symptoms of the particular disease, condition, or disorder described herein. The phrase “effective amount” may also mean an amount effective to inhibit a pest and/or pathogen.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, (C₁-C₆)alkyl, (C₂-C₆)alkyl and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and and higher homologs and isomers.

The term “aryl” as used herein refers to a single all carbon aromatic ring or a multiple condensed all carbon ring system wherein at least one of the rings is aromatic. For example, in certain embodiments, an aryl group has 6 to 20 carbon atoms, 6 to 14 carbon atoms, 6 to 12 carbon atoms, or 6 to 10 carbon atoms. Aryl includes a phenyl radical. Aryl also includes multiple condensed carbon ring systems (e.g., ring systems comprising 2, 3 or 4 rings) having about 9 to 20 carbon atoms in which at least one ring is aromatic and wherein the other rings may be aromatic or not aromatic (i.e., cycloalkyl). The rings of the multiple condensed ring system can be connected to each other via fused, spiro and bridged bonds when allowed by valency requirements. It is to be understood that the point of attachment of a multiple condensed ring system, as defined above, can be at any position of the ring system including an aromatic or a carbocycle portion of the ring. Non-limiting examples of aryl groups include, but are not limited to, phenyl, indenyl, indanyl, naphthyl, 1, 2, 3, 4-tetrahydronaphthyl, anthracenyl, and the like.

The term “heteroaryl” as used herein refers to a single aromatic ring that has at least one atom other than carbon in the ring, wherein the atom is selected from the group consisting of oxygen, nitrogen and sulfur; “heteroaryl” also includes multiple condensed ring systems that have at least one such aromatic ring, which multiple condensed ring systems are further described below. Thus, “heteroaryl” includes single aromatic rings of from about 1 to 6 carbon atoms and about 1-4 heteroatoms selected from the group consisting of oxygen, nitrogen and sulfur. The sulfur and nitrogen atoms may also be present in an oxidized form provided the ring is aromatic. Exemplary heteroaryl ring systems include but are not limited to pyridyl, pyrimidinyl, oxazolyl or furyl. “Heteroaryl” also includes multiple condensed ring systems (e.g., ring systems comprising 2, 3 or 4 rings) wherein a heteroaryl group, as defined above, is condensed with one or more rings selected from cycloalkyl, aryl, heterocycle, and heteroaryl. It is to be understood that the point of attachment for a heteroaryl or heteroaryl multiple condensed ring system can be at any suitable atom of the heteroaryl or heteroaryl multiple condensed ring system including a carbon atom and a heteroatom (e.g., a nitrogen). Exemplary heteroaryls include but are not limited to pyridyl, pyrrolyl, pyrazinyl, pyrimidinyl, pyridazinyl, pyrazolyl, thienyl, indolyl, imidazolyl, triazolyl, tetrazolyl, oxazolyl, isoxazolyl, thiazolyl, furyl, oxadiazolyl, thiadiazolyl, quinolyl, isoquinolyl, benzothiazolyl, benzoxazolyl, indazolyl, quinoxalyl, and quinazolyl.

The term “halo” or “halogen” refers to bromo, chloro, fluoro or iodo. In some embodiments, halogen refers to chloro or fluoro.

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the invention can contain asymmetric or chiral centers, and therefore exist in different stereoisomeric forms. It is intended that all stereoisomeric forms of the compounds of the invention, including but not limited to, diastereomers, enantiomers and atropisomers, as well as mixtures thereof such as racemic mixtures, form part of the present invention. Many organic compounds exist in optically active forms, i.e., they have the ability to rotate the plane of plane-polarized light. In describing an optically active compound, the prefixes D and L, or R and S, are used to denote the absolute configuration of the molecule about its chiral center(s). The prefixes d and 1 or (+) and (−) are employed to designate the sign of rotation of plane-polarized light by the compound, with (−) or 1 meaning that the compound is levorotatory. A compound prefixed with (+) or d is dextrorotatory. For a given chemical structure, these stereoisomers are identical except that they are mirror images of one another. A specific stereoisomer can also be referred to as an enantiomer, and a mixture of such isomers is often called an enantiomeric mixture. A 50:50 mixture of enantiomers is referred to as a racemic mixture or a racemate, which can occur where there has been no stereoselection or stereospecificity in a chemical reaction or process. The terms “racemic mixture” and “racemate” refer to an equimolar mixture of two enantiomeric species, devoid of optical activity.

It will be appreciated by those skilled in the art that certain compounds described herein have a chiral center may exist in and be isolated in optically active and racemic forms. Some compounds may exhibit polymorphism. It is to be understood that the present invention encompasses any racemic, optically-active, polymorphic, or stereoisomeric form, or mixtures thereof, of a compound of the invention, which possess the useful properties described herein, it being well known in the art how to prepare optically active forms (for example, by resolution of the racemic form by recrystallization techniques, by synthesis from optically-active starting materials, by chiral synthesis, or by chromatographic separation using a chiral stationary phase).

When a bond in a compound formula herein is drawn in a non-stereochemical manner (e.g. flat), the atom to which the bond is attached includes all stereochemical possibilities.

Certain embodiments of the invention are as follows:

Embodiment 1. A conjugate comprising a Sucrose Transporter protein (SUT) targeting agent linked to a cargo, wherein the conjugate is capable of being delivered to a plant or fungus, and wherein the cargo is an agent that is capable of producing a desired effect in the plant or fungus following delivery of the conjugate to the plant or fungus.

Embodiment 2. The conjugate of Embodiment 1, wherein the cargo is a pesticide, herbicide, or a fertilizer.

Embodiment 3. The conjugate of Embodiment 1 or 2, that further comprises a nanoparticle and/or a molecular basket, wherein the nanoparticle is selected from the group consisting of a quantum dot, carbon dot, carbon nanotube, silica nanoparticle (e.g., porous silica nanoparticle), lipid nanoparticle, liposome, metal or metal oxide nanoparticle, and a micro or macro nutrient-based nanoparticle.

Embodiment 4. The conjugate of Embodiment 3, that comprises a nanoparticle linked to one or more SUT targeting agent(s).

Embodiment 5. The conjugate of Embodiment 3 or 4, wherein the cargo is associated with the nanoparticle or with the molecular basket.

Embodiment 6. The conjugate of Embodiment 5, wherein the cargo is associated with the nanoparticle.

Embodiment 7. The conjugate of Embodiment 5, wherein the cargo is associated with the molecular basket.

Embodiment 8. The conjugate of any one of Embodiments 3-7, wherein the molecular basket comprises a beta cyclodextrin.

Embodiment 9. The conjugate of Embodiment 8, wherein the cargo forms an inclusion complex with the cyclodextrin.

Embodiment 10. The conjugate of Embodiment 9, wherein the cargo is selected from the group consisting of chlorpyrifos, methyl viologen, oxyfluorfen, imazaquin, fluthiacet, diclofop, penoxsulam, norflurazon, and acifluorfen, trifludimoxazin, picolinafen, pyraclostrobin, and boscalid.

Embodiment 11. The conjugate of any one of Embodiments 3-6, which comprises a conjugate of Formula I:

NP-(linker-TA)ₙ (I)

wherein: NP is the nanoparticle; TA is the Sucrose Transporter protein (SUT) targeting agent; the linker has a molecular weight of from about 20 daltons to about 20,000 daltons; and n is an integer≥1.

Embodiment 12. The conjugate of Embodiment 11, wherein the NP is further functionalized with one or more molecular baskets.

Embodiment 13. The conjugate of Embodiment 12, wherein the molecular basket comprises a beta cyclodextrin.

Embodiment 14. The conjugate of Embodiment 12 or 13, wherein the cargo is associated with the molecular basket.

Embodiment 15. The conjugate of Embodiment 13, wherein the cargo forms an inclusion complex with the cyclodextrin.

Embodiment 16. The conjugate of any one of Embodiments 12-15, wherein the cargo is selected from the group consisting of chlorpyrifos, methyl viologen, oxyfluorfen, imazaquin, fluthiacet, diclofop, penoxsulam, norflurazon, trifludimoxazin, picolinafen, pyraclostrobin, boscalid and acifluorfen.

Embodiment 17. The conjugate of Embodiment 1, which is a conjugate of formula II:

cargo-linker-TA (II)

wherein: TA is the Sucrose Transporter protein (SUT) targeting agent; and the linker has a molecular weight of from about 20 daltons to about 20,000 daltons.

Embodiment 18. The conjugate of any one of Embodiments 7-10, which comprises a conjugate of formula III:

MB-(linker-TA)ₙ (III)

wherein: MB is the molecular basket; TA is the Sucrose Transporter protein (SUT) targeting agent; the linker has a molecular weight of from about 20 daltons to about 20,000 daltons; and n is an integer≥1.

Embodiment 19. The conjugate of any one of Embodiments 11-18, wherein the linker has a molecular weight of from about 20 daltons to about 5,000 daltons.

Embodiment 20. The conjugate of any one of Embodiments 11-18, wherein the linker has a molecular weight of from about 20 daltons to about 1,000 daltons.

Embodiment 21. The conjugate of any one of Embodiments 11-20, wherein the linker comprises a boronic acid group —B(O—)₂, wherein each O— is bonded to TA.

Embodiment 22. The conjugate of any one of Embodiments 11-21, wherein the linker has a structure —X—Y—Z—; wherein:
X is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂,
Z is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂;
Rₐ is H or (C₁-C₆) alkyl;
each R_{b} is independently O—, —OH, or (C₁-C₄)alkoxy;
each R_{c} is O— that is linked to TA;
Y is a divalent, saturated or unsaturated, branched or unbranched (C₂-C₁₈) hydrocarbon chain, wherein one or more carbon of the hydrocarbon chain is optionally replaced with —O—, —N(Rₛ)—, —S—, aryl (e.g., —C₆H₄—), or heteroaryl, and wherein the hydrocarbon chain is optionally substituted on carbon with one or more substituents selected from the group consisting of halo, hydroxy, mercapto, oxo (═O) and thioxo (═S); and
Rₛ is H or (C₁-C₆) alkyl.

Embodiment 23. The conjugate of Embodiment 22, wherein Z is —B(R_{c})₂.

Embodiment 24. The conjugate of any one of Embodiments 1-23, wherein the Sucrose Transporter protein (SUT) targeting agent is a saccharide.

Embodiment 25. The conjugate of any one of Embodiments 1-23, wherein the Sucrose Transporter protein (SUT) targeting agent is sucrose.

Embodiment 26. The conjugate of Embodiment 11, which comprises formula Ic1 or formula Ic2:

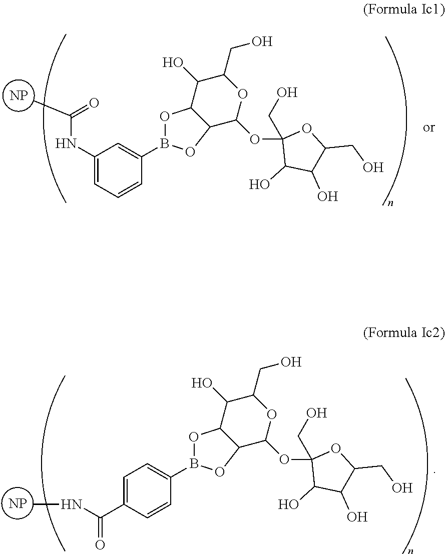

Embodiment 27. The conjugate of Embodiment 12, which comprises a conjugate of Formula Ie:

(MB-linker)ₘ-NP-(linker-TA)ₙ (Formula Ie)

wherein: MB is the molecular basket; NP is the nanoparticle; TA is the Sucrose Transporter protein (SUT) targeting agent; each linker is independently selected from a linker having a molecular weight of from about 20 daltons to about 20,000 daltons; m is an integer≥1; and n is an integer≥1.

Embodiment 28. The conjugate of Embodiment 27, which comprises formula Ie1 or formula Ie2:

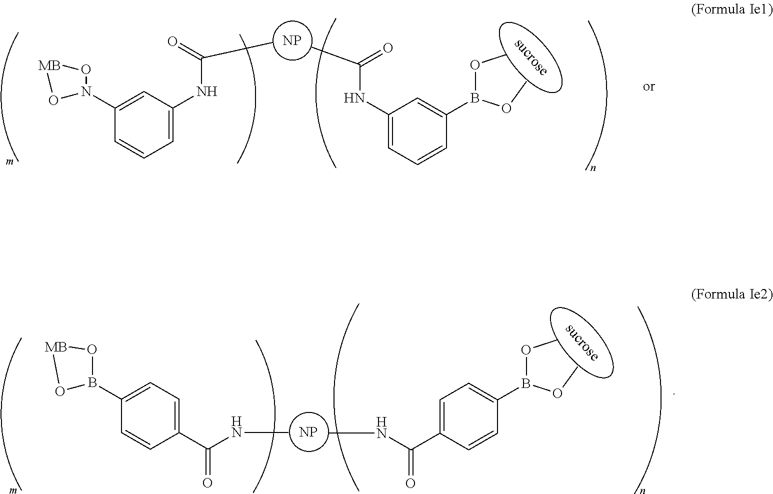

Embodiment 29. The conjugate of any one of Embodiments 3-28, wherein the nanoparticle is a carbon dot, carbon nanotube, silica nanoparticle, metal or metal oxide nanoparticle, lipid nanoparticle, liposome or micro- or macro-nutrient-based nanoparticle.

Embodiment 30. The conjugate of any one of Embodiments 3-28, wherein the nanoparticle has a diameter of about 1 nm to 300 nm.

Embodiment 31. The conjugate of any one of Embodiments 3-28, wherein the nanoparticle has a diameter of about 1 nm to 50 nm.

Embodiment 32. The conjugate of any one of Embodiments 1-31, wherein the cargo is herbicide or pesticide.

Embodiment 33. The conjugate of any one of Embodiments 1-32, wherein the cargo has a molecular weight of less than 1000 g/mol.

Embodiment 34. A method of introducing a conjugate to a plant or fungus that expresses a Sucrose Transporter (SUT) protein, the method comprising: contacting the plant or fungus with a conjugate as described in any one of Embodiments 1-33.

Embodiment 35. The method of Embodiment 34, comprising contacting a fungus with the conjugate.

Embodiment 36. The method of Embodiment 34, comprising contacting a plant with the conjugate.

Embodiment 37. The method of Embodiment 36, wherein the plant comprises a leaf that is contacted with the conjugate.

Embodiment 38. The method of any of Embodiments 34-37, wherein the conjugate is contacted with the plant and/or fungus during germination, after germination, during proliferation, when fungus forms hyphae, or at sporulation.

Embodiment 39. The method of any one of Embodiments 36-38, wherein the plant has a disease caused by a phloem pathogen.

Embodiment 40. The method of any one of Embodiments 36-38, wherein the plant has a disease caused by a root pathogen.

Embodiment 41. The method of any one of Embodiments 36-38, wherein the plant is a weed.

Embodiment 42. A method for delivering a conjugate to a plant or fungus, comprising contacting the plant or fungus with a conjugate comprising a nanoparticle and/or a molecular basket that is linked to a Sucrose Transporter protein (SUT) targeting agent, wherein the nanoparticle is selected from the group consisting of quantum dot, carbon dot, carbon nanotube, silica nanoparticle (e.g., porous silica nanoparticle), lipid nanoparticle, liposome, metal or metal oxide nanoparticle, and micro or macro nutrient-based nanoparticles.

Embodiment 43. The method of Embodiment of 42, wherein the conjugate is contacted with the plant and/or fungus during germination, after germination, during proliferation, when fungus forms hyphae, or at sporulation.

Embodiment 44. A conjugate comprising a Sucrose Transporter protein (SUT) targeting agent linked to a nanoparticle, wherein the conjugate is capable of being delivered to a plant or fungus, and the nanoparticle is selected from the group consisting of a quantum dot, carbon dot, carbon nanotube, silica nanoparticle (e.g., porous silica nanoparticle), lipid nanoparticle, liposome, metal or metal oxide nanoparticle, and micro or macro nutrient-based nanoparticle.

Embodiment 45. The conjugate of Embodiment 44, comprising a conjugate of Formula I:

NP-(linker-TA)ₙ (I)

wherein: NP is a nanoparticle selected from the group consisting of a quantum dot, carbon dot, carbon nanotube, silica nanoparticle (e.g., porous silica nanoparticle), lipid nanoparticle, liposome, metal or metal oxide nanoparticle, and micro or macro nutrient-based nanoparticle; TA is the Sucrose Transporter protein (SUT) targeting agent; the linker has a molecular weight of from about 20 daltons to about 20,000 daltons; and n is an integer≥1.

Embodiment 46. The conjugate of Embodiment 45, wherein the nanoparticle is selected from carbon dot, carbon nanotube, silica nanoparticle (e.g., porous silica nanoparticle), lipid nanoparticle, liposome, and micro or macro nutrient-based nanoparticle.

Embodiment 47. The conjugate of any one of Embodiments 44-46, which does not comprise a cargo.

Embodiment 48. The conjugate of any one of Embodiments 44-46, which comprises a cargo.

Embodiment 49. A method comprising, detecting a conjugate as described in any one of Embodiments 44-48 in a plant or fungus.

The invention will now be illustrated by the following non-limiting Examples.

Example 1: Targeted delivery of nanomaterials to the phloem by plant biorecognition Current practices for delivering agrochemicals are inefficient, with only a fraction reaching the intended targets in plants. Herein, nanomaterials functionalized with sucrose enables faster and more efficient foliar delivery into the plant phloem, a vascular tissue that transports sugars, agrochemicals, and signaling molecules. The high affinity of sucrose molecules to the sucrose transporter membrane proteins (SUT) on the phloem companion cells mediates the biorecognition and loading of quantum dots functionalized with sucrose (sucQD). The QD fluorescence optical properties enabled measurement of rapid uptake of sucQDs and translocation in the phloem of wheat leaves (<40 min) by fluorescence microscopy. Foliar delivery of engineered nanomaterials by plant biorecognition molecules provides an approach for guiding agrochemicals to specific plant organs with enhanced uptake efficiency.

### Introduction

The increasing global demand for agricultural productivity by a rapidly growing population requires a significant increase in food production ¹. Agricultural practices wield some of the earth's most significant pressures on natural resources, leading to deforestation, groundwater pollution, and increased greenhouse gas emissions ^{2,3}. The loss of agrochemicals such as pesticides and fertilizers in agricultural land are among the most negative impacts on environmental and human health ⁴. Pesticides, a major class of agrochemicals, accumulate in the environment, and progressive biomagnification can move them into the food chain ⁵. While the use of pesticides increases crop yield and quality, excessive use of pesticides leads to resistance to agricultural pests (i.e., pathogens), impacts air quality, and contaminates water and soil ⁶. This is particularly concerning since it is estimated that less than 0.1% of the 5.6 billion pounds of pesticides applied worldwide reach the intended biological target ⁸⁻⁹.

Convergent new approaches to increase agrochemical delivery efficiency require the development of new technologies ^{10,11,12}. The plant phloem provides a functional transport system to directly deliver materials from leaves to the other plant organs, including underground roots, without interacting with complex and diverse types of soil matrices ¹³. Furthermore, the plant vascular system hosts devastating plant pathogens that impair crop yields ¹⁴. Long-distance transport of organic compounds such as amino acids and photosynthetic products (i.e., sugars) in the phloem is pressure driven by bulk flow through cell-to-cell in companion cells and within sieve vascular elements that coordinate loading and unloading of phloem sap ¹⁵⁻¹⁷. Plant transport of sucrose, a primary sugar transported in the phloem of plants, is highly regulated and requires H+-coupled sucrose-uptake transporters (SUTs) ^{15,17}. It is shown herein that these innate mechanisms of sucrose recognition and transport by the phloem provide an untapped opportunity to guide nanomaterials with agrochemical cargoes by plant biorecognition.

Nanomaterials with tunable physical and chemical properties are emerging tools for improving the delivery efficiency of chemical and biomolecular cargoes in plants. For example, the size and charge of nanomaterials may play a role in their foliar delivery efficiency to plant cells and organelles, including stomata guard cells and chloroplasts ¹⁸. Recently, it was demonstrated that engineered nanomaterials can be guided by a targeting peptide motif that targets chemical cargoes to photosynthetic organelles ¹⁹, or can be targeted towards stomata, and trichomes with proteins coating ²⁰. Approaches using the molecular machinery of plants to target nanomaterials to the phloem have not been explored. Current methods for delivering chemicals to the phloem rely on conjugation with antibodies that are inadequate for agricultural applications due to their high costs and stability issue at ambient conditions ²¹⁻²³. Herein, an alternative approach was discovered using surface functionalization of nanoparticles with biorecognition molecules having affinity for SUT (e.g., sucrose) that can be scalable and low cost.

Quantum dots (QDs) are traceable model nanoparticles that enable assessing interactions with plant biointerfaces with multiple advanced analytical tools. QD's intrinsic and bright non-photobleaching fluorescence with tunable emission wavelength can be imaged in plants at high spatial and temporal resolutions by confocal fluorescence microscopy ¹⁹. Furthermore, QDs tunable surface chemistry permits coating with biorecognition motifs for targeted delivery to plant tissues, cells, and organelles ²⁴. Combined, QDs are valuable tools for tracking and quantifying the targeted delivery of nanomaterials in plants for a fundamental understanding of nanoparticle-plant interactions.

This Example assessed how functionalization of the nanoparticle (e.g., QD) surface with sucrose influences nanoparticle foliar delivery and uptake into the phloem of wheat (Triticum aestivum) plants. It was hypothesized that improved delivery of sucrose coated QDs (sucQDs) to the phloem is enabled by plant biorecognition (FIG. 1). High spatial and temporal resolution confocal microscopy were performed to determine the distribution of QDs in plant leaves. The translocation of QDs into the leaf vasculature was assessed by epifluorescence microscopy. The uptake and transport of QDs from leaves were shown, for example, by confocal imaging studies. This Example provides an approach to target nanomaterials to the phloem for research on nanoparticle-plant interactions, plant biology, and implementation of nano-enabled agriculture.

### Results

### Nanoparticle Functionalization for Targeted Delivery to the Phloem

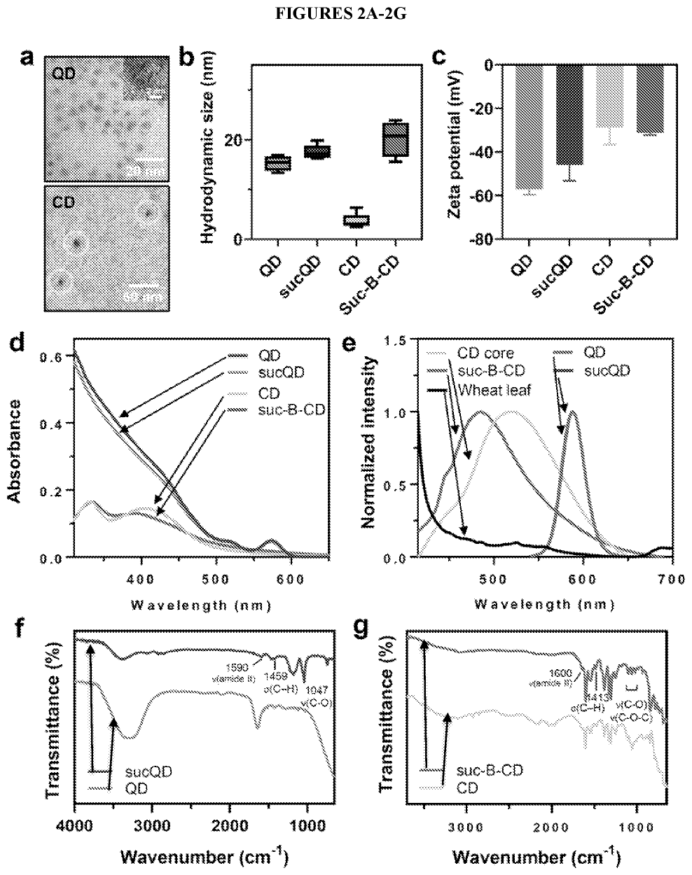

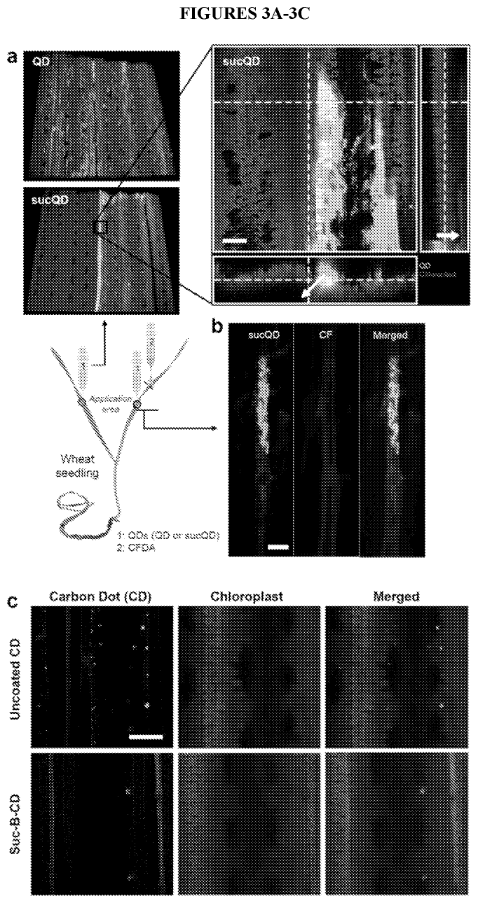

QDs and CDs were functionalized with sucrose to enable biorecognition by phloem SUTs. Sucrose molecules were coated on the QD surface (sucQDs) or CD surface (suc-β-CDs) by strong binding between boronic acid groups and carbohydrates (i.e., sucrose) containing syn-periplanar hydroxyl groups (FIG. 1b)¹⁹. We functionalized the CDs with f-cyclodextrin molecular baskets to demonstrate the potential as a nanocarrier for targeted delivery of agrochemicals in plants (FIG. 1b). Transmission electron microscopy (TEM) images showed an average size of sucQDs and suc-β-CDs of approximately 5.0±0.8 nm and 9.1±2.8 nm, respectively (FIG. 2a). The hydrodynamic diameter (in 10 mM TES pH 7.4) was similar for sucQDs (17.6±1.4 nm) and suc-β-CDs (18.1±5.8 nm) (FIG. 2b). Both sucQDs and QDs are negatively charged with high (potentials of −45.9±7.4 mV and −57.1±2.5 mV, respectively (10 mM TES, at pH 7.0). The suc-β-CD and core CD showed less negatively charged zeta potentials of −31.1±1.1 mV and −28.9±7.7 mV than QDs (FIG. 2c). The size and charge of nanoparticles may play a role in their distribution in plant cells or organelles¹³⁻¹⁸. Both DLS size and ζ potentials of these nanomaterials are in a range reported to facilitate internalization through leaf biosurface barriers, including the plant cell wall and plasma membrane. Although sucQDs exhibit the same characteristic absorption peak as QDs at 575 nm (FIG. 2d), the normalized absorbance of sucQDs has a slight increase in the UV range, attributed to the introduction of sucrose molecules on their surface. Absorption spectrum of suc-β-CD showed the broadening of CD absorption in the UV and visible range due to the introduction of both sucrose molecules and β-cyclodextrins. One of the remarkable properties of these nanomaterials is their high, tunable, and stable fluorescence that allows tracking their translocation and distribution within leaf tissues and cells. As shown in FIG. 2e, the surface coating on the QD did not significantly affect the intrinsic emission fluorescence properties with a maximum emission peak at 580 nm for sucQDs. CD fluorescence was blue-shifted by surface coating from 520 to 486 nm for suc-β-CD. Both fluorescence of sucQDs and suc-β-CD avoid optical interference with autofluorescence from leaves above ˜620 nm (FIG. 2e)^{18,19}. We measured fourier transform infrared spectroscopy (FT-IR) to confirm the functionalization of QD and CD with sucrose and/or β-cyclodextrins (FIG. 2f-g). The sucQDs or suc-β-CDs showed characteristic vibrational modes for an amide II (1590 cm⁻¹ for sucQDs and 1600 cm⁻¹ for suc-B-CD), C—H bending of sucrose or β-cyclodextrin molecules (1459 cm⁻¹, 1413 cm⁻¹), B—O stretching from sucQDs and suc-β-CD (1326 cm⁻¹, 1330 cm⁻¹, respectively) and C—O stretching of sucrose at 1047 cm⁻¹ and C—O or C—O—C stretching of β-cyclodextrin at 1101, 1060, 1014 cm⁻¹. Together, these results indicate that both QD and CD have been successfully functionalized with sucrose or β-cyclodextrin molecules and that the remarkable optical properties of these nanomaterials were maintained.

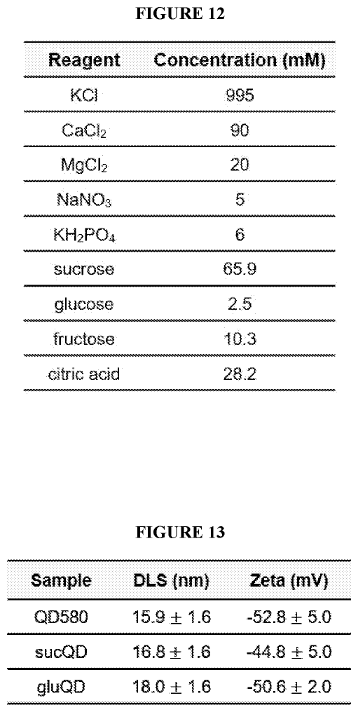

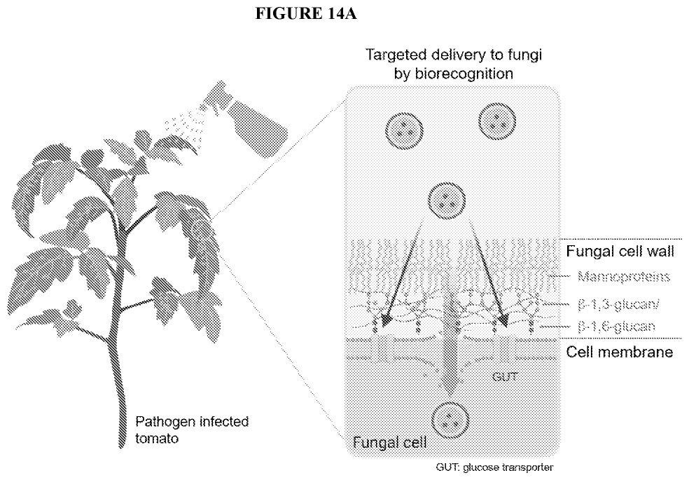

The colloidal stability of nanomaterials in simulated phloem sap was investigated to determine the impact on QD aggregation and degradation of the nanoparticles by the dissolution of their elements²⁵. The phloem sap was mimicked by including reported sugar and metal ion content (FIG. 12) and measured the change in the characteristic absorbance peak of QDs at 574 nm after incubation with the simulated phloem sap for 1 and 7 days were measured. Both QDs and sucQDs showed negligible change in peak shift or absorbance intensity (FIG. 2f). The hydrodynamic diameter also did not vary under simulated phloem sap conditions (FIG. 13). Together, these results indicate high stability without agglomeration or degradation of QDs within one week, which is longer than the experiments in this Example.

### Nanoparticle Uptake in the Plant Vascular System

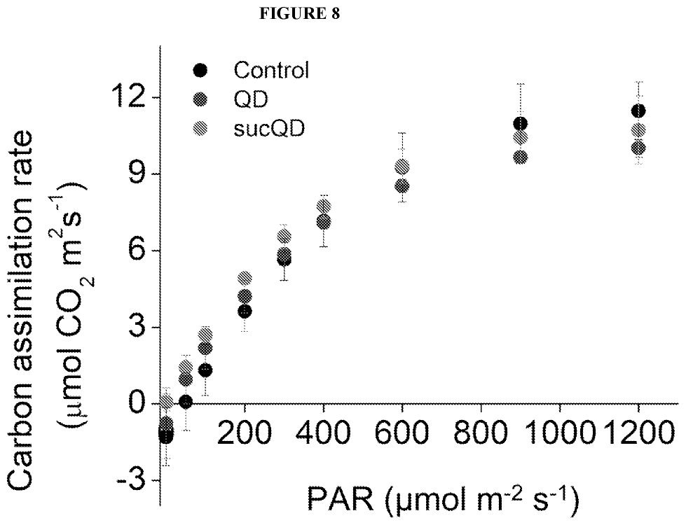

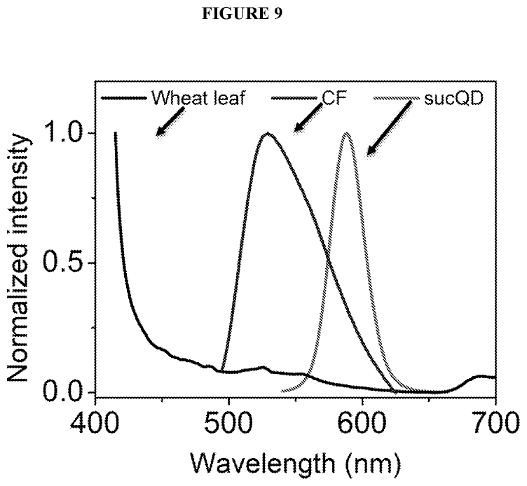

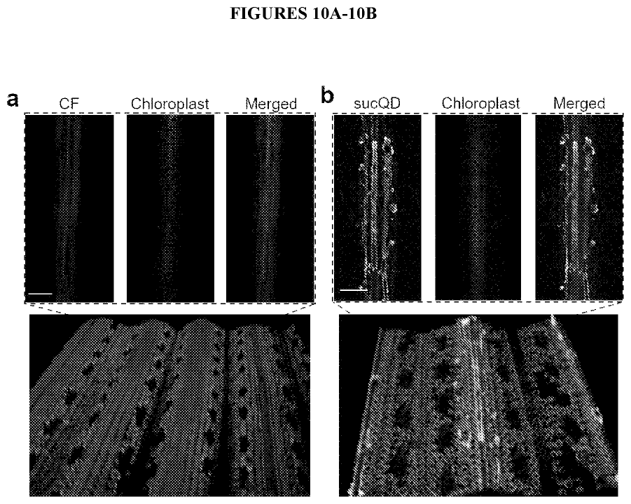

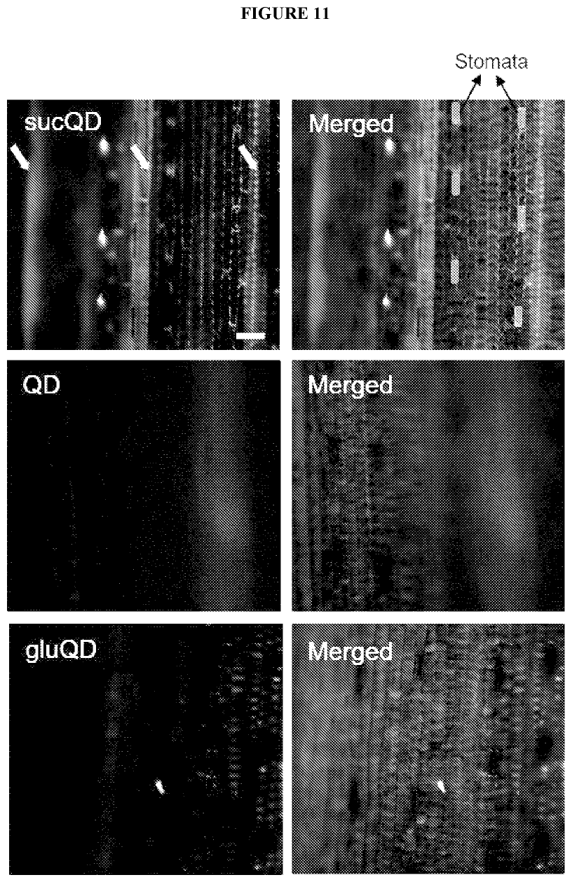

How the sucrose surface coating of QDs affects the nanoparticle translocation from the leaf surface into the phloem was investigated by high spatial resolution (206-233 nm x-y and 2 μm z-axis resolution) confocal fluorescence microscopy imaging (FIG. 3). The nanoparticles were delivered by foliar application to the adaxial (top) leaf surface of 5 l of sucQDs or QDs in buffer (10 mM TES) with 0.1 wt % Silwet surfactant. QDs were imaged by confocal microscopy in the loading area where the nanoparticles were applied topically on the wheat leaf surface for 30 min (FIG. 3a). These exposure conditions at a concentration of 200 μM of QDs did not significantly impact leaf health, determined by photosynthetic assays. The CO₂ assimilation rate (A) at different light levels of leaves exposed to QDs and sucQDs were similar to controls without nanoparticles (FIG. 8). After 30 min exposure, unmodified QDs were distributed across the entire leaf tissue. In contrast, sucQDs were mainly localized along the leaf primary veins indicating uptake into the vasculature (FIG. 3a). To examine the distribution of CD in leaves, the suc-β-CD and uncoated CD were applied on the leaf surface and imaged by confocal fluorescence microscopy. The suc-β-CD also showed a fluorescence signal arranged in a linear pattern that indicates localization with the leaf vasculature (FIG. 3c). To determine the vascular tissue transporting sucQDs, colocalization assays of sucQDs with phloem labeled with a fluorescent dye was performed. The 5,6-carboxyfluorescein diacetate (CFDA) is converted into its fluorescent form carboxyfluorescein (CF) when it reacts with cellular esterases after permeation in phloem tissues²⁶. This technique is used for live imaging of phloem companion cells and sieve elements in plants²⁶. The CF fluorescence emission was imaged within the region that does not overlap with the QD fluorescence (<550 nm, FIG. 9). The CFDA dye translocated from the leaf surface into the phloem similarly to QDs (FIG. 10A). The sucQD fluorescence colocalization (87±5.5%) with the CF dye indicates translocation of sucQDs through the leaf phloem tissue.

### Real-Time Imaging of Nanoparticle Translocation in the Phloem

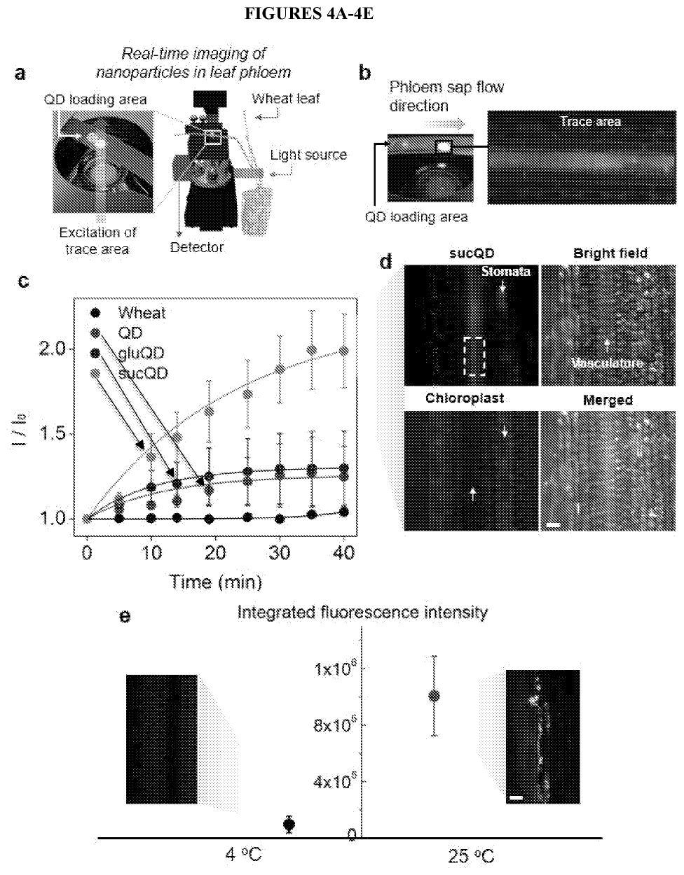

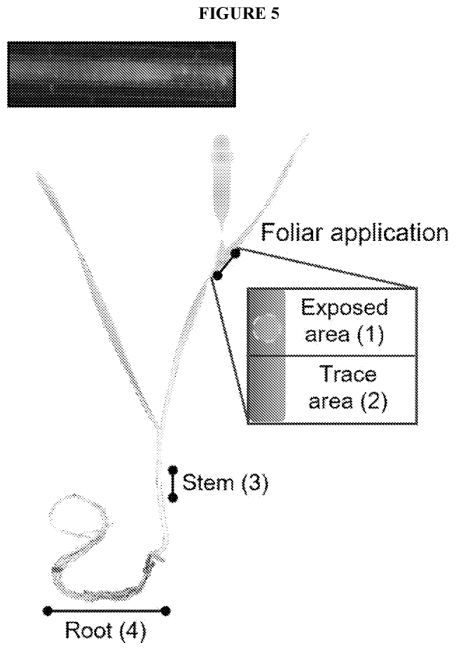

To investigate the translocation dynamics of QDs in the phloem, an epifluorescence microscope was customized to detect changes in nanoparticle fluorescence intensity in the leaf vasculature in planta (see methods, FIG. 4a). Changes in QD fluorescence intensity were monitored in real-time downstream the foliar application area (towards the stem) in leaves of intact live plants (FIG. 4b). The phloem sap in mature leaves is transported towards the stem, whereas the xylem sap moves in the opposite direction. The sucQD fluorescence intensity doubled downstream the foliar application area during 40 min demonstrating the nanoparticles are translocated by phloem vascular tissue (FIG. 4c). In contrast, the unmodified QD fluorescence intensity increased only 1.25 times relative to the initial intensity within the same timeframe. The merged bright-field image of the leaf vasculature with QD fluorescence illustrates the nanoparticle localization in the phloem after 40 min of exposure (FIG. 4d, FIG. 11). The rapid translocation of QDs in the phloem is within the timescale expected for phloem sap velocity of 0.05 to 0.2 mm per sec ^{27,28}. A QD fluorescence signal in stomata guard cells on the leaf surface suggests a stomatal pathway of uptake into the leaf tissues and the vasculature. Together, these results indicate that sucQDs can be rapidly uptaken and translocated through the leaf phloem.

Biorecognition Mediated Uptake of Nanoparticles into the Phloem

To understand the biorecognition mechanisms guiding sucQDs into the phloem, the translocation kinetics of sucQDs and glucose-coated QDs (gluQDs) were examined. It was hypothesized herein that the SUT (sucrose transporter) membrane proteins that facilitate sucrose loading into the phloem increase the binding affinity of sucQDs to this plant vascular tissue ^{29,30}. SUTs transport sucrose and other sugars in plants; however, the specificity to sucrose is much higher than for glucose. The gluQD hydrodynamic size and charge were similar to sucQDs (FIG. 13). However, the translocation kinetics of gluQDs was slower and resulted in a 1.25 times increase in fluorescence intensity in the leaf phloem (FIG. 4c), similar to the unmodified QDs indicating that glucose moieties are ineffective at improving QD loading and translocation into the phloem. To examine the uptake mechanisms, the effect of temperature on changes in sucQD fluorescence intensity in the phloem was compared (FIG. 4e). Endocytosis is an energy-dependent mechanism that is inhibited at low temperatures ³¹. The sucQDs were detected in the phloem after exposure at 25° C. but not at 4° C., indicating that sucQDs transport into the phloem vessels may be energy-dependent and may be by an endocytic pathway. In contrast, nanoparticle uptake in photosynthetic leaf mesophyll cells has been reported to be independent of endocytosis ^{32,33}. Thus, there might be an alternative mechanism of nanoparticle lipid bilayer disruption involved. Overall, these results indicate that sucQDs are guided to the phloem by SUT recognition of sucrose moieties on the QD surface. Previous work also indicated that Au nanoparticles (NPs) that more readily entered the phloem were translocated more efficiently away from the exposed leaf, and that the roots were a significant sink for foliar applied Au NPs (3, 10, and 50 nm) in wheat plants ¹³, for foliar applied TiO₂ and ZnO NPs (25 nm) ³⁴.

### Discussion

Nanoparticle surface coating with biorecognition molecules is a promising approach for targeted delivery of nanomaterials to plant tissues (i.e., phloem). Herein, QDs acting as model traceable nanoparticles allowed proof of concept of more efficient delivery of sucrose coated nanoparticles (e.g., sucQDs) to the phloem guided by plant biorecognition. The distribution and translocation of QDs in plant leaves were assessed by imaging their fluorescence emission through confocal and epifluorescence microscopy. The sucQD high colocalization with the phloem in plant leaves, translocation within the time scale reported for sap phloem velocities, and in the expected phloem sap direction (towards the stem) indicate that sucQDs are rapidly uptaken through the leaf epidermis and translocated in the phloem by bulk sap flow. The sucQD biorecognition in phloem vessels is mediated by the affinity of sucrose moieties with SUTs, and the uptake into the phloem may be potentially via an endocytosis mediated mechanism or other alternative mechanism such as nanoparticle disruption of lipid bilayer that remains to be investigated. The sucQDs are delivered by long-distance transport through the phloem from exposed mature leaves to roots. This biorecognition approach provides a tool for foliar delivery of agrochemical cargoes (e.g., via nanomaterails) to roots while avoiding interfering interactions with soils. The sucrose coating of nanomaterials approach could be applied to the targeted delivery to the phloem of biocompatible and environmentally friendly nanoparticles such as carbon dots with molecular baskets ¹⁹ and mesoporous silica nanoparticles carrying active ingredients ³⁵, and plant nutrient-based nanoparticles ^{36,37} for enabling a more efficient and sustainable agriculture with reduced environmental impact.

### Methods

Synthesis of sucrose and β-cyclodextrin coated carbon dots (suc-B-CDs). The suc-B-CDs were synthesized by coating with β-cyclodextrin and sucrose on the CD core. Core carbon dots (CDs) were synthesized by the slight modification of previously reported protocols (Hu et al. ACS Nano 2020, 14, 7, 7970-7986). The CD cores were synthesized by hydrothermal reactions using citric acid, urea, and ammonium hydroxide. In brief, 1.92 g of citric acid (Fisher, 99.7%) and 2.40 g of urea (Fisher, 99.2%) were dissolved in 2 mL of DI water and 1.35 mL of ammonium hydroxide (Sigma Aldrich, NH₃·H₂O, 30-33%) was added into the mixture. The mixture was reacted at 180° C. for 1.5 h and was cooled down to room temperature and redissolved in DI water. The aggregate was removed by centrifugation at 4,500 rpm for 30 min. A solution was further filtered by using a syringe filter (Whatman, pore size, 0.02 μm) to remove large size particles. Next, the CD core was functionalized by carboxyphenylboronic acid (CBA) as BA capped CDs (BA-CDs). NHS (75 nmol) and EDC/HCl (75 nmol) were added to the CD in TES buffer (10 mM TES buffer, pH 7.4). Then, the mixture was vortexed (750 rpm) for 15 min at ambient temperature. A CBA solution (75 nmol) was added and reacted for 3 h at room temperature. To wash the excess of CBA out, a dialysis membrane (1 K MWCO, Spectrum Laboratories) was used and dialyzed with 2 L DI water. For introducing β-cyclodextrin and sucrose on the sucCDs, firstly the BA-CDs were dispersed in TES buffer (10 mM TES buffer; pH 10.4), then 10 ul of 5 mM β-cyclodextrin was added and stirred overnight. After reaction with β-cyclodextrin, the mixture was washed with a dialysis membrane (1 K MWCO, Spectrum Laboratories) by dialysis with 2 L DI water. Subsequently, sucrose was reacted by repeating the same protocol with β-cyclodextrin.

Synthesis of sucrose coated QDs (sucQDs). The sucQDs were synthesized from carboxylated QDs functionalized with 3-aminophenyl boronic acid (APBA) capped QDs (BA-QDs). The carboxylated QDs (QSH-580, Ocean nanotech., USA) were functionalized by 1-ethyl-3-(3-dimethylarninopropyl) carbodiimide (EDC), and N-hydroxysuccinirnide (NTHS) activated reaction. Briefly, NHS (75 nmol) and EDC/HCl (75 nmol) were added to the 0.5 uM of the carboxylated QD in TES buffer (10 mM TES buffer, pH 7.4). Then, the mixture was vortexed (750 rpm) for 15 min at ambient temperature. An APBA solution (75 nmol) was added to the activated carboxylated QD solution to generate boronic acid functionalized quantum dots (BA-QDs). The reaction was stirred (750 rpm) for 3 h at room temperature. The excess of APBA was removed using a centrifugal filter (30 K amicon filter, Millipore) with ddH2O and repeated at least five times, To avoid agglomeration during the centrifugation step, a bath sonication step was used to re-suspend the BA-QDs in the centrifugal filter after refilling with ddH2O. For the synthesis of sucQDs, the BA-QDs were suspended in TES buffer (10 mM TES buffer; pH 10.4), then 10 ul of 5 mM sucrose solution was added to the BA-QD solution and vortexed overnight. Sucrose-coated BA-QDs (sucQDs) were washed using a centrifugal filter (30 K amicon filter, Millipore) in ddH₂O. This step was performed in the same way as the washing step of BA-QDs. The resulting sucQDs were suspended in 10 mM TES (pH 7.5) for experiments in plants.

Characterization of quantum dots. The sucQD and QD absorbance, photoluminescence, hydrodynamic size, zeta potential, and Fourier transform infrared spectroscopy (FT-IR) were measured to characterize their physicochemical properties. Hydrodynamic sizes and zeta potentials were determined in a 10 mM TES buffer (pH 7) in the presence of 0.1 mM NaCl using a Nano-S Malvern Zetasizer. The UV-vis absorption spectra were measured in a UV-2600 Shimadzu spectrophotometer to calculate the concentration of sucQD based on their absorbance at 575 nm. The concentration of the sucQDs (mol L⁻¹) was determined using Lambert-Beer's law (Eq. 1), where Abs is absorbance, c is the extinction coefficient, L is the path length, and c is concentration.

Abs=∈×L×c, (1)

Transmission electron microscopy (TEM) was performed on a Philips FEI Tecnai 12 microscope operated at an accelerating voltage of 120 kV. The TEM samples were prepared by placing one drop of particle solution onto the ultrathin carbon film grid. The surface coatings and functional groups on nanomaterials were characterized by FT-IR (Bruker spectrometer, Alpha I). FT-IR measurements at each step of the synthesis of sucQDs were taken to analyze functional groups on the nanoparticle surface.

Plant growth. Wheat plants (Triticum aestivum, USA) were grown in the F-1200 Plant Growth Chambers (Hipoint, Taiwan) under a light intensity of 200 mol m⁻² s⁻¹ photosynthetic active radiation, 24±1 and 21±1° C. day/night, 60% relative humidity, and 14/10 h day/night light period. Soil was purchased from Planet Natural (Sunshine Mix #1) and autoclaved before use. Each wheat seedling was grown in an individual 2.25 inches square size pot. Plants were watered with tap water once every two days.

Nanoparticle delivery into leaves. A solution of 10 uL QDs (200 nM) in 10 mM TES buffer (pH 7.4) was applied topically on the abaxial side of the wheat leaf lamina for 30 min to enable the translocation of QDs into the vasculature. The remaining QD droplet was gently removed by wiping off with Kimwipes.

Confocal fluorescence microscopy of QDs in plant leaves. The QDs were imaged in wheat leaves by using TCS SP5 laser scanning confocal microscope (Leica Microsystems, Germany). Leaves were exposed to QDs, as explained above. The leaf disks were collected immediately with a cork borer at the loading area and tracing area (10 mm from loading area towards the stem) and mounted on a microscopy slide for confocal microscopy imaging of QDs. The leaf disks in the microscopy slide were placed inside a chamber made with observation gel (132700, Carolina) filled with 0.3 ml of perfluorodecalin (P9900, Sigma-Aldrich) observation solution for improving confocal imaging. The confocal microscopy settings were as follows: x20 and x40 objectives (UAPON-340, 1.15 w); 405 nm laser excitation for QD; z-stack section thickness=2 μm. The PMT detection range was set 550-600 nm for QD; 700-800 nm for chloroplast autofluorescence: 500-550 nm for CDFA. All confocal microscopy images were analyzed using FIJI (ImageJ).

Epifluorescence microscopy of QD uptake and translocation into the phloem. To monitor the translocation of sucQDs into the vascular system in real-time, epifluorescence images were collected by a customized microscopy system. A wheat leaf from an intact live plant was mounted using metal clips on the microscope stage. QDs were applied on wheat leaves as described above. The roots and soil in the pot were wrapped with aluminum foil to prevent spilling on the microscopy setup. The measurement spot on the abaxial side of the leaf surface was focused 10 mm away from the loading area exposed to sucQDs or QDs suspension. A fluorescence light source (U-HGLGPS, Oylmpus) was used for excitation of QDs and a PMT detector (Retiga R3, Qimaging) for imaging fluorescence emission. Images were collected using optical cube filters for QD fluorescence emission or chloroplast autofluorescence as follows: For QDs, excitation 405 nm, emission detection range was 570-590 nm; for chloroplasts excitation 405 nm, emission detection range was 700-800 nm. The integration time was set at 0.1 s. The collected images were converted to calculate integrated average fluorescence intensity with FIJI (ImageJ).

### DOCUMENTS CITED IN EXAMPLE 1

1. Spiertz, J. H. J. & Ewert, F. Crop production and resource use to meet the growing demand for food, feed and fuel: opportunities and constraints. NJAS—Wageningen Journal of Life Sciences 56, 281-300 (2009).
2. Dalin, C. & Rodriguez-Iturbe, I. Environmental impacts of food trade via resource use and greenhouse gas emissions. Environ. Res. Lett. (2016).
3. DeFries, R. S., Rudel, T., Uriarte, M. & Hansen, M. Deforestation driven by urban population growth and agricultural trade in the twenty-first century. Nat. Geosci. 3, 178-181 (2010).
4. Alam, Z. The Use of Biotechnology to Reduce the Dependency of Crop Plants on Fertilizers, Pesticides, and Other Agrochemicals. Biotechnology in Functional Foods and Nutraceuticals 197-218 (2010) doi:10.1201/9781420087123-c13.
5. Sebastian, A., Nangia, A. & Prasad, M. N. V. Chapter 18—Advances in agrochemical remediation using nanoparticles. in Agrochemicals Detection, Treatment and Remediation (ed. Prasad, M. N. V.) 465-485 (Butterworth-Heinemann, 2020).
6. Lamichhane, J. R., Dachbrodt-Saaydeh, S., Kudsk, P. & Messéan, A. Toward a Reduced Reliance on Conventional Pesticides in European Agriculture. Plant Dis. 100, 10-24 (2016).
8. Stone, W. W., Gilliom, R. J. & Ryberg, K. R. Pesticides in U.S. Streams and Rivers: Occurrence and Trends during 1992-2011. Environ. Sci. Technol. 48, 11025-11030 (2014).
9. Alavanja, M. C. R. Introduction: Pesticides Use and Exposure, Extensive Worldwide. Reviews on Environmental Health vol. 24 (2009).
10. Su, Y. et al. Delivery, uptake, fate, and transport of engineered nanoparticles in plants: a critical review and data analysis. Environ. Sci.: Nano 6, 2311-2331 (2019).
11. Lowry, G. V., Avellan, A. & Gilbertson, L. M. Opportunities and challenges for nanotechnology in the agri-tech revolution. Nat. Nanotechnol. 14, 517-522 (2019).
12. Hofmann, T. et al. Technology readiness and overcoming barriers to sustainably implement nanotechnology-enabled plant agriculture. Nature Food 1, 416-425 (2020).
13. Avellan, A. et al. Nanoparticle Size and Coating Chemistry Control Foliar Uptake Pathways, Translocation, and Leaf-to-Rhizosphere Transport in Wheat. ACS Nano (2019) doi:10.1021/acsnano.8b09781.
14. Yadeta, K. A. & J Thomma, B. P. H. The xylem as battleground for plant hosts and vascular wilt pathogens. Front. Plant Sci. 4, 97 (2013).
15. VAN Bel, A. J. E. & Van Bel, A. J. E. The phloem, a miracle of ingenuity. Plant, Cell & Environment vol. 26 125-149 (2003).
16. Lucas, W. J. et al. The plant vascular system: evolution, development and functions. J. Integr. Plant Biol. 55, 294-388 (2013).
17. Dinant, S. & Lemoine, R. The phloem pathway: new issues and old debates. C. R. Biol. 333, 307-319 (2010).
18. Hu, P. et al. Nanoparticle Charge and Size Control Foliar Delivery Efficiency to Plant Cells and Organelles. ACS Nano (2020) doi:10.1021/acsnano.9b09178.
19. Santana, I., Wu, H., Hu, P. & Giraldo, J. P. Targeted delivery of nanomaterials with chemical cargoes in plants enabled by a biorecognition motif. Nat. Commun. 11, 2045 (2020).
20. Spielman-Sun, E. et al. Protein coating composition targets nanoparticles to leaf stomata and trichomes. Nanoscale (2020) doi:10.1039/c9nr08100c.
21. Gravato-Nobre, M. J. et al. Meloidogyne incognita Surface Antigen Epitopes in Infected Arabidopsis Roots. J. Nematol. 31, 212-223 (1999).
22. Kim, J. S. & Daniel, G. Immunolocalization of pectin and hemicellulose epitopes in the phloem of Norway spruce and Scots pine. Trees 31, 1335-1353 (2017).
23. DeWitt, N. D. & Sussman, M. R. Immunocytological localization of an epitope-tagged plasma membrane proton pump (H(+)-ATPase) in phloem companion cells. Plant Cell 7, 2053-2067 (1995).
24. Koo, Y. et al. Fluorescence Reports Intact Quantum Dot Uptake into Roots and Translocation to Leaves of Arabidopsis thaliana and Subsequent Ingestion by Insect Herbivores. Environ. Sci. Technol. 49, 626-632 (2015).
25. Su, Y. et al. Delivery, Fate, and Mobility of Silver Nanoparticles in Citrus Trees. ACS Nano 14, 2966-2981 (2020).
26. Cayla, T. et al. Live imaging of companion cells and sieve elements in Arabidopsis leaves. PLoS One 10, e0118122 (2015).
27. Payvandi, S., Daly, K. R., Zygalakis, K. C. & Roose, T. Mathematical modelling of the Phloem: the importance of diffusion on sugar transport at osmotic equilibrium. Bull. Math. Biol. 76, 2834-2865 (2014).
28. Savage, J. A., Zwieniecki, M. A. & Holbrook, N. M. Phloem transport velocity varies over time and among vascular bundles during early cucumber seedling development. Plant Physiol. 163, 1409-1418 (2013).
29. Reinders, A. Evolution of plant sucrose uptake transporters. Frontiers in Plant Science vol. 3 (2012).
30. Sun, Y. & Ward, J. M. Arg188 in rice sucrose transporter OsSUT1 is crucial for substrate transport. BMC Biochemistry vol. 13 26 (2012).
31. Low, P. S. & Chandra, S. Endocytosis in Plants. Annu. Rev. Plant Physiol. Plant Mol. Biol. 45, 609-631 (1994).
32. Wu, H., Tito, N. & Giraldo, J. P. Anionic Cerium Oxide Nanoparticles Protect Plant Photosynthesis from Abiotic Stress by Scavenging Reactive Oxygen Species. ACS Nano vol. 11 11283-11297 (2017).
33. Lv, J., Christie, P. & Zhang, S. Uptake, translocation, and transformation of metal-based nanoparticles in plants: recent advances and methodological challenges. Environmental Science: Nano 6, 41-59 (2019).
34. Raliya, R., Nair, R., Chavalmane, S., Wang, W.-N. & Biswas, P. Mechanistic evaluation of translocation and physiological impact of titanium dioxide and zinc oxide nanoparticles on the tomato (Solanum lycopersicum L.) plant. Metallomics 7, 1584-1594 (2015).
35. Hussain, H. I., Yi, Z., Rookes, J. E., Kong, L. X. & Cahill, D. M. Mesoporous silica nanoparticles as a biomolecule delivery vehicle in plants. J. Nanopart. Res. 15, 1676 (2013).
36. Borgatta, J. et al. Copper Based Nanomaterials Suppress Root Fungal Disease in Watermelon (Citrullus lanatus): Role of Particle Morphology, Composition and Dissolution Behavior. ACS Sustainable Chem. Eng. 6, 14847-14856 (2018).
37. Ma, C. et al. Advanced material modulation of nutritional and phytohormone status alleviates damage from soybean sudden death syndrome. Nat. Nanotechnol. (2020) doi:10.1038/s41565-020-00776-1.

### Example 2. Targeted Delivery to Fungi by Biorecognition Using Glucose Coated Carbon Dot

Nanocarriers were designed herein to target the delivery of active ingredients to fungi in plants by recognizing glucose transporters (GUT) on the fungi cell membrane. The β- or γ-cyclodextrin/glucose-coated Gd-doped carbon dot (glu-β-GdCD) nanocarriers described in this Example comprise three components: a biorecognition moiety (glucose), a fluorescent nanoparticle (carbon dot), and a molecular basket for loading fungicide(s). The glucose coated nanocarriers have a higher binding affinity to fungi cells, which is mediated by the biorecognition between glucose on the nanoparticle surface and GUT membrane proteins. An increase in nanoparticle thickness after functionalization with molecular baskets was also observed (FIG. 14).

Enhanced delivery of nanocarriers functionalized with glucose to fungi was shown in an in vitro assay, in which GFP-Botrytis hyphae were incubated with nanocarriers followed by washing with DI water before confocal microscopy imaging. Representative confocal images of GFP-Botrytis exposed to nanocarriers indicate enhanced uptake into fungi of glucose coated glu-ρ-GdCD (FIG. 15b). Colocalization analysis of GdCD with GFP-Botrytis fluorescence signals indicated a significantly higher percentage of GFP co-localized with targeted glu-β-GdCD compared to the control counterparts without glucose coating (FIG. 15c). Orthogonal view of z-stacked confocal images GFP-botrytis was performed using line transect and it showed an overlap of the fluorescence peaks corresponding to GFP and GdCD (FIG. 15d).

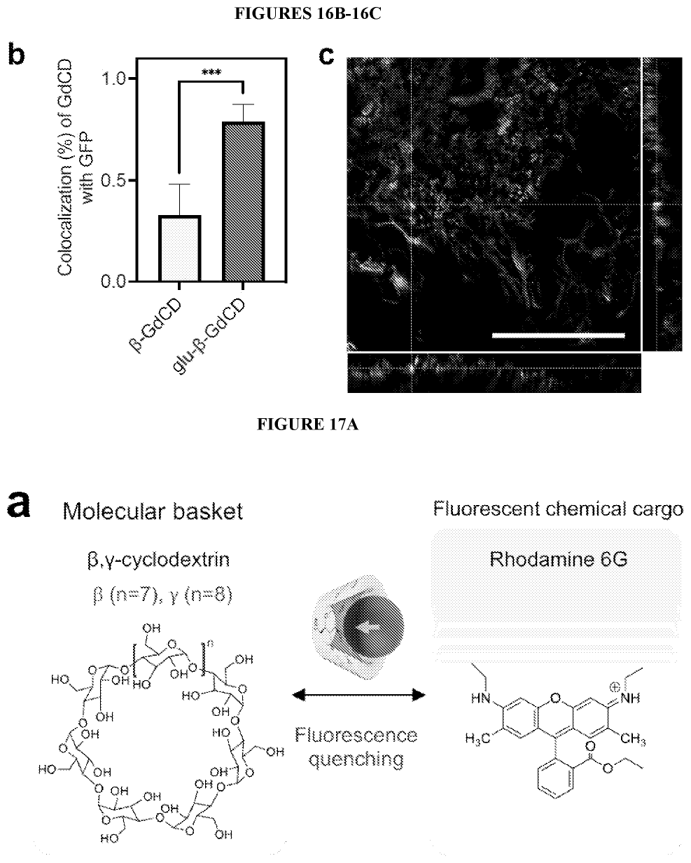

Targeted delivery of nanocarriers coated with glucose to fungi were also tested in infected leaves. In vivo confocal images of GFP-Botrytis infected leaves indicated a higher degree of colocalization of nanocarriers coated with glucose (glu-β-GdCD and glu-γ-GdCD) with GFP fluorescence compared to non-targeted nanocarriers (β-GdCD) (FIG. 16a). Enhanced colocalization rates of glu-β-GdCD with GFP were shown as compared to β-GdCD (FIG. 16b). Orthogonal views from Z-stack confocal images showed colocalization of glu-β-GdCD within GFP-botrytis (FIG. 16c).

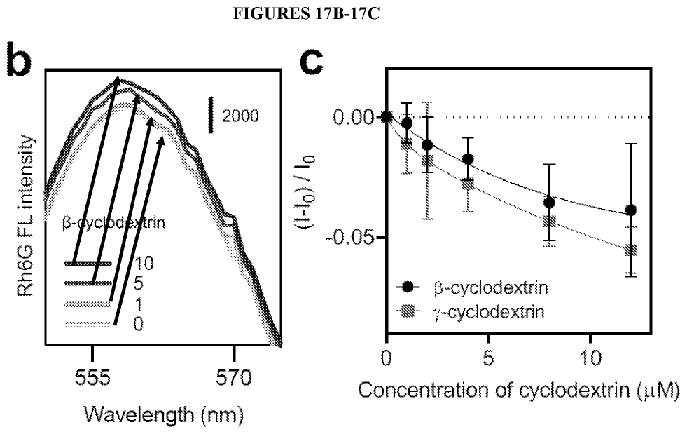

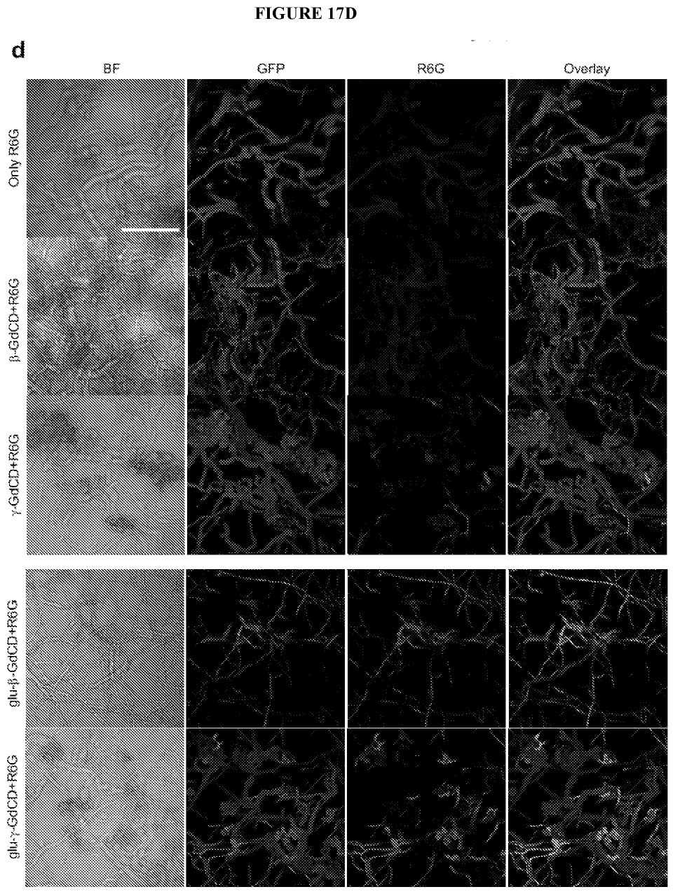

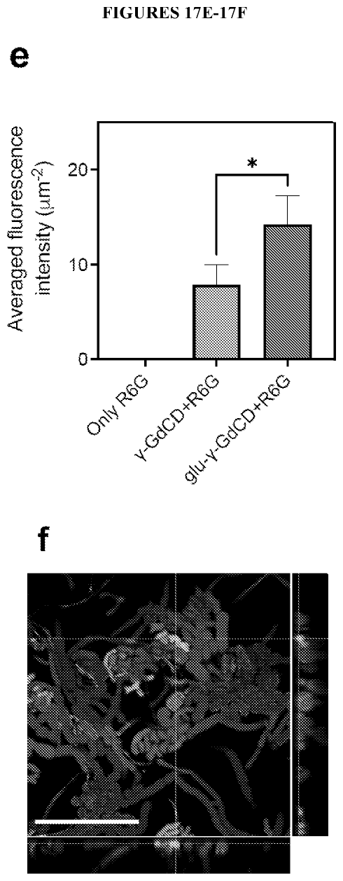

In vitro delivery of fluorescent chemical cargo to fungi mediated by nanocarriers was evaluated. Fluorescence spectra of R6G in the presence of different concentrations of β-cyclodextrins (0-10 mM, TES buffer, pH 7.4) were assessed (FIG. 17b). Dose dependent fluorescence response of R6G interacted with β-, γ-cyclodextrins was assessed (FIG. 17c). Confocal images of GFP-botrytis infected leaf indicated a higher degree of colocalization of nanocarriers coated with glucose (glu-β-GdCD and glu-γ-GdCD) with GFP fluorescence compared to non-targeted nanocarriers (β-GdCD and γ-GdCD) (FIG. 17d). Enhanced colocalization rates of glu-γ-GdCD with GFP were shown as compared to γ-GdCD (FIG. 17e). Orthogonal views from z-stack confocal images colocalizing R6G with glu-γ-GdCD in GFP-botrytis (FIG. 17f).

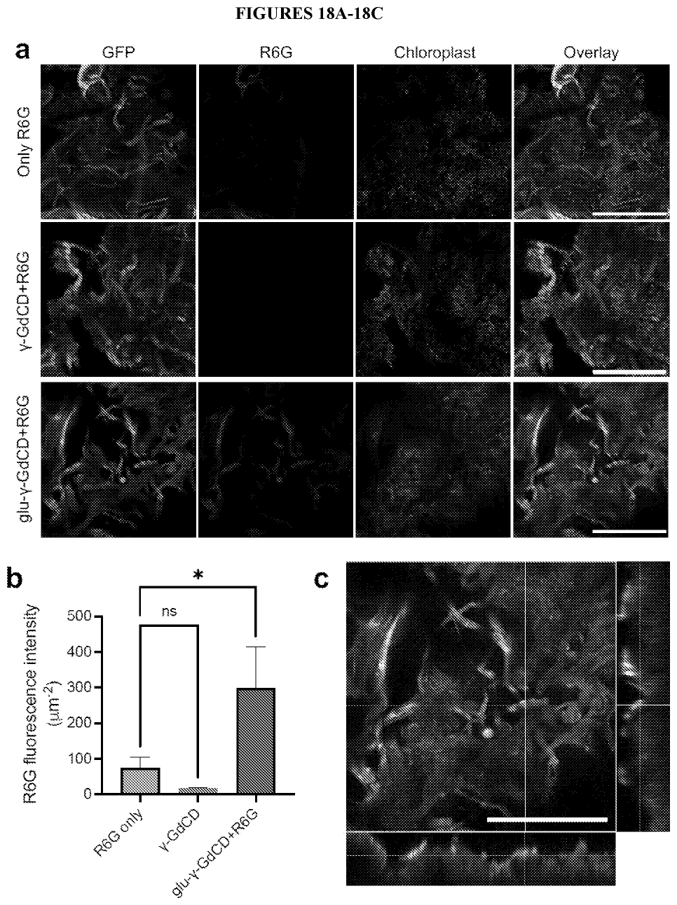

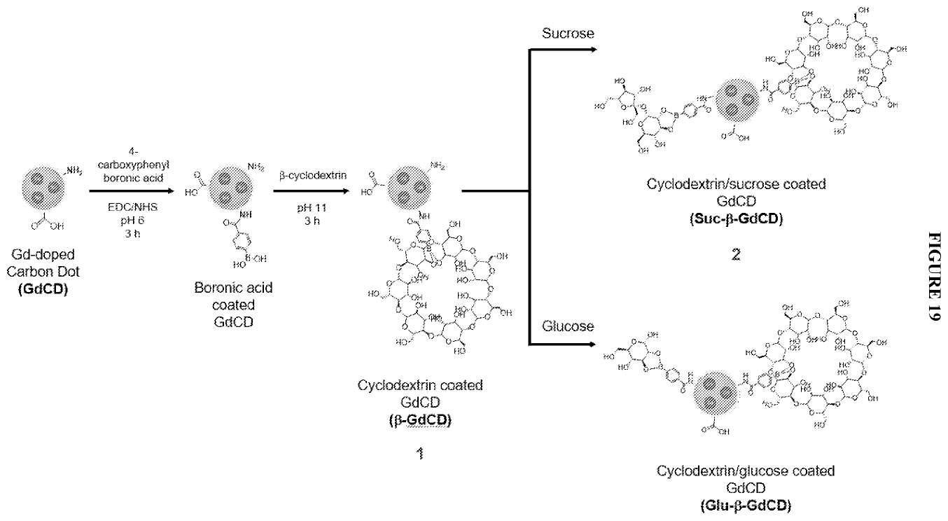

Targeted delivery of fluorescent chemical cargo to fungi in infected leaves mediated by nanocarriers was tested and shown herein. Confocal images of GFP-Botrytis infected leaves indicated a higher degree of colocalization of R6G delivered by glu-γ-GdCD with GFP fluorescence compared to non-targeted γ-GdCD (FIG. 18a). Colocalization rates of R6G delivered by glu-γ-GdCD with GFP were compared to γ-GdCD (FIG. 18b). Orthogonal views from z-stacks of confocal images showing colocalization of glu-γ-GdCD within GFP-Botrytis (FIG. 18c).

### Methods

Synthesis of sucrose or glucose and β-cyclodextrin coated carbon dots (suc-B-CDs or glu-B-CDs). The suc-B-CDs or gluc-B-CDs were synthesized by coating with β-cyclodextrin and sucrose or glucose on the CD core. Core carbon dots (CDs) were synthesized by the slight modification of previously reported protocols (Hu et al. ACS Nano 2020, 14, 7, 7970-7986). The CD cores were synthesized by hydrothermal reactions using citric acid, urea, and ammonium hydroxide. In brief, 1.92 g of citric acid (Fisher, 99.7%) and 2.40 g of urea (Fisher, 99.2%) were dissolved in 2 mL of DI water and 1.35 mL of ammonium hydroxide (Sigma Aldrich, NH₃·H₂O, 30-33%) was added into the mixture. The mixture was reacted at 180° C. for 1.5 h and was cooled down to room temperature and redissolved in DI water. The aggregate was removed by centrifugation at 4,500 rpm for 30 min. A solution was further filtered by using a syringe filter (Whatman, pore size, 0.02 μm) to remove large size particles. Next, the CD core was functionalized by carboxyphenylboronic acid (CBA) as BA capped CDs (BA-CDs). NHS (75 nmol) and EDC/HCl (75 nmol) were added to the CD in TES buffer (10 mM TES buffer, pH 7.4). Then, the mixture was vortexed (750 rpm) for 15 min at ambient temperature. A CBA solution (75 nmol) was added and reacted for 3 h at room temperature. To wash the excess of CBA out, a dialysis membrane (1 K MWCO, Spectrum Laboratories) was used and dialyzed with 2 L DI water. For introducing β-cyclodextrin and sucrose or glucose on the sucCDs or gluCDs, respectively, firstly the BA-CDs were dispersed in TES buffer (10 mM TES buffer; pH 10.4), then 10 ul of 5 mM β-cyclodextrin was added and stirred overnight. After reaction with β-cyclodextrin, the mixture was washed with a dialysis membrane (1 K MWCO, Spectrum Laboratories) by dialysis with 2 L DI water. Subsequently, sucrose or glucose was reacted by repeating the same protocol with β-cyclodextrin, to make suc-B-CDs or gluc-B-CDs, respectively.

For fungi assay for targeted delivery of nanocarrier, the spores of GFP-Botrytis were isolated by collecting a small amount of GFP-Botrytis from an agar plate in 1 ml of growth medium by using a sterile swap and filtered to separate spores from hyphae. The spores were counted using a hemocytometer and diluted to 5 spores/ul, and 3 ul of suspensions was transferred into a well of a microscope slide (μ-Slide 18 Well, ibidi). The 3 ul of suspension was transferred to a well of a microscope slide (μ-Slide 18 Well, ibidi) and incubated for 72 h. After incubation, Botrytis hyphae were incubated with nanocarriers (5 uL of nanocarriers (0.1 mg/ml with 0.1 wt % Silwet L-77) for 1 h and analyzed using confocal fluorescence microscopy.

### Example 3. Targeted Delivery to Fungi by Biorecognition

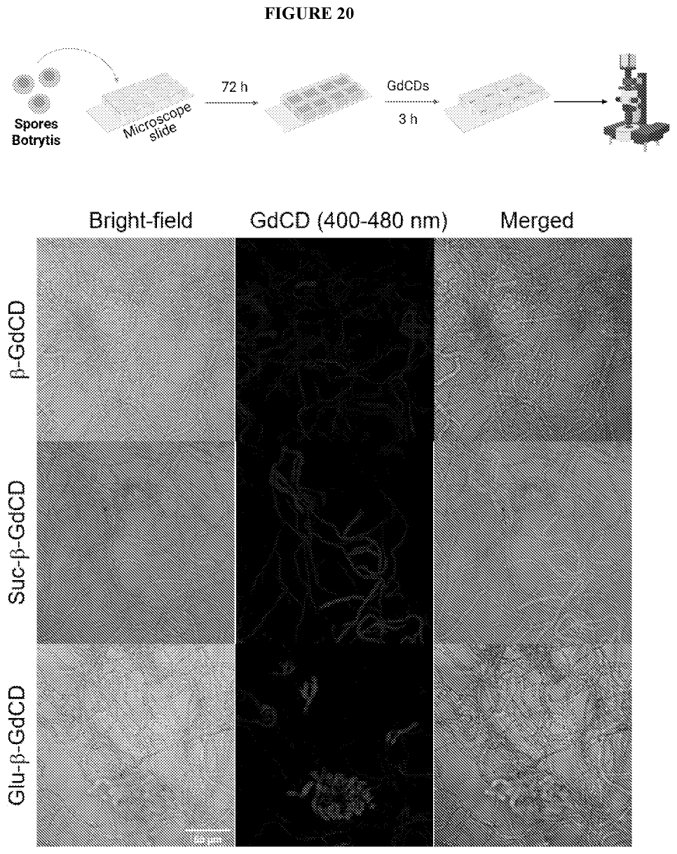

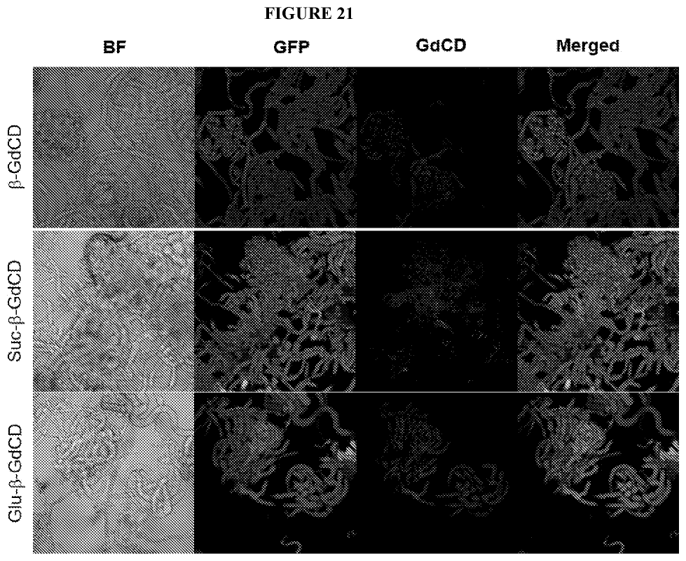

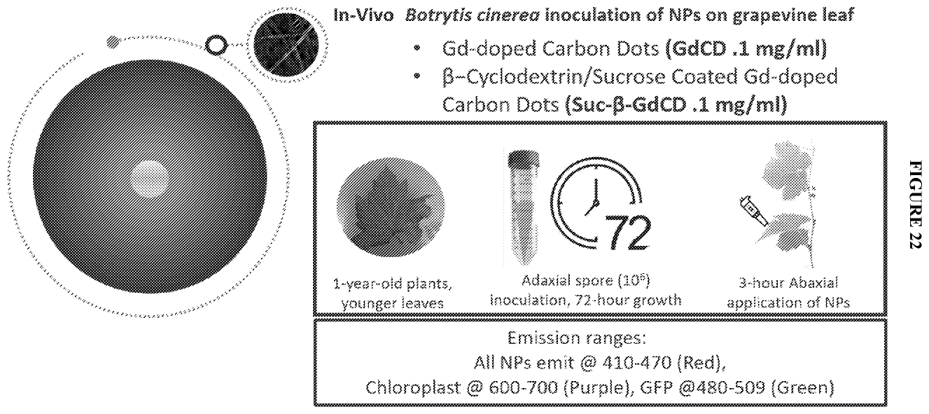

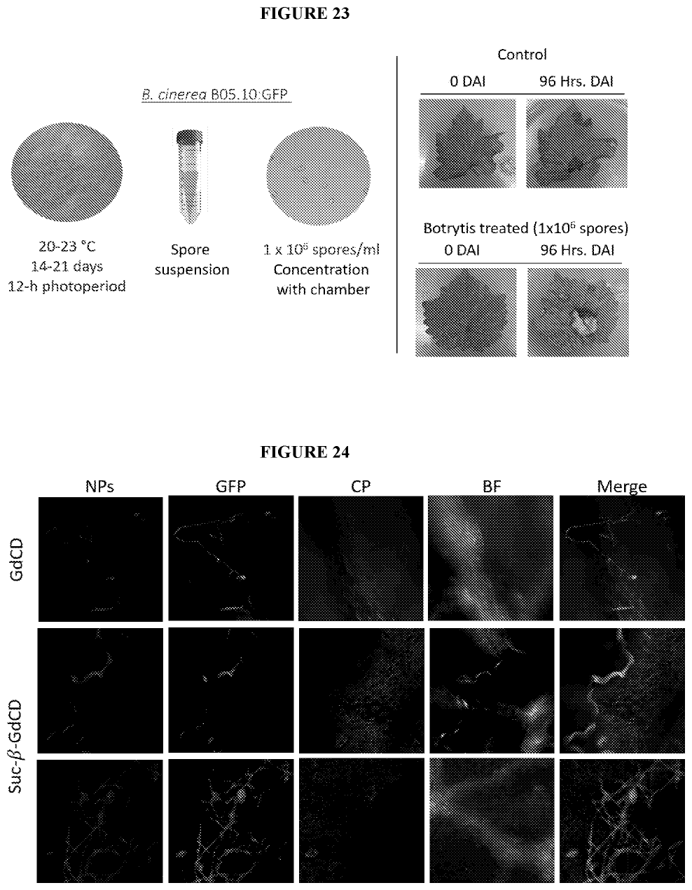

After culturing Botrytis spp. Hyphae on a microscope slide, the sample was incubated with uncoated and sucrose or glucose coated nanocarriers for one hour and then observed under confocal microscopy. Both uncoated GdCD and GdCD coated with sucrose or glucose showed fluorescent signals in the Botrytis spp. (FIG. 20). The GdCD coated with glucose displayed the strongest fluorescent signal in confocal images. Therefore, this in vitro experiment (FIG. 20) showed that nanocarriers coated with glucose can enter Botrytis fungus more effectively.

Genetically engineered Botrytis hyphae expressing GFP proteins were cultured on a microscope slide, and the experiment was conducted using the same method as used in FIG. 20. Through this experiment (FIG. 21), the degree of colocalization between the fluorescent signals of GdCD and GFP was calculated, showing a similar level of 85-92% for uncoated GdCD and coated GdCD with sucrose or glucose. GdCD coated with sucrose (85%) showed a slightly lower level compared to uncoated GdCD (90%), which was attributed to some amount of GdCD being attached not only inside but also outside the fungal wall. GdCD coated with glucose (92%) showed a slightly increased colocalization and clear yellow color due to colocalization with GFP inside the Botrytis fungi. However, this preliminary experiment is based on one replication and to ensure the reproducibility of the experiment (FIG. 21), more biological replicates are needed. Overall, this in vitro experiment shows that nanocarriers can enter GFP-Botrytis fungus.

### Methods

Synthesis of β-cyclodextrin coated Gd doped carbon dots (β-GdCD). 0.2 g of gadolidium chloride hexahydrate, 0.5 g of citric acid and 0.17 ml of diethylenetriamine were dissolved in 6 mL of DI water. The mixture was transferred into the autoclave reactor and reacted at 180° C. for 1.5 h. After reaction, the mixture was cooled down to room temperature and the aggregate was removed by centrifugation at 4,500 rpm for 30 min. The supernatant was then transferred in a dialysis membrane (1 kDa MWCO) and dialyzed with 2 L water to remove the excess reagents from the solution. A solution was further filtered by using a syringe filter (Whatman, pore size, 0.02 μm) to remove large size particles. Next, the GdCD core was functionalized by carboxyphenylboronic acid (CBA) as BA capped GdCDs (BA-GdCDs). NHS (75 nmol) and EDC/HCl (75 nmol) were added to the GdCD in TES buffer (10 mM TES buffer, pH 7.4). Then, the mixture was stirred (500 rpm) for 30 min at ambient temperature. A CBA solution (75 nmol) was added and reacted for 3 h at room temperature. To wash the excess of CBA out, a dialysis membrane (1 K MWCO, Spectrum Laboratories) was used and dialyzed with 2 L DI water. For introducing β-cyclodextrin on the BA-GdCDs, firstly the BA-GdCDs were dispersed in TES buffer (10 mM TES buffer; pH 10.4), then 10 ul of 5 mM β-cyclodextrin was added and stirred 3 h. After reaction with β-cyclodextrin, the mixture was washed with a dialysis membrane (1 K MWCO, Spectrum Laboratories) by dialysis with 2 L DI water.

Synthesis of sucrose or glucose coated nanocarrier (suc-β-GdCD, glu-β-GdCD). For sucrose or glucose coated nanocarrier, j-GdCDs were dispersed in TES buffer (10 mM TES buffer; pH 10.4), then 10 ul of 6 mM sucrose or glucose solution was added and stirred 3 h. The mixture was washed with a dialysis membrane (1 K MWCO, Spectrum Laboratories) by dialysis with 2 L DI water.

Preparation of nanocarrier treated Botrytis hyphae on a microscope slide for confocal microscopy analysis. For in-vitro fungi assay for uptake of nanocarrier, the spores of GFP-Botrytis were isolated by collecting a small amount of GFP-Botrytis from an agar plate in 1 ml of growth medium by using a sterile swap and filtered to separate spores from hyphae. The spores were counted using a hemocytometer and diluted to 5 spores/ul. and 3 ul of suspensions was transferred into a well of a microscope slide (μ-Slide 18 Well, ibidi). The 3 ul of suspension was transferred to a well of a microscope slide (μ-Slide 18 Well, ibidi) and incubated for 72 h. After incubation, Botrytis hyphae were incubated with nanocarriers (5 uL of nanocarriers (0.1 mg/ml with 0.1 wt % Silwet L-77) for 1 h and analyzed using confocal fluorescence microscopy. Confocal fluorescence microscopy imaging. Nanocarrier treated Botrytis were imaged by a Zeiss laser scanning confocal microscope Zeiss880. The imaging settings were as follows: x40 wet objective; 355 nm laser excitation for GdCD; 488 nm for GFP. The PMT detection range was set 400-480 nm for GdCD; 500-550 nm for GFP.

### Example 4. Testing Functionalized Sucrose Coated Nanoparticle Delivery to Fungal Structures in Grapevines

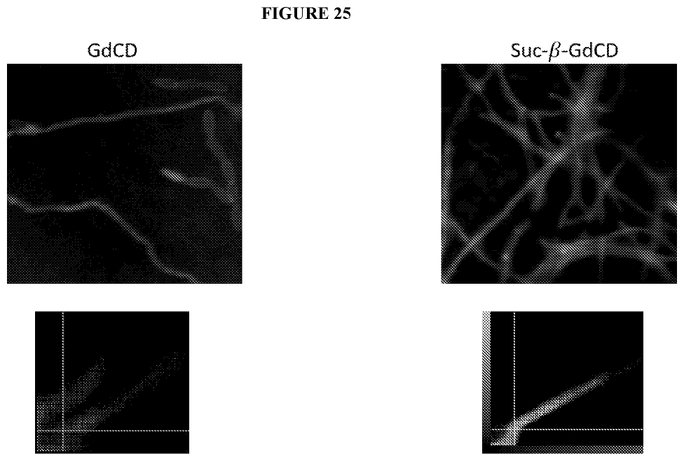

As shown in FIGS. 24-25, enhanced delivery of sucrose coated nanocarriers to Botrytis spp. fungus in grapevine plants in vivo was detected as compared to uncoated nanocarriers.

Preparation of nanocarrier-treated Botrytis hyphae on a grapevine leaf for confocal microscopy analysis. A detached leaf assay was conducted for in-vivo fungi assay for uptake of nanocarrier in grapevine leaf. To collect spores for leaf inoculation, the spores of GFP-Botrytis were isolated by collecting a small amount of GFP-Botrytis from an agar plate in 1 ml of growth medium by using a sterile swap and filtered using an autoclaved cheesecloth to separate spores from hyphae. The spores were counted using a hemocytometer and diluted to 10 spores/ul. Using 10 ul of the spore suspension, inoculation was performed using a pipette to the adaxial (top) side of the leaf. Detached GFP-Botrytis infected leaves were placed into a PDA agar plate, sealed, and allowed to grow for 72 h. After incubation, Botrytis hyphae were incubated with nanocarriers (1.5 uL of nanocarriers (0.1 mg/ml with 0.1 wt % Silwet L-77) for 3 h and analyzed using confocal fluorescence microscopy.

Confocal fluorescence microscopy imaging. Nanocarrier-treated GFP-Botrytis were imaged by a Zeiss laser scanning confocal microscope Zeiss880. The imaging settings were as follows: x40 wet objective; 355 nm laser excitation for GdCD; 488 nm for GFP. The PMT detection range was set to 400-480 nm for GdCD; 500-550 nm for GFP.

Synthesis of Gd doped carbon dots (GdCD). 0.2 g of gadolidium chloride hexahydrate, 0.5 g of citric acid and 0.17 ml of diethylenetriamine were dissolved in 6 mL of DI water. The mixture was transferred into the autoclave reactor and reacted at 180° C. for 1.5 h. After reaction, the mixture was cooled down to room temperature and the aggregate was removed by centrifugation at 4,500 rpm for 30 min. The supernatant was then transferred in a dialysis membrane (1 kDa MWCO) and dialyzed with 2 L water to remove the excess reagents from the solution. A solution was further filtered by using a syringe filter (Whatman, pore size, 0.02 μm) to remove large size particles.

Synthesis of sucrose coated nanocarrier (suc-β-GdCD). For sucrose coated nanocarrier, (3-GdCDs were dispersed in TES buffer (10 mM TES buffer; pH 10.4), then 10 ul of 6 mM sucrose solution was added and stirred 3 h. The mixture was washed with a dialysis membrane (1 K MWCO, Spectrum Laboratories) by dialysis with 2 L DI water.

All publications, patents, and patent documents are incorporated by reference herein, as though individually incorporated by reference. The present disclosure has been described with reference to various specific and preferred embodiments and techniques. However, it should be understood that many variations and modifications may be made while remaining within the spirit and scope of the invention.

What is claimed is:

1. A conjugate comprising a Glucose Transporter protein (GUT) targeting agent linked to a cargo that is a pesticide, herbicide, or fertilizer.

2. The conjugate of claim 1, wherein the cargo is a pesticide, and wherein the pesticide is a fungicide.

3. The conjugate of claim 1 or 2, that further comprises a nanoparticle and/or a molecular basket, wherein the nanoparticle is selected from the group consisting of a quantum dot, carbon dot, carbon nanotube, silica nanoparticle (e.g., porous silica nanoparticle), lipid nanoparticle, liposome, and metal or metal oxide nanoparticle.

4. The conjugate of claim 3, that comprises a nanoparticle linked to one or more GUT targeting agent(s).

5. The conjugate of claim 3 or 4, wherein the cargo is associated with the nanoparticle or with the molecular basket.

6. The conjugate of claim 5, wherein the cargo is associated with the nanoparticle.

7. The conjugate of claim 5, wherein the cargo is associated with the molecular basket.

8. The conjugate of any one of claims 3-7, wherein the molecular basket comprises a beta cyclodextrin or gamma cyclodextrin.

9. The conjugate of claim 8, wherein the cargo forms an inclusion complex with the cyclodextrin.

10. The conjugate of claim 9, wherein the cargo is selected from the group consisting of Ametoctradin, Benthiavalicarb, chlorothalonil, cyazofamid, Dimoxystrobin, Etaconazole, fluopyram, myclobutanil, Oxathiapiprolin, pyraclostrobin, thiabendazole, and Spiroxamine.

11. The conjugate of any one of claims 3-6, which comprises a conjugate of Formula I:
NP-(linker-TA)ₙ (I)
wherein: NP is the nanoparticle; TA is the Glucose Transporter protein (GUT) targeting agent; the linker has a molecular weight of from about 20 daltons to about 20,000 daltons; and n is an integer≥1.

12. The conjugate of claim 11, wherein the NP is further functionalized with one or more molecular baskets.

13. The conjugate of claim 12, wherein the molecular basket comprises a beta cyclodextrin or gamma cyclodextrin.

14. The conjugate of claim 12 or 13, wherein the cargo is associated with the molecular basket.

15. The conjugate of claim 13, wherein the cargo forms an inclusion complex with the cyclodextrin.

16. The conjugate of any one of claims 12-15, wherein the cargo is selected from the group consisting of Ametoctradin, Benthiavalicarb, Etaconazole, fluopyram, Oxathiapiprolin, and Spiroxamine.

17. The conjugate of claim 1, which is a conjugate of formula II:
cargo-linker-TA (II)
wherein: TA is the Gluocse Transporter protein (GUT) targeting agent; and the linker has a molecular weight of from about 20 daltons to about 20,000 daltons.

18. The conjugate of any one of claims 7-10, which comprises a conjugate of formula III:
MB-(linker-TA)ₙ (III)
wherein: MB is the molecular basket; TA is the Gluocse Transporter protein (GUT) targeting agent; the linker has a molecular weight of from about 20 daltons to about 20,000 daltons; and n is an integer≥1.

19. The conjugate of any one of claims 11-18, wherein the linker has a molecular weight of from about 20 daltons to about 5,000 daltons.

20. The conjugate of any one of claims 11-18, wherein the linker has a molecular weight of from about 20 daltons to about 1,000 daltons.

21. The conjugate of any one of claims 11-20, wherein the linker comprises a boronic acid group —B(O—)₂, wherein each O— is bonded to TA.

22. The conjugate of any one of claims 11-21, wherein the linker has a structure —X—Y—Z—; wherein:
X is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂,
Z is a bond, —O—, —S—, —C(═O)—, —N(Rₐ)—, —C(═O)NH—, —C(═S)NH—, —C(═O)O—, —C(═O)S—, —NHSO₂—, —OC(═O)NH—, —NHC(═O)NH—, —NHC(═S)NH—, —Si(R_{b})₃, or —B(R_{c})₂;
Rₐ is H or (C₁-C₆) alkyl;
each R_{b} is independently O—, —OH, or (C₁-C₄)alkoxy;
each R_{c} is O—that is linked to TA;
Y is a divalent, saturated or unsaturated, branched or unbranched (C₂-C₁₈) hydrocarbon chain, wherein one or more carbon of the hydrocarbon chain is optionally replaced with —O—, —N(Rₛ)—, —S—, aryl, or heteroaryl, and wherein the hydrocarbon chain is optionally substituted on carbon with one or more substituents selected from the group consisting of halo, hydroxy, mercapto, oxo (═O) and thioxo (═S); and
Rₛ is H or (C₁-C₆) alkyl.

23. The conjugate of claim 22, wherein Z is —B(R_{c})₂.

24. The conjugate of any one of claims 1-23, wherein the Glucose Transporter protein (GUT) targeting agent is a monosaccharide.

25. The conjugate of any one of claims 1-23, wherein the Glucose Transporter protein (GUT) targeting agent is glucose.

26. The conjugate of claim 11, which comprises formula Ib3, formula Ib4, formula Ic3 or formula Ic4:

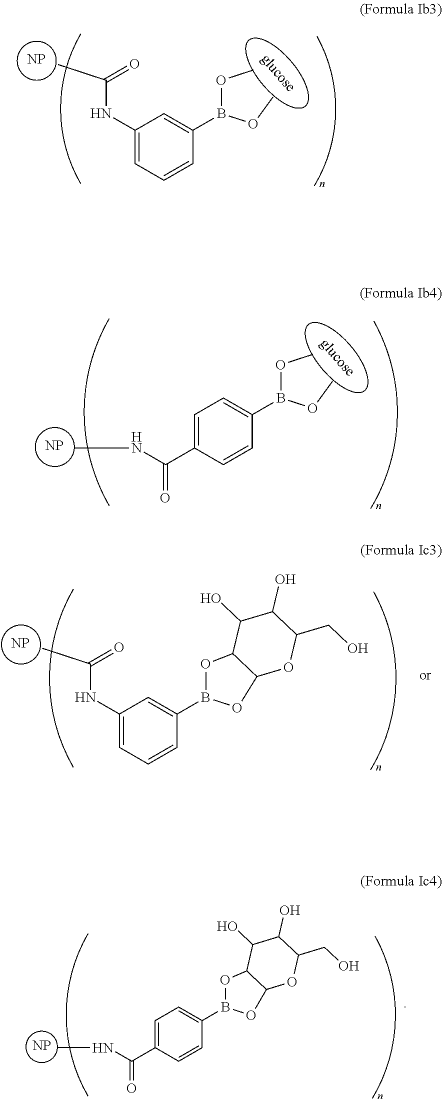

27. The conjugate of claim 12, which comprises a conjugate of Formula Ie:
(MB-linker)ₘ-NP-(linker-TA)ₙ (Formula Ie)
wherein: MB is the molecular basket; NP is the nanoparticle; TA is the Glucose Transporter protein (GUT) targeting agent; each linker is independently selected from a linker having a molecular weight of from about 20 daltons to about 20,000 daltons; m is an integer≥1; and n is an integer≥1.

28. The conjugate of claim 27, which comprises formula Ie3 or formula Ie4:

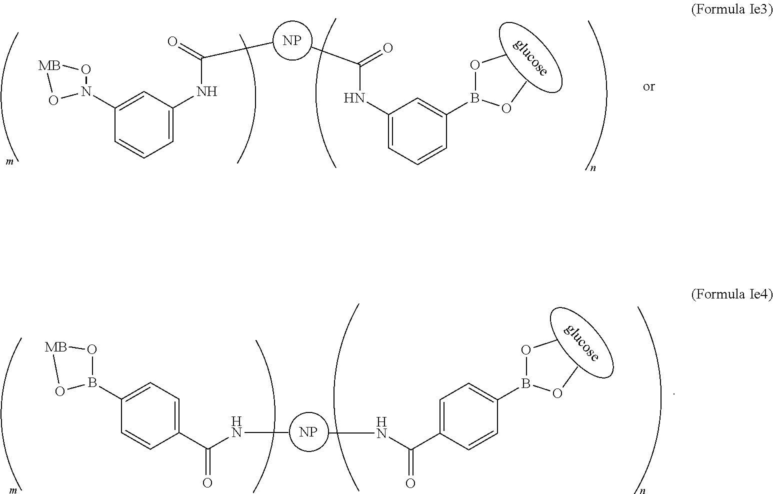

29. The conjugate of any one of claims 3-16 and 19-28, wherein the nanoparticle is selected from the group consisting of a carbon dot, carbon nanotube, silica nanoparticle, metal or metal oxide nanoparticle, lipid nanoparticle, and liposome.

30. The conjugate of any one of claims 3-16 and 19-28, wherein the nanoparticle has a diameter of about 1 nm to 300 nm.

31. The conjugate of any one of claims 3-16 and 19-28, wherein the nanoparticle has a diameter of about 5 nm to 150 nm.

32. The conjugate of any one of claims 3-16 and 19-28, wherein the nanoparticle has a diameter of about 1 nm to 50 nm.

33. The conjugate of any one of claims 1-32, wherein the cargo has a molecular weight of less than 1000 g/mol.

34. A method of treating a fungus infection in a plant or introducing a conjugate to a fungus, the method comprising: contacting the plant and/or fungus with a conjugate as described in any one of claims 1-33.

35. The method of claim 34, comprising contacting the fungus with the conjugate.

36. The method of claim 34, wherein the plant has a fungal infection disease selected from the group consisting of gray mold, anthracnose, leaf blight, leaf spot, leaf rust, Gall rust, Fusarium wilt, early blight, and powdery mildew.

37. The method of claim 34, wherein the plant is infected by the fungus on a leaf, stem, and/or root.

38. The method of claim 34, wherein the plant is infected by the fungus on a leaf and/or fruit.

39. The method of any one of claims 34-38, wherein the plant is infected by a fungus selected from the group consisting of Alternaria spp., Bipolaris spp., Botrytis spp., Cochliobolus spp., Colletotrichum spp., Erysiphe spp., Endocronartium spp., Fusarium spp., glomerell spp., Phragmidium spp., and Puccinia spp.

40. The method of any one of claims 34-38, wherein the fungus is selected from the group consisting of Magnaporthe oryzae, Botrytis spp. (e.g., Botrytis cinerea), Puccinia spp., Fusarium graminearum, Fusarium oxysporum, Blumeria graminis, Mycosphaerella graminicola, Colletotrichum spp., Ustilago maydis, Melampsora lini, and Zymoseptoria tritici.

41. The method of any one of claims 34-40, wherein the conjugate is contacted with the plant and/or fungus during germination.

42. The method of any one of claims 34-40, wherein the conjugate is contacted with the plant and/or fungus after germination.

43. The method of any one of claims 34-40, wherein the conjugate is contacted with the plant and/or fungus during proliferation.

44. The method of any one of claims 34-40, wherein the conjugate is contacted with the fungus when fungus forms hyphae.

45. The method of any of claims 34-40, wherein the conjugate is contacted with the plant and/or fungus at sporulation.

46. A method for introducing a conjugate to a fungus, comprising contacting the fungus with a conjugate comprising a nanoparticle and/or a molecular basket that is linked to a Glucose Transporter protein (GUT) targeting agent, wherein the nanoparticle is selected from the group consisting of quantum dot, carbon dot, carbon nanotube, silica nanoparticle (e.g., porous silica nanoparticle), lipid nanoparticle, liposome, and metal or metal oxide nanoparticle.

47. The method of claim 46, wherein the conjugate is contacted with the fungus during germination.

48. The method of claim 46, wherein the conjugate is contacted with the fungus after germination.

49. The method of claim 46, wherein the conjugate is contacted with the fungus during proliferation.

50. The method of claim 46, wherein the conjugate is contacted with the fungus when fungus forms hyphae.

51. The method of claim 46, wherein the conjugate is contacted with the fungus at sporulation.

52. A conjugate comprising a Glucose Transporter protein (GUT) targeting agent linked to a nanoparticle, wherein the conjugate is capable of being delivered to a fungus, and the nanoparticle is selected from the group consisting of a quantum dot, carbon dot, carbon nanotube, silica nanoparticle (e.g., porous silica nanoparticle), lipid nanoparticle, liposome, and metal or metal oxide nanoparticle.

53. The conjugate of claim 52, comprising a conjugate of Formula I:
NP-(linker-TA)ₙ(I)
wherein: NP is a nanoparticle selected from the group consisting of a quantum dot, carbon dot, carbon nanotube, silica nanoparticle (e.g., porous silica nanoparticle), lipid nanoparticle, liposome, and metal or metal oxide nanoparticle; TA is the Glucose Transporter protein (GUT) targeting agent; the linker has a molecular weight of from about 20 daltons to about 20,000 daltons; and n is an integer≥1.

54. The conjugate of claim 53, wherein the nanoparticle is selected from carbon dot, carbon nanotube, silica nanoparticle (e.g., porous silica nanoparticle), lipid nanoparticle, and liposome.

55. The conjugate of any one of claims 52-54, which does not comprise a cargo.

56. The conjugate of any one of claims 52-54, which comprises a cargo.

57. The conjugate of any one of claims 52-56, wherein TA is a monosaccharide.

58. The conjugate of any one of claims 52-56, wherein TA is a hexose.

59. The conjugate of any one of claims 52-56, wherein TA is glucose.

60. A method comprising, detecting a conjugate as described in any one of claims 52-59 in a fungus.
